(19) United States
(12) Patent Application Publication
(10) Pub. No.: US 2018/0133900 A1
(43) Pub. Date: May 17, 2018

(54) EMBODIED DIALOG AND EMBODIED SPEECH AUTHORING TOOLS FOR USE WITH AN EXPRESSIVE SOCIAL ROBOT

(71) Applicant: JIBO, INC., Boston, MA (US)

(72) Inventors: Cynthia BREAZEAL, Cambridge, MA (US); Fardad FARIDI, Marlborough, MA (US); Sigurdur Orn ADALGEIRSSON, Somerville, MA (US); Thomas James DONAHUE, Arlington, MA (US); Sridhar RAGHAVAN, Fremont, CA (US); Adam SHONKOFF, Boston, MA (US)

(21) Appl. No.: 15/812,223

(22) Filed: Nov. 14, 2017

Related U.S. Application Data
(60) Provisional application No. 62/422,217, filed on Nov. 15, 2016.

(51) Int. Cl. B25J 11/00; B25J 19/02; G06F 17/27; G06F 17/21; G10L 13/04

(52) U.S. Cl. CPC B25J 11/0015; B25J 11/0005; B25J 19/026; G06F 17/2785; G06F 17/274; G06F 17/218; G10L 13/043; G06F 17/272

(57) ABSTRACT

A social robot provides more believable, spontaneous, and understandable expressive communication via embodied communication capabilities by which a robot can express one or more of: paralinguistic audio expressions, sound effects or audio/vocal filters, expressive synthetic speech or pre-recorded speech, body movements and expressive gestures, body postures, lighting effects, aromas, and on-screen content, such as graphics, animations, photos, videos. These are coordinated with produced speech to enhance the expressiveness of the communication and non-verbal communication apart from speech communication.

### CROSS-REFERENCE TO RELATED APPLICATIONS

This application claims the benefit of priority of U.S. Provisional Patent Application No. 62/422,217, titled “EMBODIED DIALOG AND EMBODIED SPEECH AUTHORING TOOLS FOR USE WITH AN EXPRESSIVE SOCIAL ROBOT,” filed on Nov. 15, 2016, which is hereby incorporated by reference in its entirety.

### BACKGROUND

A number of challenges exist for managing dialog between a social robot and a human. One of these is the difficulty in causing a robot to deliver expressions that convey emotion, tone, or expression in a way that seems authentic, believable and understandable, rather than what is commonly called “robotic.” By contrast, humans often convey speech together with non-language sounds, facial expressions, gestures, movements, and body postures that greatly increase expressiveness and improve the ability of other humans to understand and pay attention. A need exists for methods, devices, and systems that allow a social robot to convey these other elements of expressive content in coordination with speech output.

Another challenge lies in the difficulty in causing a robot to convey expression that is appropriate for the context of the robot, such as based on the content of a dialog, the emotional state of a human, the state of an activity performed between human and robot, an internal state of the robot (e.g., related to the hardware state or software/computational state), or the current state of the environment of the robot. A need exists for improved methods and systems that enable a social robot to execute synchronized, context-appropriate, authentic expression.

Given this, an additional challenge is enabling a social robot to decide or learn how to lend expressive attributes that are synchronized with dialog with a person, or enabling a developer to author lines of expressive natural language utterances with coordinated multi-modal paralinguistic expressions.

Alternatively, a developer could author such multi-modal expressive utterances for a robot using a set of techniques, tools and interfaces. Hence, another challenge is the development of such an authoring environment. Note than an additional challenge exists if such pre-authored multi-modal expressive utterances must work in conjunction with a social robot that may also be making real-time decisions how to express an utterance.

### BRIEF SUMMARY

A social robot, and other embodiments, described herein produces multi-modal expressive utterances that may express character traits, emotions, sentiments, etc. that may be at least partially specific to the character definition and expressive abilities of a particular robot. These may be part of a larger dialog interaction with a person, where both the human and robot exchange multi-modal expressive communication intents. This capability is referred to as “embodied dialog.”

In particular, a robot may be capable of being mechanically articulable and capable of producing expressive trajectories and physical animations or striking an expressive pose. A robot may have a repertoire of non-verbal communicative behaviors such as directing gaze, sharing attention, turn-taking, and the like. A robot may come with a screen and is capable of displaying graphics, animations, photos or videos and the like. A robot may be capable of lighting effects such as with LEDs or full spectrum LEDs. A robot may be capable of producing audio outputs. For instance, the robot could have a repertoire of paralinguistic audio sounds (non-word but vocalized expressive sounds such as mmm hmm, uh oh, oooo, and the like). Other audio outputs could include non-speech sounds such as audio effects, audio filters, music, sounds, etc. A combination and expression of these multi-modal, non-spoken language expressive cues is referred to as Para-Linguistic Cues (PLCs).

An important type of semantic audio output is natural spoken language. A robot may produce natural language output via a speech synthesizer (e.g., a text to speech engine (TTS)). In addition to producing speech audio from a text source, such as a text data file, speech audio may be synthesized from various audio clips, such as words, phrases, and the like. Alternatively, speech audio, whether it is natural spoken language or paralinguistic can be sourced from audio recordings entirely. The speech synthesizer may have parameters that allow for the prosodic variation of synthesized speech (e.g., pitch, energy, speaking rate, pauses, etc.) or other vocal or articulatory filters (e.g., aspiration, resonance, etc.). As another example, text for speech may be stored as lyrics of a song. Those lyrics can be spoken, such as in a natural language reading of the lyrics. However, those same lyrics can be sung. Indeed, those same lyrics can be sung differently based on the music being played. Processing a text file to produce contextually relevant speech may include contextual inputs, such as if a sound track needs to be produced by the robot or if music can be heard by the robot. No matter what the source, the speech output can be adapted contextually to convey character traits, emotions, intentions, and the like.

Natural language, that may be output during the process of such expression that results in expressive spoken language, may be any human language, such as English, Spanish, Mandarin, and many others. Such expressive spoken language may be processed by applying rules of diction from an input form such as TTS, to result in various ways of generating speech, and variations in how that speech can be synthesized (e.g., varying emotional expression, prosody, articulatory features such as aspiration, cultural, etc.).

As noted above, multi-modal expressive effects may include any combination of the above to supplement spoken/semantic/linguistic communication with paralinguistic cues. Coordinating and executing the multiple mediums (expressive spoken and/or paralinguistic outputs) so that the expression appears to be believable, comprehensible, emotive, coherent, socially connecting, and the like may require one or more mechanisms for adapting each medium plus coordinating the activation of each medium. The capabilities, methods and systems described herein that facilitate conveying character traits, emotions, and intentions of a social robot through expressive spoken language supplemented by paralinguistic expressive cues are referred to as “Embodied Speech.” The techniques and technologies for producing Embodied Speech for a social robot may facilitate the social robot to produce and coordinate multi-modally expression with natural language utterances to convey, among other things, communicative intent and emotion that is more expressive than neutral affect speech output.

Embodied speech may comprise multi-modal expression coordinating a plurality of social robot expression modes including any combination of verbal text-to-speech communications, paralinguistic communications, movement of one or more body segments, display screen imagery, lighting effects, and the like. In an embodiment, an embodied speech expression of a message may comprise generating varying combinations of expression modes based on context, historical expression of the message, familiarity of the intended recipient to the social robot, embodiment of the social robot (e.g., physical robot, device-independent embodiment, remote user communicated, and the like), preferences of a recipient of the message, randomized variation of delivery of the message, and the like. In an example, a social robot may express a message as a text-to-speech communication in a first instance of expression and as a combination of text-to-speech and paralinguistic communication in a second instance of expression of the message. Likewise, a first mobile device embodiment of the social robot may comprise expression of the message via a combination of text-to-speech and mobile device display screen imagery, such as a graphical representation of a physical embodiment of the social robot. Such an embodiment may comprise visual depiction of movement of one or more segments of a multi-segment social robot that is representative of coordinated movement of body segments of a physical embodiment of the social robot expressing the same message.

In one embodiment, a method is disclosed comprising receiving a prompt; generating a pre-input tree variant of the prompt; applying a lexigraphing function to the pre-input tree variant to generate a parse tree of the prompt; generating one or more natural language parse trees identifying parts of speech in the parse tree using at least one natural language processing (NLP) parser; identifying one or more markup tags based on the identified parts of speech in the one or more natural language parse trees and the parse tree, the one or more markup tags comprising indications of paralinguistic expressions; generating a timeline representation of the prompt based on the markup tags and the natural language parse trees; generating an action dispatch queue based on the timeline representation, the action dispatch queue comprising instructions generated and ordered based on start times of behaviors identified by the markup tags; and activating, by a control system the social robot, output functions of the social robot in response to the instructions in the action dispatch queue.

In another embodiment, a social robot is disclosed comprising a processor; one or more input and output devices; and a storage medium for tangibly storing thereon program logic for execution by the processor, the stored program logic comprising: receiving logic executed by the processor for receiving a prompt via the one or more input devices; first generating logic executed by the processor for generating a pre-input tree variant of the prompt; application logic executed by the processor for applying a lexigraphing function to the pre-input tree variant to generate a parse tree of the prompt; second generating logic executed by the processor for generating one or more natural language parse trees identifying parts of speech in the parse tree using at least one natural language processing (NLP) parser; identification logic executed by the processor for identifying one or more markup tags based on the identified parts of speech in the one or more natural language parse trees and the parse tree, the one or more markup tags comprising indications of paralinguistic expressions; third generating logic executed by the processor for generating a timeline representation of the prompt based on the markup tags and the natural language parse trees; fourth generating logic executed by the processor for generating an action dispatch queue based on the timeline representation, the action dispatch queue comprising instructions generated and ordered based on start times of behaviors identified by the markup tags; and activation logic executed by the processor for activating output functions of the social robot in response to the instructions in the action dispatch queue, the output functions controlling outputs of the one or more output devices.

### BRIEF DESCRIPTION OF THE DRAWINGS

The disclosure and the following detailed description of certain embodiments thereof may be understood by reference to the following figures:

FIGS. 1A through 1F depict details of the embodied speech processing architecture and data structures according to some embodiments of the disclosure.

FIGS. 2A through 2C depict a multi-dimensional expression matrix and uses thereof according to some embodiments of the disclosure.

FIGS. 3A through 3M depict uses of a LED ring, body segment movement, user and system tags, and several tag examples according to some embodiments of the disclosure.

FIGS. 4A through 4E depict an embodied speech editor according to some embodiments of the disclosure.

FIGS. 5A through 5L are user interface diagrams illustrating a user interface tool for developing social robot animations according to some embodiments of the disclosure.

FIGS. 6A and 6B depict eye animation conditions for engaging and disengaging with a user according to some embodiments of the disclosure.

FIGS. 7A and 7B provide high level flow diagram for embodied dialog according to some embodiments of the disclosure.

FIGS. 8A through 8D depict flow charts for determining and producing natural language and paralinguistic audio in various sequences according to some embodiments of the disclosure.

FIGS. 9A through 9E depict various examples of embodied speech markup language with corresponding exemplary robot actions according to some embodiments of the disclosure.

FIGS. 10A through 10C depict various authored responses for a prompt associated with a human inquiry regarding a favorite food according to some embodiments of the disclosure.

FIG. 11 depicts a user interface display screen for tuning various aspects of pronouncing a text to speech phrase according to some embodiments of the disclosure.

### DETAILED DESCRIPTION

The methods, devices, and systems of embodied speech and the methods and techniques related to that are described herein and depicted in the accompanying figures may be embodied in a physical or virtual social robot.

In the described embodiments, the social robot is comprised of multiple rotationally connected robot segments that may rotate with respect to one another. As a result of the angular configuration of each segment, such rotation results in the body of the social robot assuming various poses or postures. In some instances, the poses may mimic human poses in order to express emotion. In other exemplary instances, the poses may function to facilitate desired actions of the social robot. For example, in instances where the social robot comprises a viewable screen on the uppermost segment, rotation of the component segments may enable the social robot to situate the screen in a preferred posture to face the user at the right viewing angle. The robot may have cameras to process visual inputs from a user. The robot may have touch sensors to receive tactile inputs from a user. The robot may have a touch screen. The robot may have microphones for spoken or auditory inputs. The robot may have speakers to produce audio outputs such as speech or other sound effects. It may have a microphone array to localize sound inputs. The robot may have stereo or depth cameras to estimate the physical location of a person with respect to the robot. The robot may be connected to the Internet where it can receive digital content and feeds. The robot may be connected to other devices such as in a connected home context. The robot may have other digital content such as games or stories.

Embodied speech outputs comprised of expressive paralinguistic cues coordinated along with natural language utterances may be coded or otherwise indicated through data structures, either predefined and stored in some way such as a source file (e.g., a text file), database etc., or generated procedurally in response to real-time inputs, that an embodied speech system capability of the social robot may recognize, compose, decode, and/or otherwise analyze and interpret in order to produce/generate/perform embodied speech outputs.

This expressive performance can be generated in response to sensory inputs (e.g., vision, sound/speech, touch), task state (e.g., taking a picture, playing a game, answering a question, telling a story, relaying a message, etc.), or some other context (e.g., device state, time of day, special event such as a birthday, an information feed from the Internet, communication with another device, etc.).

Consider the following examples of embodied speech outputs. The social robot is enabled to coordinate the rotation of body segments to produce non-verbal cues such as gazing, conversational postural shifts, emotive expressions, and the like. For example, the social robot may ask a question of a user. Then, the social robot may rotate its segments to produce a posture that mimics a cocked head that conveys curiosity or anticipation of a response. Further, the robot may display a question mark on the screen as an additional prompt to the user to respond.

In another example where the robot is conveying digital content, such as telling a story, the social robot may commence to recite the poem “Goodnight Moon” while simultaneously configuring its body and screen graphics such as to depict eyes to effect a gaze shift aimed up and out of a nearby window towards the sky, then a moon might appear on the screen with a sound effect.

Alternatively, when expressive cue data indicates producing a positive high energy voice output, such as laughter or the like, a corresponding screen animation such as a broadening smile, and the like may be produced that is synchronized as a unified, coherent performance. Similarly, an expressive cue that connotes excitement may be embodied as a coordinated performance of one or more of a higher-pitch and faster speech utterance (e.g., saying “great job!” in an excited manner), a corresponding non-speech sound (e.g., cheers, whistling, etc.), movement (wiggling the body or the like), lighting (flashing), screen animations (e.g., fireworks), and so forth.

In some embodiments, the social robot may vary different aspects of the multi-modal outputs to produce different intensities or variations of effects. For example, for a given audio communication, the social robot might vary the pitch, prosody, word emphasis and volume of the communication while coordinating therewith control of a plurality of rotationally connected robot body segments. This may allow the robot to convey a range of intensities or emotion, for instance.

Expressiveness of back-and-forth dialog with a person may be enhanced when the social robot coordinates behavioral movements, screen graphics, lighting effects, and the like with expressive audio communication. For instance, the embodied speech system could consider user inputs such as speech, visual perception of the user (such as gestures, location and facial expressions), how the user may be touching the robot's body or screen, etc. The embodied speech system could adjust the data source file (comprised of natural language and/or paralinguistic cue commands) to generate an expressive response that is contextually appropriate to what the user is saying and doing.

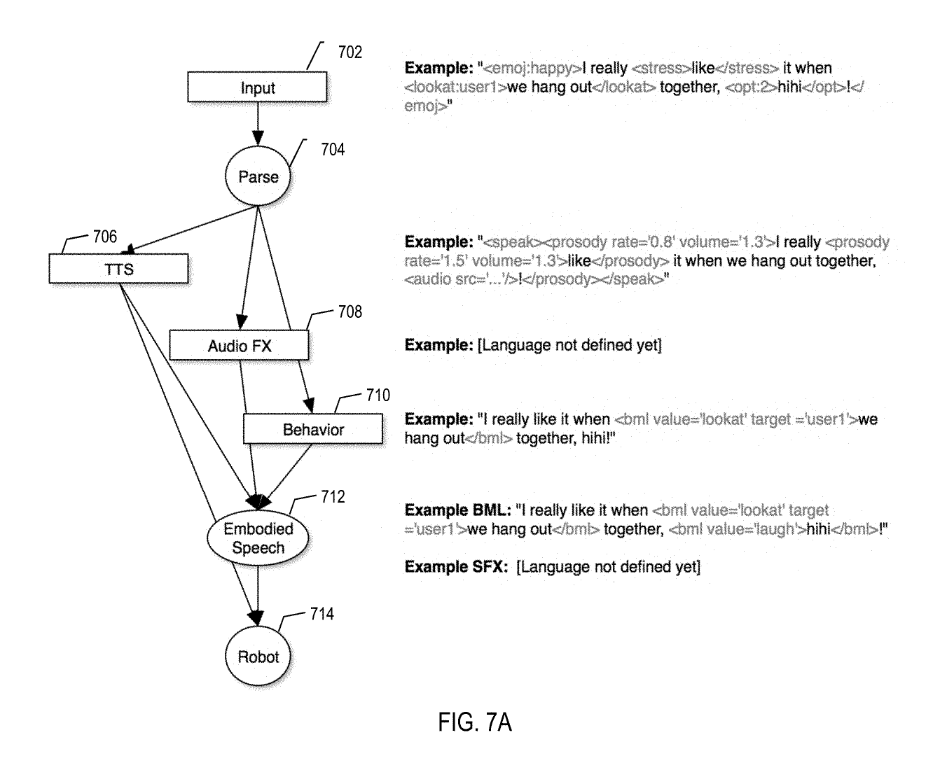

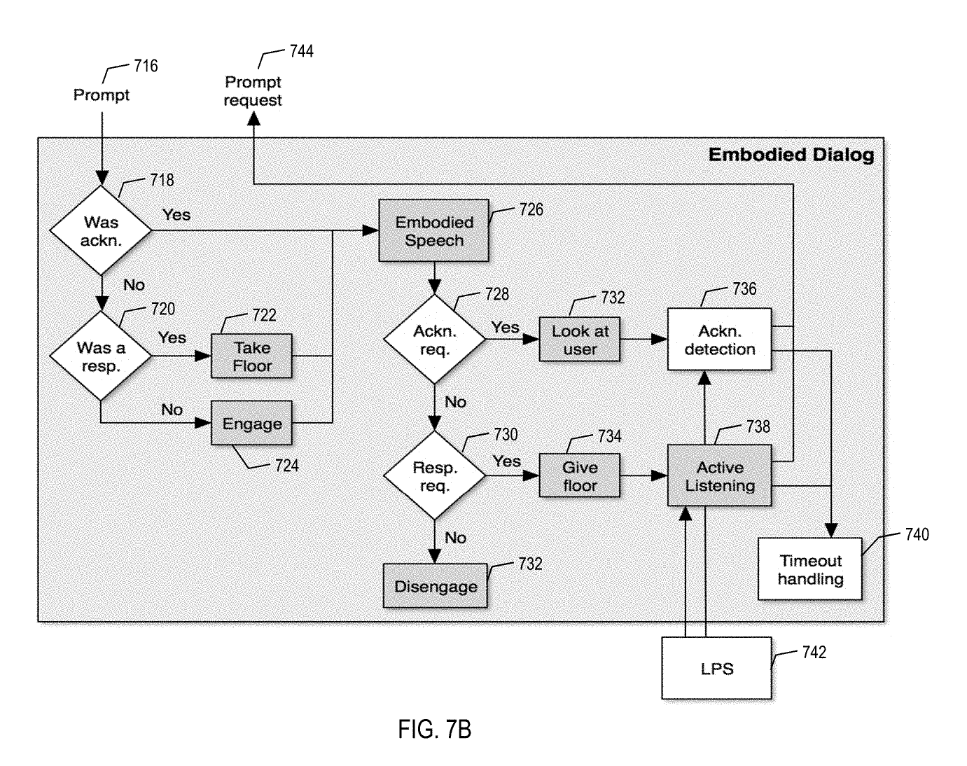

Referring to FIG. 7B, a flow chart depicting an exemplary flow for embodied dialog between a robot and, for example, a human. In the embodiment of FIG. 7B, an audio, visual, or tactile prompt (716) may be received by the social robot. The social robot will determine if it was an acknowledgement type prompt (718) or a response type prompt (720). If it is an acknowledgement prompt the robot will engage in embodied speech (729) using the methods and systems described herein, such as by using an embodied speech facility (e.g., engine) of the social robot. If the response was not an acknowledgement type prompt, the social robot will take the floor (722) in the dialog if the prompt was a response type prompt or it will engage the prompter otherwise (724).

After performing embodied speech as noted herein, the social robot will determine if the embodied speech requires an acknowledgement by the user (728). If so, the robot may turn to look at the user (732). If the speech does not require an acknowledgement by the user, the social robot may determine if a response is required at all (730). If not, then the robot may disengage from embodied dialog with the user (732). If a response is required, the social robot may give the floor (734) and engage in active listening (738) based on sensing inputs through its audio, camera, or tactile input system (742). If an acknowledgement is detected (736), the social robot may perform an embodied speech action to request a next prompt (744). After some time, the social robot may go into a timeout handling routine to determine a next action (740).

In one non-limiting example, user inputs may include a human user's touch and facial expression, which may be taken as inputs to an attention system of the social robot. For example, a light touch by the user may indicate that the social robot should direct its attention to that user, such as among other individuals in the presence of the robot. The robot may use an image capture system, such as a camera, to capture a facial expression of the user, which may be analyzed in an emotion recognition system to determine an emotion of the user, which may be used in turn to select a mode of operation for the robot. For example, if the emotion of the user is recognized as happy, the robot may select a state of an embodied speech system that is appropriate for happy interaction. The embodied speech system may then direct the various sub-systems of the robot to produce outputs that are modulated for that state, such as directing the lighting system to display brightly colored lighting effects, the robotic motors to move segments of the robot to a cheerful pose, the animation system to display a cheerful animation, such as a smile, on the robot's screen, and the audio system to emit cheerful sounds, such as beeps. Thus, the inputs to the attention system direct the robot's attention, such that additional inputs are obtained by the robots sensory systems, which are in turn analyzed to determine an appropriate mode or state of interaction by the robot, which are in turn used to modulate the output modes of the robot, such as through embodied speech.

Consider the following interaction between a person and social robot to illustrate how embodied speech enhances human-robot interaction and dialog:
Human: “Hey Robot, what is the weather today?”
Robot:
[Looks to person]
“Hi Sam, let me check the weather report.”
[robot glances to the side as if in thought as the robot accesses a weather service data]
[robot looks back to person]
“I'm afraid the weather today is pretty gloomy.”
[Eyes look down, eyes dim and slightly squash at the low point, body shifts posture to a slump, while making a low pitch decreasing tone that conveys sorrow]
[Robot eye brightens and looks back to person while it straightens its posture]
“It will be cold . . . .
[robot's eye squints as body does a shivering body animation when the robot says “cold”, pause.]
. . . with lows in the 30s.”
[shows an animation of a thermometer graphic with a blue “mercury” line dropping down to the 35 degree mark while making a quiet decreasing tone sound while the robot says “lows in the 30s”, pause]
“Also, high chance of rain with thunder and lightning . . . .
[as the robot says “high chance of rain” an animation of thunder clouds drift across the screen, and right after the robot says “thunder and lightning” it plays a sound of thunder with an on-screen animation of rain pouring down, then a flash of a lightning bolt comes down from the clouds. The LEDs on the robot flashes bright white in unison with the lightning bolt on the screen. The animation of pouring rain and the sound of rainfall continues, while the robot stoops as if the rain is falling on its head].
Human: “Wow, thanks robot, I'm going to bring an umbrella!”
Robot: [straightens posture]
“Great idea! Take care out there!”
[makes a confirming sound after saying this, and does a posture shift to emphasize confirmation].

### Embodied Speech System Description

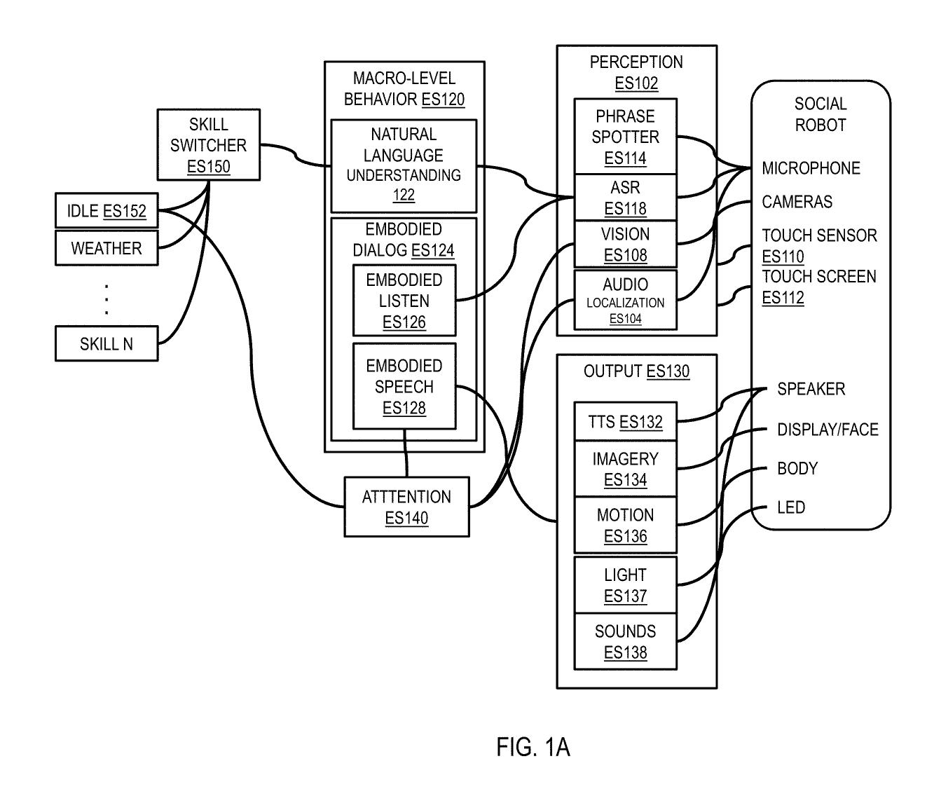

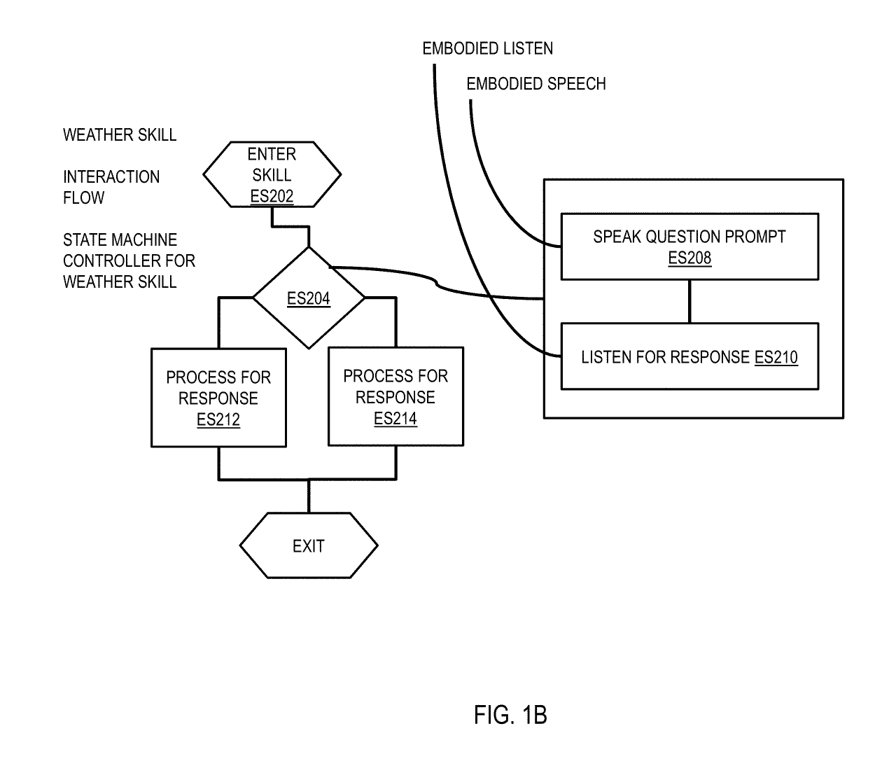

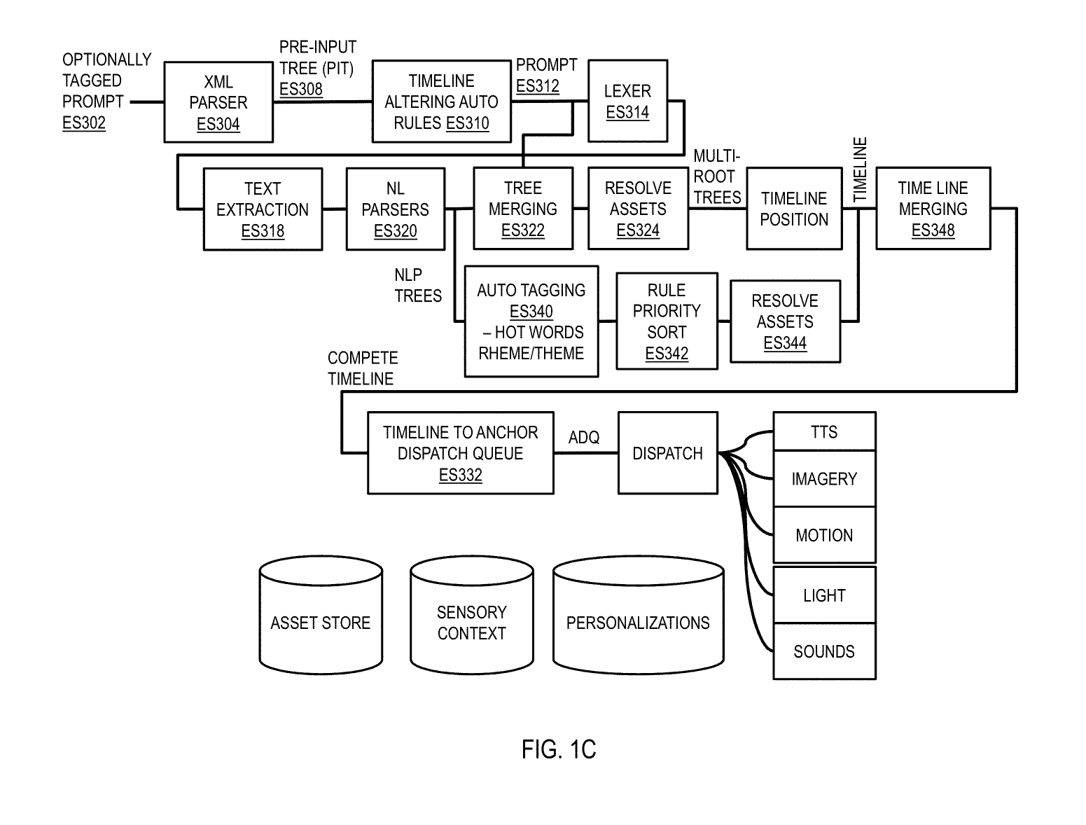

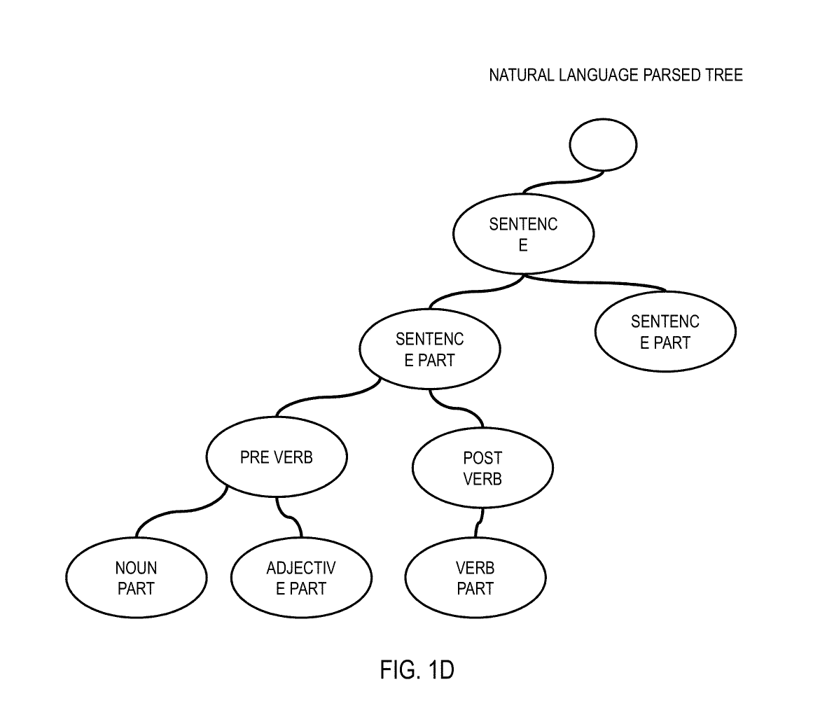

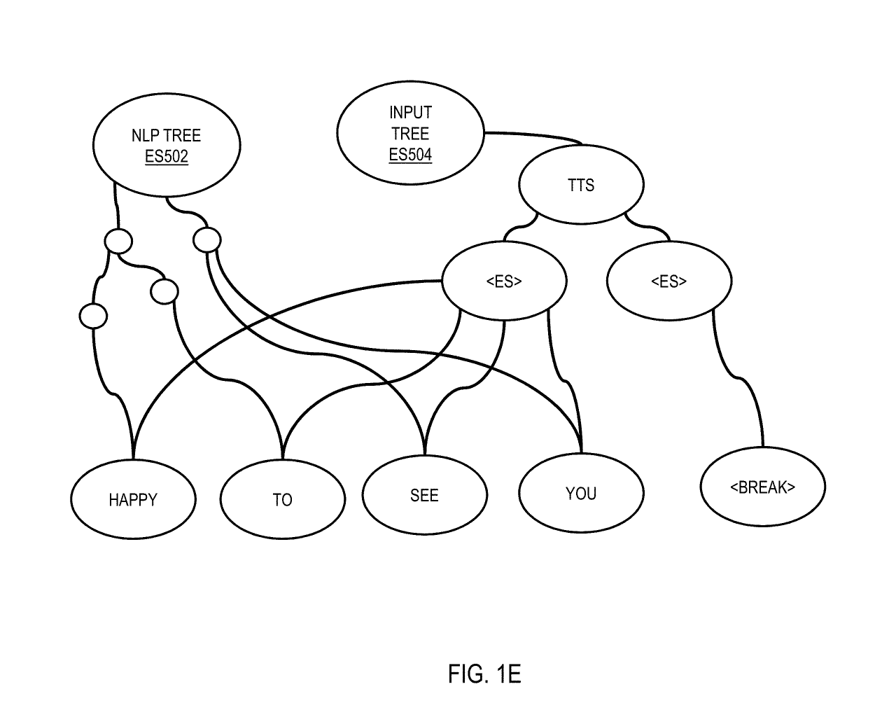

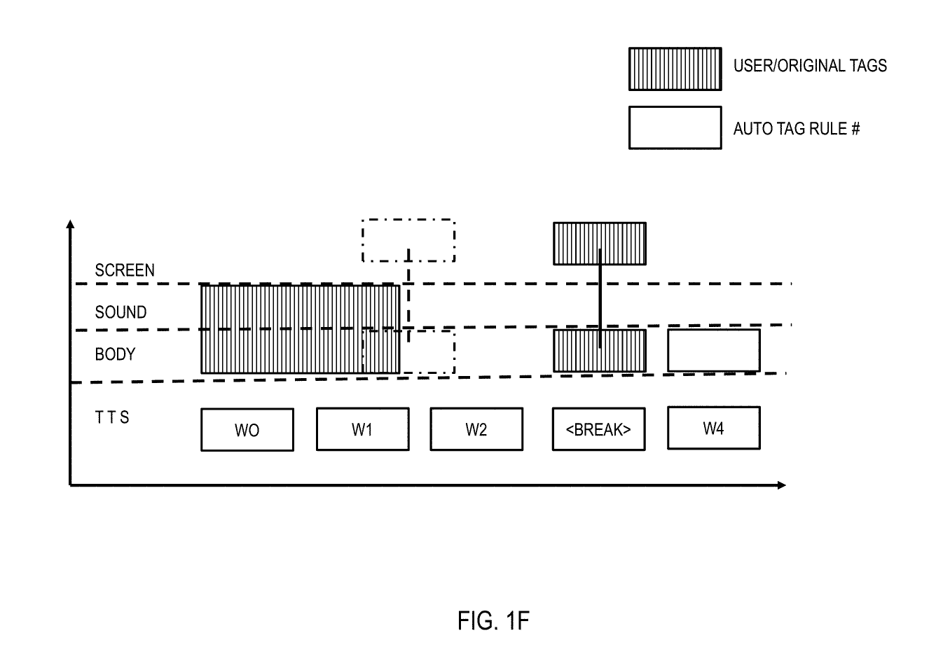

FIGS. 1A through 1F depict details of the embodied speech processing architecture and data structures according to some embodiments of the disclosure.

In accordance with exemplary and non-limiting embodiments, the social robot may facilitate expressive dialog between itself and a human user by combining natural language speech audio output commands with multi-modal paralinguistic output commands, as aforementioned.

This expressive performance can be generated in response to sensory inputs (e.g., vision, sound/speech, touch), task state (e.g., taking a picture, playing a game, answering a question, telling a story, relaying a message, etc.), or some other context (e.g., device state, time of day, special event such as a birthday, an information feed from the Internet, communication with another device, etc.).

These expressive paralinguistic cues coordinated along with natural language utterances may be coded or otherwise indicated through data structures (e.g., such as a source file, a text string, etc.) that an embodied speech generation capability of the social robot may compose, decode, and or otherwise interpret and integrate with the synchronized control of other expressive sub-systems when producing, generating or otherwise performing embodied speech outputs.

A social robot may be configured with control subsystems that operate cooperatively to facilitate embodied dialog as a form of user interaction. While an articulated embodiment of such a robot may include control subsystems related to mechanical manipulation, an emulated version of a social robot, such as on a mobile device or the like may include many of these same control subsystems.

Referring to FIG. 1A, a social robot may include a perception subsystem ES102 through which the social robot perceives its environment via sensor sub systems including: an audio localization facility ES104 that may include one or more microphone arrays and the like; one or more visual input systems ES108 that may include a digital camera and the like; a tactile sensing facility ES110 that may include touch or other tactile sensors disposed on portions of the body of the robot; a visual interface screen that may include a touch sensing screen ES112 and the like. The perception subsystem ES102 may also include processing facilities that provide processing of data retrieved by the sensor interfaces. These processing facilities may include a phrase spotter facility ES114 that may detect certain words or phrases being spoken to the social robot. The phrase spotter facility ES114 may operate on the social robot processing resources directly rather than being communicated up to a server for processing. The perception subsystem ES102 may also include an automated speech recognition facility ES118 that processes detected speech into structured data that represents the words. The ASR may perform speech recognition with the robot processing resources, with a server-based application that communicates with the social robot to receive, process, and return a structured representation of the spoken content.

Backing up the perception sub system ES102 is a Macro-Level Behavior (MLB) module ES120 that produces macro-level semantic understanding of text produced by the ASR ES118 as a set of semantic commands/content. In an example, the MLB may turn a phrase like “what is it like outside, Jibo” into a set of commands and content that facilitates a skill gathering the relevant weather data and providing a description of the current weather conditions.

The social robot also includes an output sub system ES130 that works cooperatively with the MLB ES120 and an attention subsystem ES140 to produce outputs for interacting with a human via embodied dialog. The output sub system ES130 includes speech generation, such as via a text-to-speech facility ES132 that works with an audio speaker, an imagery generating module ES134 that works with a display screen, a motion module ES136 that works with a multi-segment articulable body, light control ES137 that may work with an LED subsystem and sound generation ES138 that works with the audio speaker.

The MLB ES120 further includes a natural language understanding (NLU) facility ES122 that produces a structured semantic understanding of content received from the automated speech recognition sub system ES118, an embodied dialog facility ES124 that comprises an embodied listen facility ES126 and an embodied speech facility ES128. The embodied dialog facility ES124 communicates with the NLU facility ES122 to receive the structured semantic representation of the audio content processed by the ASR118. The embodied listen facility ES126 interacts with at least the ASR ES118 facility of the perception sub system ES102 to capture responses to the social robot's questions to a human and words spoken by the human that relates to a keyword or phrase, such as “Hey Jibo”.

The macro-level behavioral module ES120 communicates with a skill switcher sub system ES150 that listens for semantic understanding of a skill-specific launch command. When this launch command is detected, the skill switcher ES150 may evaluate robot context and switch to the skill identified in the command. The skill switcher ES150 facilitates switching among the different skills that the social robot is capable of performing.

In an example of use of the skill switching facility 150, the social robot may be currently operating in an idle skill ES152 monitoring inputs and directing attention to interesting and/or active areas of its environment, such as where sounds or movement or people might be detected. In this example a person walks up to the social robot and says a keyword phrase like “Hey Jibo”. The social robot detects this phrase using the phrase-spotter module ES114. Any subsequent audio is captured for conversion to text by the ASR ES118. So if the person says “what is the weather like in Washington?”, The social robot will detect this audio and also determine that the speech from the person is complete by detecting an “end of speech” marker, such as an end of the audio or completion of a sentence. The social robot will produce a text version of this complete spoken audio for further processing using the automatic speech recognition facility ES118.

This transcribed audio is provided to the MLB ES120 for contextual understanding. The MLB ES120 changes the audio into a structured query that may include a query subject, e.g., “weather” with one or more associated parameters, e.g., the location of the subject “Washington”.

The MLB ES120 provides this query (or portions of it) to the Skill switcher module ES150 that has registered various skills to correspond with portions of this structured query produced by the MLB ES120. It matches a skill (e.g., weather skill) to the query about the weather. The skill switcher ES150 will redirect the social robot's active skill from Idle to the matched skill (e.g., a weather skill).

The weather skill operation may be represented as a state machine depicted in FIG. 1B. The weather skill may invoke further interaction with the person (e.g., for clarification if any and to respond to the query). This is represented as a finite state machine in the embodiment of FIG. 1B. The first thing that the weather skill may do is to disambiguate the user's query (e.g., Washington state .vs. Washington D.C.). This happens by the social robot using embodied speech to ask one or more questions using a state machine.

The weather skill state machine is entered at ES202. The social robot then at step ES204 interacts with the human via an embodied speech function that uses the perception sub system ES102, the MLB ES120, and the output sub system ES130. The robot speaks a question prompt ES208 using the embodied speech module ES128 that takes text from the skill question, annotates it with various ES expression tags that cover various ways that the social robot can express himself. This enables the output sub system ES130 module to “decorate” the text being spoken with behavioral aspects, such as paralinguistic clues, hence the speech is embodied.

Once the social robot completes expressing the question prompt using the embodied speech facility ES128 portion of the embodied dialog module ES124, the social robot changes to a listening mode using the embodied listening module ES126 of the ES102 module. The embodied listen module ES126 engages the ASR module to take the audio detected after the question is expressed to convert it into text. The detected and converted speech is provided to the MLB ES120 module to get semantic understanding of what is heard in a structured form. That structured response form is provided to the embodied listen module ES126 (that requested the ASR to process the spoken words). The ES126 module flows the structured response form (or a relevant portion of it) to the requesting skill (here a listening portion ES210 of the disambiguation function). This flows back into the state machine instantiated to complete performance of the “weather” skill, where a particular path ES212 or ES214 is followed to resolve the query based on the disambiguation response.

While the ASR ES118 and MLB ES120 process is useful for detecting spoken content for skill switching, the social robot can launch a skill based on, for example information derived from an image captured by its vision system ES108, a third party alert and the like.

The skill switcher ES150 also allows skills to request control of the embodied speech subsystems, such as Perception module ES102, MLB ES120, and output module ES130. This access to control may be based on some relevant contextual information, such as a severe weather alert, update of information from a prior execution of the skill, a calendar event or request, and the like. It may also be based on environmental context, such as recognition by the vision system ES108 of a person known to the social robot to whom the skill-related contextual information may be useful. Of course it may be based on a combination of these plus a range of other factors, such as robot emotional state, current skill activity, and the like.

Related to embodied speech is the social robot taking actions to enhance the interaction with a human in his vicinity by, for example orienting the robot toward the human with whom it is interacting, such as when a keyword such as “Hey Jibo” is heard by the social robot. The vision system ES108 may also be useful during embodied dialog at least to keep the social robot oriented toward the speaker. However, there is other contextual information derivable with a vision system that can enhance embodied speech. For example, if a person speaking is perceived as carrying heavy items, the social robot could incorporate that into the interaction. If the person has a detectable stain on their clothes, or is wearing the same clothes as the last time the person met with a person whom they are about to see based on their calendar, the social robot could use this context in the dialog.

An attention system module ES140 may participate in the functioning of, for example a skill as a dedicated resource to the social robot to ensure the robot provides suitable attention to the person for whom the skill is being performed and with whom the social robot is interacting. For skills that do not require nearly dedicated attention to a proximal person, such as an “ambient” skill (e.g., playing music that a proximal person has requested), the attention system ES140 may develop at least partial autonomy to continue to look for opportunities to interact.

Operations performed among and within the sub systems that support embodied speech are depicted in FIG. 1C and described herein. As a starting point, embodied speech may rely on a data structure referred herein to as a Multi-Interaction Module (MIM). A plurality of these may be used to perform embodied speech. Each MIM may includes prompts, tags, and rules. An exemplary MIM is shown here:
a. Prompt: “<es cat=“happy”> Happy to see you!</es>
b. <es name=‘smiley_wigle_iboji’/>”
c. Rule: [ASR Rule]

In the MiM above, the text “Happy to see you, NAME” is tagged with a couple of Embodied Speech Module Language tags. The first tag is a derivative associated with to “Happy to see you”. The second is a tag for happy animation or imagery tagged to “NAME”. This MiM is input to an embodied speech function for presentation/delivery to the user. This function is represented in the flow chart of FIG. 1C. The MiM comes in as an optionally tagged prompt ES302. The MiM is XML parsed ES304 to discover the XML tag. The result is a pre-input tree (PIT) ES308 variant of the MiM.

The embodied speech process attempts to auto-tag the MiM to enhance the interactions to bring out more unique character traits and/or customize the interactions for the human. Auto-tagging of a MiM occurs when (i) a MiM is received without ESML tags and when (ii) the social robot is automatically generating content, like the weather, news, or any third party source that is text only.

There are many auto tagging rules that can be applied in specific situations, much like a specialized expert performing a tag for a specific purpose. Generally there are two types of auto tagging rules: (i) timeline altering rules (any rule that changes the duration or timing of the prompt e.g., speed up the delivery, insert a pause in the delivery) and (ii) non-timeline altering rules.

Continuing in the flow chart of FIG. 1C, pre-input tree XML parsed MiM entry ES308 is provided to the timeline altering auto rules module ES310. That produces a prompt with timeline altering tags ES312. Next step is to process the prompt text string ES312 with a lexigraphing function ES314 that identifies and organizes the words into individual nodes in a tree. The result is processed through text extraction ES318 to produce content that is free of tags to facilitate Natural Language Parsing with NLPs ES320. These are typically NLP processing algorithms ES320 to determine nouns, verbs, and noun phrases, sentence parts, and more advanced things like what part of the prompt is the setup and which is the main portion/conclusion of the sentence. Each NLP parser ES320 may operate to select a different part of the sentence. Each NLP parser ES320 generates a separate limb on a tree representation of the text in the MiM to be spoken. NLP parsing operations are depicted in FIG. 1D.

The individual NLP tree outputs ES321 and the original pre-input tree MiM content are merged in a tree merging module ES322. The result is a data structure that has mappings of words to different roots. In an example, each of the words “Happy to see you” may be rooted through different limbs of the NLP tree back to the original content to be spoken. Those same words and other aspects of the data may also be rooted to the source tags, such as a TTS behavior root tag, perhaps an animation behavior root tag, and the like. The resulting content includes many leaf nodes to many different trees as depicted in FIG. 1E that is described later herein.

The merged data from the tree merging module ES322 may then be processed by a resource resolver ES324 that sorts out all of the possible embodied speech expressions, body movement, and the like that may be possible for a given tag, such as “happy” to identify which expression “resource” to use. The resource resolver ES324 may use perception module ES102 input context, identity of the human, time of day, noise level of the room, personalization information (history of interactions, skills used, person's favorite animal or color. and the like), and other information that may be accessible to the social robot in a knowledge base to resolve the resources to identify one or more ESML tags of the possible range of EMSL tags associated with the MiM for each word, phrase, sentence or the like.

The result is a conversion of the tree-based representation of the MiM depicted in FIG. 1E to a timeline-based representation that reflects the animations, expressions, and the like to potentially be applied to each word to be expressed. A timeline composition module ES328 may produce this timeline view. This initial timeline view ES329 includes the NLP parsed output plus the original EMSL tags.

The NLP parsers ES324 also provide content to the auto tagging facility ES340 that applies various auto tagging rules to each of the NLP parsers outputs. The auto tagging methods and system described elsewhere herein may be applied by auto tagging facility ES340. These auto tagged embodied speech tags having been coupled to elements of the MiM (e.g., the words to be spoken) are then processed through a rules priority facility ES342 that can sort out which auto tag for each element of the MiM should have priority over other auto tags for each element. Next, the prioritized MiM elements are processed through a resource resolver ES344 for determining which of a possible range of potential expressions are to be used. The resource resolver ES344 then provides the resolved MiM to a timeline merging facility ES348. The result output from the timeline merging facility ES348 is a prioritized merged timeline view of the MiM with all tags resolved and prioritized.

Contemporaneously with tree merging ES322, the NLP ES324 outputs are processed by an auto tagging facility ES340 that applies the auto tagging rules to create autonomous EMSL tags. As an example, automated tagging rules are set for a range of MiM content, such as a “hot words” database of animations that match to certain words, a “birthday” hot word that links to displaying a birthday cake, and the like. These and other features of auto-tagging, such as self-learning, rheme-theme differentiation, and the like are further described elsewhere herein.

In reference to FIG. 1E, a multi-rooted tree view of the MiM is depicted. A first root, NLP ES502 represents the result of NLP processing of the text content of the MiM by the NLP Parsers ES324. A second root TTS ES504 represents the result of pre-input tree parsing that separates the embodied speech aspects defined in the input MiM from the text portions.

Referring to FIG. 1F, a consolidated timeline view that shows the possible action tags (EMSL tags) that have been applied to each element in the MiM. This view represents the result of combining the automated tagging with the tags received with the original MiM. This timeline view shows representative types of embodied speech features, display screen, sound, body movement/position, and text for speech that may be associated with each relevant element of the MiM. Here the elements are words (W0, W1, W2 and W4) and a pause (<break>).

Here the original MiM tags are represented by sound and body tags for the first two words (W0, W1), and a screen tag for the <break>. The autotagging process has identified a tag that activates the screen and the body across words W1 and W2. Because the source or user generated tag has priority over auto tags, the original tags for W0 and W1 are going to be applied when this MiM is implemented by the social robot. Therefore the body auto tag for W1 will be rejected. However, the screen auto tag for W1 and W2 will be executed. Note that the portion of the auto body tag configured for W1 and W2 may be performed for W2 by the social robot.

A second auto tagging rule applies a tag to word W4. Since there is no higher priority tag already applied to this word, the auto tagging rule tag is applied to the timeline. The result is a fully resolved timeline with no conflicts.

Referring again to FIG. 1C, the actions noted above to reject the body action for at least word W1, may be performed by a timeline merging facility ES348. The merged timeline is then compressed into an action dispatch queue (ADQ) by a ADQ generator ES332 that scans the resolved timeline data structure for start times of behaviors, such as a TTS behavior for words to be spoken, an animation action, a sound effect action, and the like. The ADQ then puts the resulting compressed timeline output into an action queue that is ready to get dispatched. The robot control systems, such as output facility ES130 and the like are activated for the various actions in the merged, compressed timeline MiM at the proper time based on the dispatch queue for the MiM. The dispatch queue comprises instructions and other content needed to control the audio, video, movement, lighting, and other output functions ES130 required to perform embodied speech of the MiM.

Embodied Speech from an Expressive Speech Markup Language (ESML)

An expressive or otherwise Embodied Speech Data Structure (ESDS) may define a plurality of expression functions of the social robot. Generally, combinations of expression functions are activated correspondingly to produce rich multi-modal expressions. Expression functions may include, without limitation, natural language utterances or multi-modal paralinguistic cues as aforementioned (in their many possible forms). Using such tools and interfaces, a developer has fine-grained control over how the social robot delivers an expressive performance or spoken utterance.

The Embodied Speech Data Structure can take a variety of forms. One example form is a text string where natural language text is marked up with specialized embodied speech tags that correspond to a repertoire of multi-modal expressive effects to be executed along with spoken language output (or in isolation). Embodied Speech Data Structures or elements/assets of such could be stored in a source file, a database, etc.

A set of rules for how to specify an Embodied Speech Data Structure to execute for a desired synchronization of spoken natural language along with multi-modal paralinguistic expression would make up an Embodied Speech Markup Language (ESML). Such rules denote what, when, and how different expressive effects correspond to tags that can be used to specify where in the textual representation of the utterance the effects should occur (an effect can be any of the above or a combination thereof). A set of ESML tags are provided that can include emotional expressions, multi-modal iconic effects, non-verbal social cues like gaze behaviors or postural shifts, and the like. These embodied speech tags can be used to supplement spoken utterance with effects to communicate emotion cues, linguistic cues, attentional cues, turn taking cues, status cues, semantic meanings, and the like. They can also be used as stand-alone performance without an associated text/spoken counterpart.

Authoring an ESML data structure to be performed by the social robot includes determining whether a natural language utterance as input will be sourced through text (to be synthesized via a text to speech (TTS) synthesis engine) and/or via audio recordings that can be transcribed into an input data source (for instance, converted to text via an automatic speech recognition (ASR) engine). A TTS source may be a manually generated text file and/or a transcription of an audio recording. Aspects of an authoring user interface may facilitate the developer speaking a word, phrase, or the like that is automatically transcribed into a text version to be accessible to the robot when needed to produce speech audio.

As is described elsewhere herein, expressive cues may be produced through use of an Embodied Speech Markup Language and Data Structure. As an example, aspiration and/or resonance may be defined as attributes of such a markup language that can be used when processing a text file for a TTS engine or other speech or paralinguistic language source to produce speech audio. The ESML markup can also specify a specific instance of multi-modal expressions (e.g., an expression of “joy”) to be coordinated Paralinguistic effects are performed with spoken output. An ESML is provided herein that allows for the production/specification, editing, and parsing/interpretation of communicated intent/content via embodied speech —that is tagged in a way that is easily parsed for commands that cause a social robot to engage in the multi-modal expression of that intent/content such as through synthesized speech (e.g., text-to-speech), expressive effects, paralinguistic cues, and the like—for controlling a social robot to convey emotion, character traits, intention, semantic meaning, and a wide range of multi-modal expressions.

ESML may comprise of a set of expressive effect tags. An ESML tag may comprise data that represents at least one of emotional expressions, multi-modal iconic effects, non-verbal social cues like gaze, behaviors or postural shifts, and the like. ESML tags may indicate paralinguistic language utterances, lighting effects, screen content, body movements, communicative behaviors, body positions, and the like. Tags may communicate or reference metadata that may help govern speech and embodied communication when the ESML is processed. Tags may be associated with at least a portion of a text-based word or utterance. Alternatively a tag may indicate that processing the ESML should result in certain behaviors that are adjusted based on an input, such as contextual, environmental or emotional input. The multi-modal expressive elements that correspond to a given tag may include paralinguistic language utterances, lighting effects, screen content, body movements, communicative behaviors, body positions, and the like. A ESML tag may also be associated with metadata to modulate expressive TTS parameters (e.g., pitch, timing, pauses, energy, articulation, vocal filters, etc.). As such, the ESML tag data may control expressive effects to communicate at least one of emotion cues, linguistic cues, attentional cues, turn taking cues, status cues, semantic meanings, and the like.

Timing of expression may be defined by an ESML tag and may span at least a portion of a word and can span any of: a part of a word, a single word, a phrase, a sentence, a set of sentences and the like. In this way, ESML tags may impact or induce any of the modes of expression that a robot is capable of including affecting speech, producing paralinguistic language, movement of one or more body segments, producing lighting effects, displaying imagery and/or text on a display screen, producing aromas, and the like. Tags can be inserted within a sequence of text to indicate where that multi-modal expression should be evoked during a spoken production. Tags can also modify a specific text string to indicate being performed in synchrony with that spoken output.

An ESML tag may identify a specific effect, but may alternatively identify a category of effects. There can be a 1:1 mapping of an embodied speech tag and an effect, or there can be a 1:n mapping where a specific embodied speech tag can refer to a category of effects. For example, an ESML tag may indicate that the social robot should convey a “happy” state, such that the robot can execute any of a variety of expressive elements that are identified (such as in a library) as conveying happiness, such as cheerful paralinguistic language utterances, happy on-screen emojis, or the like. The specific instance of the “happy” category to be selected and performed at execution time could be selected using a set of criteria such as intensity, history of what other instances have been performed, randomized selection, etc.). Such selection criteria may be based on wanting the robot's expression to be relevant, appropriate and “fresh” so that the variability of the performance is within a bounded theme but feels spontaneous.

Run-time execution of ESML tags may be conditional and based on various other contextual factors, such as a current state of the robot (including an attentive state, an emotional state, or the like), external stimuli, an aspect of an environment proximal to the robot, and the like. Within any given category of effects, a particular effect to be produced at the identified timing may be determined based on a criteria for variability of expression within the category so that the range of variability is bounded by aspects of the category, but can vary enough to appear spontaneous. In an example, a category of “joy” can cover a range of emotions from warmth to elation. Contextual data may facilitate determining a portion of the range of joyful emotions that should be expressed. Based on this determination, controls for the multi-modal expressive capabilities of the social robot can be configured and activated accordingly based on the identified timing of expression. Criteria that may be determined in this process may be at least one of intensity, prior instances of expressing an effect from this category, randomized selection, and the like.

### Embodied Speech Markup Language Tags

More specifically, ESML Tags may be used to specify where in the textual representation of the utterance the effects should occur (an effect can be any of the above or a combination thereof). ESML Tags can be inserted within a sequence of text to indicate where that multi-modal paralinguistic expression should be evoked during a spoken production for the correct synchronization and timing for the desired embodied speech performance. The timing of expression defined by an ESML tag may span at any of a part of an utterance: a portion of a word, a single word, a phrase, a sentence, a set of sentences and the like. In this way, ESML Tags may impact or induce any of the modes of expression that a robot is capable of performing including affecting speech (e.g., prosody or vocal filters), producing paralinguistic/audio effects, movement of one or more body segments, producing lighting effects, displaying imagery and/or text on a display screen, producing aromas, and the like.

Additionally, such rules could also include situations where a paralinguistic cue is performed without spoken output at all.

Alternatively, such rules also include the case where there is only affectation applied to spoken output where the utterance is to be synthesized in an expressive manner (e.g., vocal filters, prosodic parameters, articulatory parameters). Hence, ESML Tags may be associated with metadata to modulate expressive TTS parameters (e.g., pitch, timing, pauses, energy, articulation, vocal filters, etc.).

A wide range of ESML Tags can therefore be specified to capture the full range of paralinguistic cues with or without spoken utterances that a social robot can perform. The available ESML Tags could be organized into a ESML Tag Library. As aforementioned, this could correspond to body animations/behaviors/gestures, on-screen graphics/animations, vocal affectations and filters, sounds, lighting effects, etc. ESML tags could be organized per type or category of aforementioned paralinguistic cues such as categories/types of emotional expressions, multi-modal iconic effects (to supplement semantic meaning), non-verbal communicative cues (that support dialog such as gaze behaviors, turn-taking, listening cues, or postural shifts), and the like. As such, the ESML Tag data may control expressive effects to communicate at least one of emotion cues (joy, frustration, interest, sorrow, etc.), semantic/iconic cues that represent a concept (e.g., icons/symbols/photos/videos to represent concepts, media, information, identifiers, numbers, punctuation, nouns, verbs, adjectives, etc.), attentional cues, dialogic/turn taking cues, cognitive status cues (e.g., thinking, searching for information online, etc.), other communicative meanings/intents (e.g., acknowledgements, greetings, apologies, agreements, disagreements, etc.), and the like.

Furthermore, ESML Tags could correspond to a specific instance or combination of expressive effects to be performed with a specific intent (e.g., a “happy” ESML tag could be used to trigger the performance of a specific combination of a body animation, a screen graphic, and a sound effect that conveys a joyful emotion.).

ESML tags that represent a category of intents could map to a collection of assets for multiple ways to express that intent. In our example of a “happy” ESML tag, the specific instance of the “happy” category to be performed at execution time could be selected using a set of criteria such as intensity, history of what other instances have been performed, randomized selection, parameters for personalization based on the recipient, etc. As noted above, an ESML Tag may also call up a very specific expressive asset (e.g., a specific file denoting a particular graphical animation, a body animation, etc. in a library or database of assets). Such selection criteria may be based on wanting the robot's expression to be relevant, personalized, appropriate, and “fresh” so that the variability of the performance is within a bounded theme but feels spontaneous and authentic.

The specification and creation of new ESML tags could occur in multiple ways ranging from full authoring by a developer to full automatic generation through machine learning techniques by the robot. In regard to defining new ESML tags and associating them with a library of multi-modal expressions, we describe such tools and interfaces with extensions later in this document.

For instance, the robot could create new ESML tags and learn the mapping of a specific ESML tag with associated multi-modal assets within the robot's library/database of expressive paralinguistic cues. This could be learned by example by gathering a corpus of developer authored ESDS and applying statistical machine learning methods to learn reliable associations of keywords with expressive assets. This may be particularly useful for mapping iconic screen-based animations and graphics to target words that have an associated ESML Tag.

As an example, consider the case where an ESML Tag for “hot” is not pre-defined in the ESML Tag library. By analyzing a corpus of ESDS for semantic content (e.g., identifying adjectives, nouns, etc.) and multi-modal asset association (i.e., how developers have authored a specific iconic animation to go along with the word “hot”), the Embodied Speech system could learn to statistically associate the appearance of the word “hot”, potentially with other synonyms (e.g., “scorcher”, “warm”, “sizzle”, etc.), with specific instances of expressive assets (e.g., certain expressive sounds like a rising whistle or a cracking sound of fire; certain graphical assets such as a flame, or thermometer with high temperature, a sun, etc.). The Embodied Speech system could then auto-generate a suggested ESML Tag for “hot” with those associated multi-modal expressive assets. Once a new ESML Tag has been learned, it can be used either by the Embodied Speech System when automatically generating new ESDS, or make that tag available in the ESML Tag library and expose it via a developer interface tool so that developers could use that new ESML tag when authoring ESDS.

### Automatic Markup of Utterances Using ESML Tags

Given a Library of ESML Tags and a text prompt to be spoken, the production of an Embodied Speech Data Structure (ESDS), such as a text string marked up with ESML Tags, could occur in multiple ways ranging from full authoring by a developer to full automatic generation by the robot.

Hence, a developer could use a set of tools and interfaces to author an ESDS to be performed by the social robot. In terms of developer authoring of ESDS, we describe such tools and interfaces with extensions later in this document.

Alternatively, the Embodied Speech System could receive an unmarked text string—such as a text string coming directly from an online service (e.g., news, weather, sports, etc.), and the Embodied Speech System could perform automatic ESML Tag markup based on an analysis of that text string. Another possibility is where the embodied speech system receives a text string dynamically generated in real-time by the robot's own dialog system, analyzes it, and does automatic markup.

Methods and systems of social robot embodied speech may include a set of techniques and technologies by which an expressive utterance system on a social robot can take a textual input that represents a spoken utterance and analyze its meaning. Based on this analysis the tools automatically insert appropriate ESML tags with timing information to be performed by a social robot at execution time.

The system, once implemented, automatically generates expressive spoken utterances to be performed by a social robot that are comprised of at least one of or a combination of at least two of, a natural language utterance with crafted expressive prosodic features, paralinguistic audio sounds, animated movements or expressive body positions or postures, screen content (such as graphics, photography, video, animations, etc.) and/or lighting effects.

The rules governing the markup using ESML Tags can be based on a number of analyses performed on the text string including but not limited to: punctuation, sentiment or emotional analysis, semantic analysis (for example, is this utterance presenting a list of options, making a confirmation, asking a question, etc.), information or topical analysis (is this an utterance about the weather, news, sports, etc.), “hot word” recognition that could be mapped to multi-modal icons that visually or auditorily represent that word, environmental context (e.g., the specific person or persons speaking to the robot, personalization information such as likes, dislikes or preferences of people, location of people around the robot, time of day, time of year, history or interactions, etc.), and the like.

In embodiments, these different analyses may be performed in parallel by different processing nodes, such as a node that tags based on punctuation, a node that tags based on specific word content like “hot words”, and a node that provides more general tagging based on grammatical analysis of the text string using a NLP parse tree to separate into theme or rheme with corresponding paralinguistic cues to show a change of topic. Some could be based on machine learning, such as learning new ESML tags with associated content, among others. The output markup from different processing nodes can be merged to provide a final embodied speech timeline of content (that is sent to an action queue to be performed by the different output modalities).

The use of ESML tags applied to the text string can be implemented and refined based on a set of timeline resolution rules. For example, rules can be specified that determine what tags will be used among different tags for the same content, rules can resolve timing issues so the paralinguistic cues are performed within the timing constraints of TTS timing information. Rules can also provide precedence of human-authored tags over automated tags in cases of conflicts, or to delete some tags if the number of tags exceeds a threshold frequency (such as may occur when dialog is tagged by multiple different nodes, resulting in many tags that appear with very high frequency in the dialog). In the presence of ESML tags initially provided by the prompt author/developer, the system can inject automatic tags to a prompt that merges with pre-existing tags. The prompt author can choose to disable the system as a whole, or any specific auto-tagging rules of the system both at the level of an interaction as well as the level of an individual prompt.

Automation may be accomplished by use of machine learning, such as by having a machine learning system, such as a machine classifier or statistical learning machine, learn on a training set of utterances that have been marked with embodied speech tags by humans and how that corresponds to different expressive assets. The machine learning-based automatic tagging system may be provided feedback, such as by having humans review the output of machine tagging, so that over time the automated tagging system provides increasingly appropriate tagging.

### Diction Engine

A social robot may employ a Diction Engine for producing natural language speech from text (TTS), using transcribed recorded speech, and the like. The diction engine may be invoked in response to at least one interaction context detected by the social robot. Interaction context may include without limitation conveying detailed and specific information, providing clear instructions for addressing issues quickly (working through errors), building human emotion-like or relationship bonds between the social robot and a human (creating personal relationships, conveying empathy, etc.), proactive commentary, expressive reactions, pacing interactions according to the context, leading a human through a set of complex interactions (providing clear guidance), and the like.

In embodiments, the diction engine may have one or more modes that can be invoked to reflect the context of interactions of a social robot with one or more individuals or with one or more other systems or environments. For example, the social robot platform may determine a context in which the social robot should play a directive role, such as guiding a human through a set of instructions, in which case the diction engine may employ a mode that focuses on clarity and technical accuracy, such as by having very clear, grammatically correct pronunciation of spoken language. Similarly, the social robot may identify instead a primarily social context in which the diction engine may employ a mode that promotes social interaction, such as by using informal grammar, a pace that reflects a casual or humorous tone, or the like. Thus, various modes may be invoked to reflect context, allowing the robot to vary diction in a way consistent with that of human beings, who speak differently depending on the purpose of their interactions.

The diction engine may combine an interaction context with expressive effect tags, such as those made possible through the use of an ESML authoring interface as described herein or through a learning capability of the social robot to provide further variation within a given interaction context. Additionally, sensed context and/or state of the robot may contribute to such variation. As an example when the social robot determines that it should play a directive role of providing instructions to a child, it may choose to use a slower porosity and/or adjust inflection on words and/or adjust a pitch of speech, much like a human would when talking to a child rather than to an adult. Generally, generating an utterance may be based on ESML tags, a user's emotional state or prior interactions, and the like. Such adjustment of utterance may be implemented by automatically generating appropriate tags for use by a TTS engine. Context that may be used for such automatic generation of tags may include text, voice, vision, and any range of information that may be accessible from a knowledge base.

### Automatic Markup of Embodied Speech Cues for Spoken Utterances

FIGS. 7A and 7B provide high level flow diagram for embodied dialog according to some embodiments of the disclosure.

Methods and systems of social robot embodied speech may include a set of techniques and technologies by which an expressive utterance system on a social robot can take a textual input that represents a spoken utterance and analyze its meaning. Based on this analysis the tools automatically insert appropriate embodied speech tags to be performed by a social robot at execution time. Automation may be accomplished by use of machine learning, such as by having a machine learning system, such as a machine classifier or statistical learning machine, learn on a training set of utterances that have been marked with embodied speech tags by humans. The machine learning-based automatic tagging system may be provided feedback, such as by having humans review the output of machine tagging, so that over time the automated tagging system provides increasingly appropriate tagging. The system, once implemented, automatically generates expressive spoken utterances to be performed by a social robot that are comprised of at least one of or a combination of at least two of, a natural language utterance with crafted expressive prosodic features, paralinguistic language expression, animated movements or expressive body positions or postures, screen content (such as graphics, photography, video, animations, etc.) and/or lighting effects. The use of tags can be based on a number of analyses performed on the text string including but not limited to punctuation, sentiment or emotional analysis, semantic analysis (for example, is this utterance presenting a list of options, making a confirmation, asking a question, etc.), information or topical analysis (is this an utterance about the weather, news, sports, etc.), word recognition that could be mapped to multi-modal icons that visually or auditorily represent that word, context (e.g., the specific person or persons speaking to the robot, personalization information such as likes, dislikes or preferences of people, location of people around the robot, time of day, time of year, history or interactions, etc.), and the like. In embodiments, these different analyses may be performed in parallel by different processing nodes, such as a node that tags based on punctuation, a node that tags based on specific word content, and a node that provide more general tagging based on machine learning, among others. The output from different processing nodes can be merged to provide a unified item of content that has tags based on the different nodes. As noted above, the automatic markup rules can also be learned from statistical machine learning methods based on examples of meta-tagged utterances done by people to learn associations of embodied speech tags to words, phrases, sentences, etc. The use of tags can be implemented based on a set of rules. For example, rules can be specified that determine what tags will be used among different tags for the same content, such as to provide precedence of human-authored tags over automated tags in cases of conflicts, or to delete some tags if the number of tags exceeds a threshold frequency (such as may occur when dialog is tagged by multiple different nodes, resulting in many tags that appear with very high frequency in the dialog). As another example, in the presence of ESML tags provided by the prompt author, the system can inject automatic tags to a prompt that merges with pre-existing tags. The prompt author can choose to disable the system as a whole, or any specific auto-tagging rules of the system both at the level of an interaction as well as the level of an individual prompt.

FIG. 7A depicts a flow diagram for parsing audio input (702) for generation of ESML structured content. An input (702) may be received and parsed (704) for three aspects (i) text (706), (ii) audio effects (708), and (iii) behavior (710). Markups of each may be automatically generated (712). The three markups may be combined into a single ESML content stream that can be used to operate the robot (714).

In some instances, the social robot may compute that a received audio input or utterance is a low probability speech recognition event. Specifically, it may be determined that there is low probability that the input was intended for or directed to the social robot. For example, someone says “blah blah blah robot blah blah blah” and all the “blah blahs” don't match any known grammar or otherwise indicate that it is unlikely that the robot is being targeted for social interaction. The speaker may be on the phone to a friend saying “I just bought this cute robot; you should get one, too”. Instead of the social robot saying “I'm sorry, can you repeat that?” or taking some action that may not be appropriate, the social robot may make, for example, a paralinguistic sound that implies “I'm here, did you want something?” If the speaker's sentence was just part of the phone conversation, the speaker can just ignore the paralinguistic audio sound and after a few seconds the social robot will stop listening for further direct communication.

### Types of Paralinguistic Cues and Data Structures

As aforementioned, a social robot can convey a wide assortment of paralinguistic cues to convey and communicate different intents, character traits, meanings, and sentiments.

For instance, paralinguistic cues may be used to convey an emotional or affective states such as how energetic or tired the robot appears, or a sentiment such as whether the robot approves, disapproves, etc. Paralinguistic cues may serve communicative functions such as turn-taking, directing gaze, active listening for speech input, etc. Paralinguistic cues can be used to signal social intents such as greetings, farewells, acknowledgements, apologies, and the like. Paralinguistic cues may be used to signal internal “cognitive” states of the robot such as thinking, attention, processing, etc. Paralinguistic cues can also be used to supplement or augment semantic content, such as the iconic representation of ideas through visuals and sounds such as graphically depicting the concept of “cold” with an image of a snowflake on the screen, a shivering body animation, and the sound effect of “brrrr”. See Appendix A, Table 4. This is not an exhaustive list, but conveys the wide range of roles that paralinguistic cues serve.

In this section, we catalog a non-exhaustive range of multi-modal paralinguistic cues and associated data structures that a social robot might employ in order to perform appropriate paralinguistic cues for different contexts, purposes, and intents. Such cues are canonically associated with ESML Tags that are used to create ESDS for expressive multi-modal performance by the robot.

Data structures to support the performance of synchronized multi-modal outputs associated with paralinguistic cues can take a variety of forms. Sound files (e.g., .wav) can be used to encode sound effects. Graphical animation files (e.g., .fla, etc.). can be used to encode on-screen graphics and animation effects. Body animation files (e.g., .anim) can be used to encode body movements as well as real-time procedural on-screen graphics (e.g., graphical features that that might be associated with a robot's body such as face, eyes, mouth etc.). A vocal synthesizer data structure could be used to encode the prosodic effects or articulatory filters for a spoken utterance. LED data structures could be used to control the color, intensity, timing of lighting effects and so on.

Flexible compositions of multi-modal outputs associated with paralinguistic cues can be represented by a Paralinguistic Data Structure (PDS) that support the mix-and-matching of output assets, or the parametric adjustment of features (e.g., prosody of an utterance). This flexibility enables fine-tune adjustment or spontaneity of the real-time performance by the robot.

For instance, the Paralinguistic Data Structure could be represented as a vector with a set of fields, where each field points to a specific kind of multi-modal asset file (see Figure). Namely, the first field could point to an audio asset, the second field could point to a body animation asset, the third field could point to a graphical asset, the fourth field could point to LED effect, etc.

To enable variations for how a PDS might be performed at a given moment, each field could point to a specific instance of that type of asset, or to a collection of assets of that type. The selection of a particular asset of that type could be based on a number of parameters such as length of time that asset takes to perform, the last time that asset was used, personal preferences of the user, and other contextual information. For instance, a specific PDS to convey an emotion, such as sorry, may have each field point to a collection of output assets: a set of sad sounds like a trombone “wah wah wah” or a “aww” vocalization, etc.; a set of graphics that depict sorrow like a teardrop or a sad looking frown, etc.; a set of sad body animations like a slump or shaking of the head, etc. At a given moment, the Embodied Speech System uses its selection criteria to assemble a specific combination compromised of each type of expressive asset based on compatibility (e.g., timing constraints, etc.) and other factors. In this way, the ESML Tag for “sorrow” could be expressed at one moment as a trombone sound with a teardrop on the screen and the robot shaking its head, and in another moment as a “aww” vocalization with a sad frown and a slumped body posture, etc.

In accordance with an exemplary and non-limiting embodiment, the social robot may have access to a library of stored Paralinguistic Data Structures (PDS) and associated expressive assets. Such a library of PDS may be stored in a memory resident within the social robot or may be stored external to the social robot and accessible to the social robot by either wired or wireless communication.

Additionally, pre-crafted combinations of modes may be grouped for more convenient reference when authoring and/or producing expressive interaction. In particular, packaged combinations of paralinguistic audio with other expressive modes (e.g., graphical assets, robot animated body movement, lighting effects, and the like) may be grouped into a multi-modal expressive element, herein referred to as a “jiboji”. ESML tags) may refer to a specific jiboji in the library. Additionally, a ESML tag could correspond to an extended group of jiboji that represent a category of expressive ways to convey the expressive meaning associated with that tag. The selected jiboji to be performed at run time could be chosen based on a selection criteria as described above (e.g., based on user preferences, time, intensity, external context based on task state or sensor state, etc.).

Jibojis could be authored by developers using an authoring toolkit and integrated into a library to run on a social robot.

Libraries of PDS and/or jiboji could be shared among a community of social robots to expand their collective expressive repertoire.

### Iconic Paralinguistic Cues

While a social robot may employ multiple output modes for expression, an important use case is to supplement spoken semantic meaning with reinforcing multi-modal cues such as visuals, sounds, lighting and/or movement (e.g., via use of jiboji). The on-screen content can be a static graphic or an animation, or it could be supplemented with other multi-modal cues. As an example, the spoken word “pizza” may connote the same meaning as an image of a pizza. The on-screen content can be a static graphic or an animation, or it could be supplemented with other multi-modal cues. For instance, the robot might say “John wants to know if you want pizza for dinner” where an icon of a pizza appears on screen when the robot says “pizza”. Alternatively, the robot may put text on the screen “John wants to know if you want [graphic pizza icon] for [graphic dinner place setting icon].” Text display on a screen may be derived from text in a TTS source file and may be used for display as well as speech generation contemporaneously.

A set of “hot words” could be specified that map to specific jiboji, such that “hot words” in a written prompt can be automatically substituted out for the corresponding jiboji. Alternatively, hot words in a spoken prompt using a text-to-speech synthesizer would still be spoken but the corresponding jiboji would be displayed at the time the hot word is uttered by the robot.

Broadly speaking, the semantic meaning of utterances can be enhanced with jiboji or other PDS as a way to reinforce or augment key concepts in a spoken delivery. For instance, a set of jiboji could be authored that correspond to a large library of nouns, verbs, adjectives, icons, symbols, and the like. In accordance with yet other exemplary embodiments, use of PDS and/or jiboji may reduce a cognitive or behavioral load, or increase communication efficiency, for visual-verbal communication between a social robot and at least one other human.

### Paralinguistic Non-Speech Audio Cues

In accordance with an exemplary and non-limiting embodiment, the social robot may have access to a library of stored paralinguistic non-speech sounds (PNSS) that convey meaning in a format that is distinct from a natural human language speech format.

A particular type of PNSS is a “paralinguistic” sound. Paralinguistic refers to sounds that may lack the linguistic attributes essential to a language such as, for example, grammar and syntax, but may be considered a type of vocalization. For example, this corresponds to vocalizations such as ooo, aaah, huh, uh uh, oh oh, hmm, oops, umm, sigh, and the like. In exemplary embodiments, paralinguistic sounds are configured to convey specific meaning and may express at least one of an emotive response, a cognitive state, a state of the social robot, a task state, and/or paralinguistic/communicative states, and/or content, and the like. In some embodiments, as described more fully below, each paralinguistic sound may be attributed such as with one or more group designations.

In some embodiments, at least a portion of PNSS or paralinguistic sounds correspond to at least one human emotion or communicative intent. Prosodic features, duration, timing of these paralinguistic audio sounds may be highly associated with such emotions or communicated intents for an intuitive understanding of their meaning. Examples include but are not limited to laughter, sighs, agreeing sounds (e.g., “mm hmm”), surprise sounds (e.g., woah!”), comprehending/agreeing sounds (e.g., “uh huh, ok”), and so forth.

The library of PNSS sounds may dynamically change and increase over time. This may be due to additional PNSS assets being added to the library by developers. Alternatively, the robot may acquire new PNSS from learning them during interactions and experience, such as through imitation or mimicry. Potentially, the robot may even record a sound and add it to its own PNSS library.

In some instances, a social robot may develop and/or derive paralinguistic sounds from interactions with users of the social robot. For example, through interaction with a young child, the social robot may observe that, in response to an occurrence engendering negative emotions, the child says “Uh-oh!”. In response, the social robot may derive a paralinguistic sound or series of paralinguistic sounds that mimics the tonalities and cadence of the uttered “Uh-oh!”. When, at a later time, the social robot interacts with the user and emits or broadcasts the derived paralinguistic sounds in response to a negative occurrence, the similarity between the derived paralinguistic sounds and the vocabulary of the user may serve to produce a feeling of camaraderie between the user and the social robot.

While described as defined sounds, a uniquely defined PNSS may be altered when emitted to enhance characteristics of an interaction. For example, the same PNSS sound may be transposed to a different octave, may be sped up or slowed down, and/or may be combined with various effects, such as, for example, vibrato, to match an intended emotional mood, social environment, user preference, and any other condition that is detectable and/or derivable by the social robot.

In accordance with an exemplary and non-limiting embodiment, the social robot may produce and emit a plurality of interrelated audio layers that may be layered one with the other in real time to convey and/or reinforce specific meaning of a multi-media message being communicated from a social robot. In some embodiments, a variety of speech or non-speech modes may be employed for defining the audio layers.

In some embodiments, a first, or “base” layer, may be comprised of one or more elements such as a human performed time/pitch contour playback of a base sound such as: a human pre-recording, a text to speech utterance, a sound effect, and/or a paralinguistic sound.

In some embodiments, a second layer may be an algorithmically randomized run-time melodic addition to the base layer or some other auditory filter. Potential benefits of the algorithmically randomizing include avoiding the same phrase sounding the same each time it is spoken. Additionally, randomizing further ensures that, for example an emotional harmonic key/mode and performance contour is followed, but within some degree of variation to add depth and interest to the social robot speech.

In some embodiments, the overall prosodic contour (e.g., the pitch/energy) as well as other speech-related artifacts like speaking rate, pauses, articulation-based artifacts that may change the quality of the voice to convey emotion, etc. may be procedurally varied so that the social robot may say the same thing with variations in delivery, thus conveying and/or reinforcing a specific meaning of a multi-media message being communicated by the social robot.

In some embodiments, synthesizer overlays may be employed to contribute a characteristic affectation to the English utterances. A set of algorithmic audio filters and overlays may be algorithmically applied to the social robot's text-to speech operations to procedurally produce a unique voice for the social robot that is expressive and intelligible, but with a distinct technological affectation that is unique to the social robot and a core element of a brand and character.

In some embodiments, the overall prosodic contour (e.g., the pitch/energy) as well as other speech-related artifacts like speaking rate, pauses, articulation-based artifacts that may change the quality of the voice to convey emotion, etc. may be procedurally varied so that the social robot may say the same thing with variations in delivery, thus conveying and/or reinforcing a specific meaning of a multi-media message being communicated by the social robot.

In some embodiments, the PNSS may be grouped into a plurality of intent-based groups. A group can map to a specific ESML tag that represents that corresponding category. Markup tags may then be used, such as by an author of embodied speech for the social robot, to designate the use of PNSS defined by attribute.

For example, a developer may encode a physical response by the social robot to be accompanied by a type of PNSS as indicated by an embedded syntax such as “[PNSS: attr.happy]”. In such an instance, the social robot may access one or more stored PNSS audio assets for playback, having a group attribution indicating a “happy” sound. In this way, the social robot may be instructed to produce PNSS audio output in a generic manner, whereby the actual performance of the task of producing the specific audio effect may be tailored to the use environment. For example, with reference to the above example, an instruction to play a happy sound may result in the social robot playing the derived PNSS associated with the user's “oooh” sound wherein such sound has been previously attributed as and grouped with happy sounds and the “happy” ESML tag.

Other intent-group designations include those configured around a semantic intent: such as confirmation, itemizing a list, emphasizing a word, a change of topic, etc. Another is expressive intent: such as happy sounds, sad sounds, worried sounds, etc. Yet another is communicative intent: such as directing an utterance to a specific person, active listening, making a request, getting someone's attention, agreeing, disagreeing, etc. Finally, other groupings could include configurations around a device/status intents: such as battery status, wireless connectivity status, temperature status, etc. In addition, there could be a GUI interface intent: such as swipe, scroll, select, tap, etc. In yet other exemplary embodiments, an intent-based group may be configured around a social theme, such as a holiday and the like.

In accordance with exemplary and non-limiting embodiments, use of PNSS may reduce computing load of a social robot required for verbal communication between a social robot and at least one of a human and a social robot. For example, the use of paralinguistic sounds to convey meaning to a user does not require the processing resources utilized when, for example, performing text-to-speech conversion. This may be determined at least by the generally shorter duration of a paralinguistic utterance to convey the same or a substantially comparable meaning as a sophisticated text to speech phrase/sentence.

Additionally, paralinguistic audio may generally be short phrases or utterances that are stored as audio files/clips and processed to adjust an intent—this is described herein. Conversely, the social robot may be able to process a received paralinguistic sound, such as from another social robot, using fewer resources than when receiving spoken text or audio. This may occur at least because each paralinguistic audio utterance may be mapped to a specific meaning, whereas each word in a sentence may have multiple interpretations based on context that must be derived through processing.

In accordance with yet other exemplary embodiments, use of PNSS may reduce a cognitive or behavioral load, thus increasing communication efficiency, for verbal communication between a social robot and at least one of a human and a social robot. For the reasons noted above use of PNSS audio can reduce the processing load for interactions that incorporate paralinguistic audio production and/or detection. Indeed, these paralinguistic non-speech sounds could be used as a form of social robot to social robot communication, too.

### Emotion and Affect Paralinguistic Cues

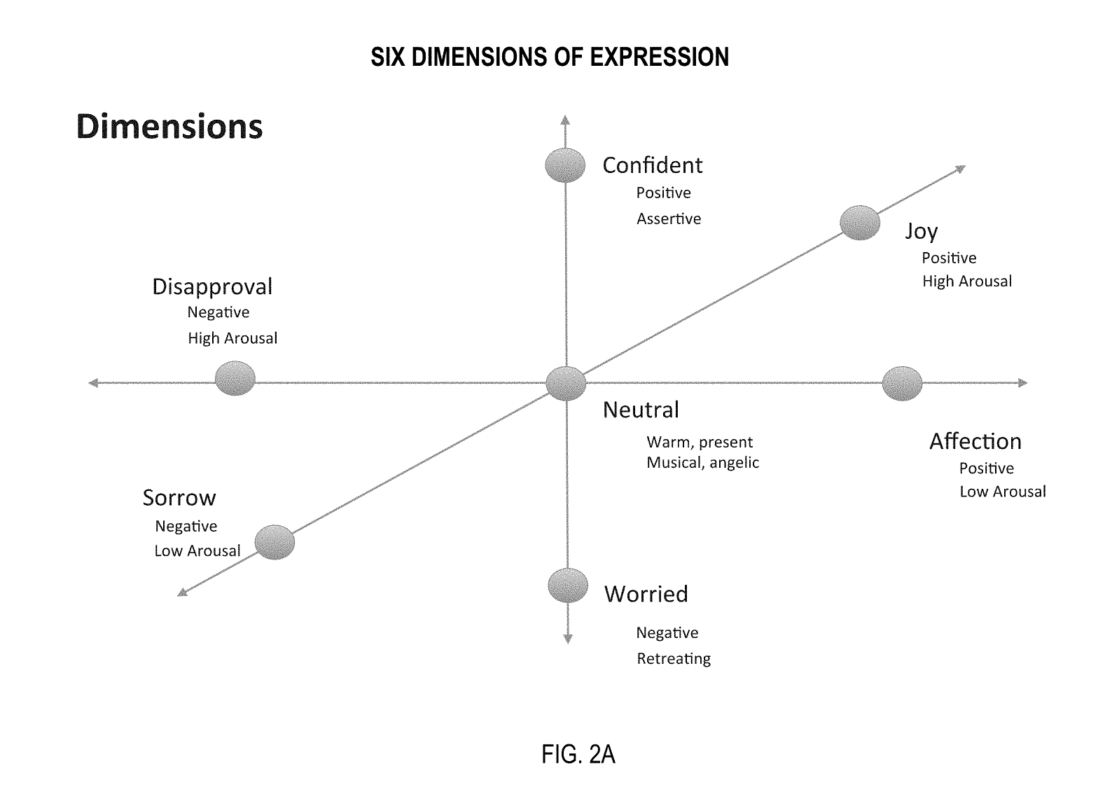

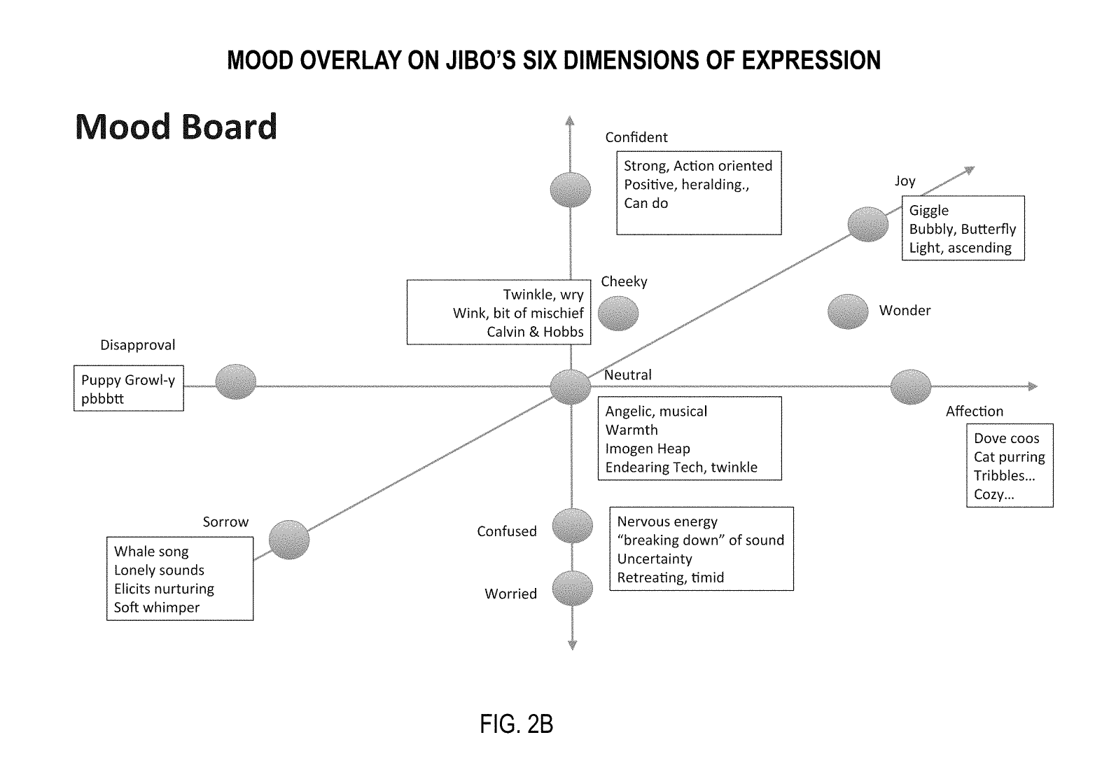

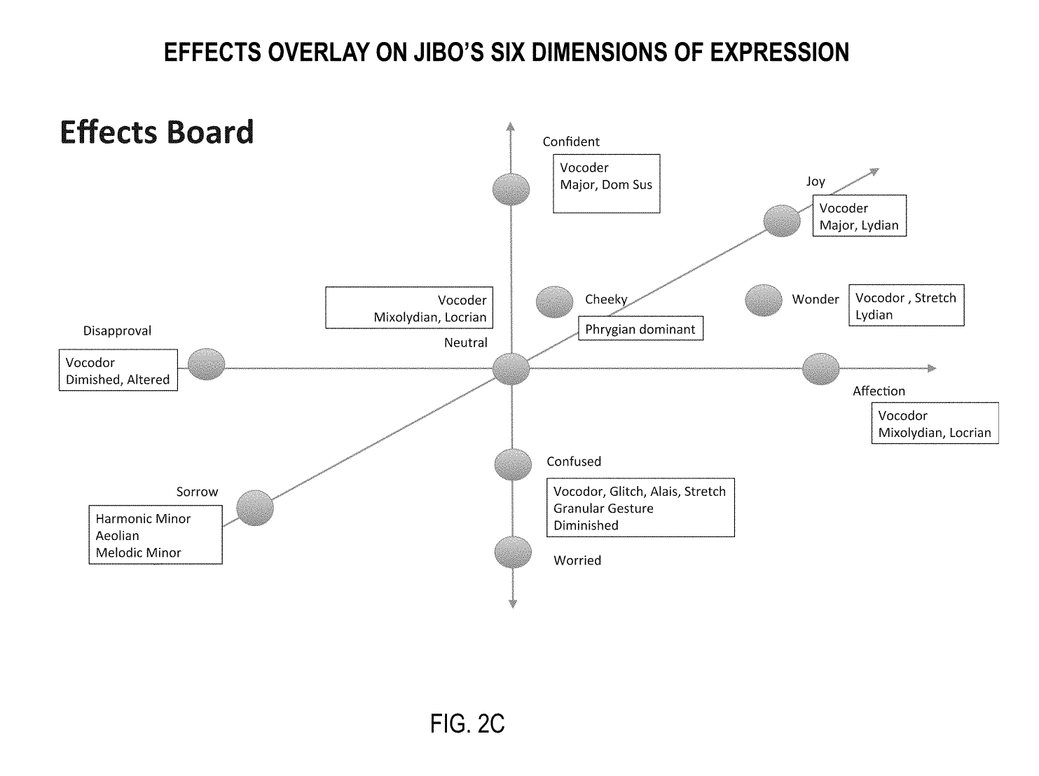

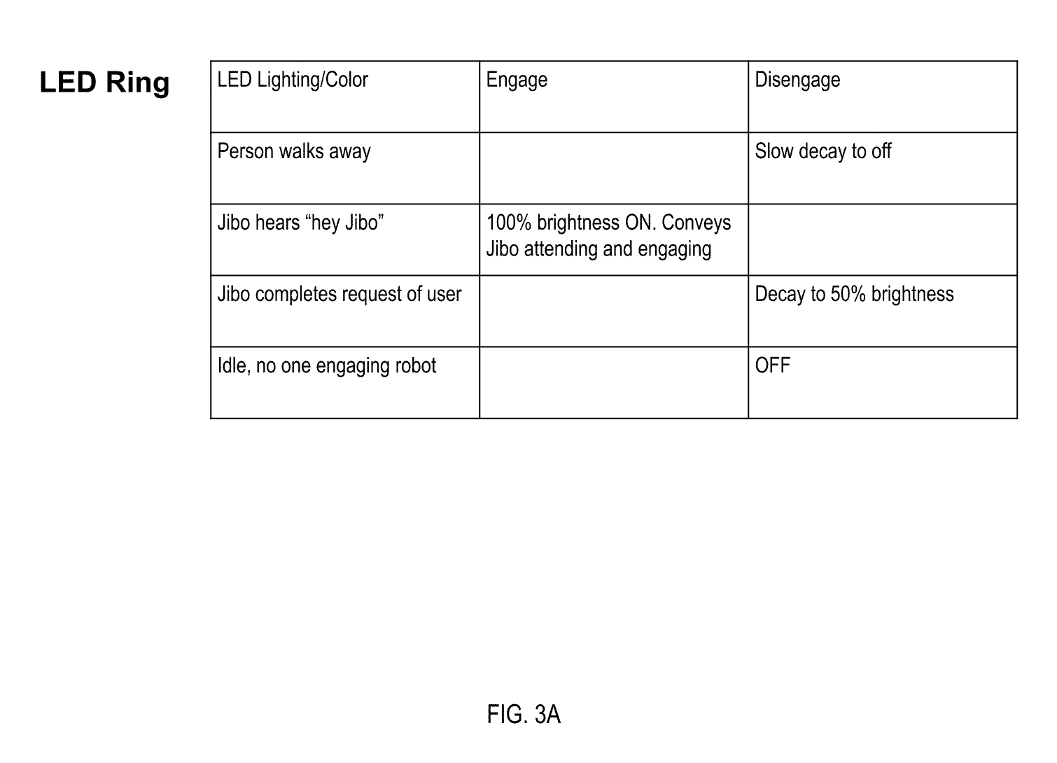

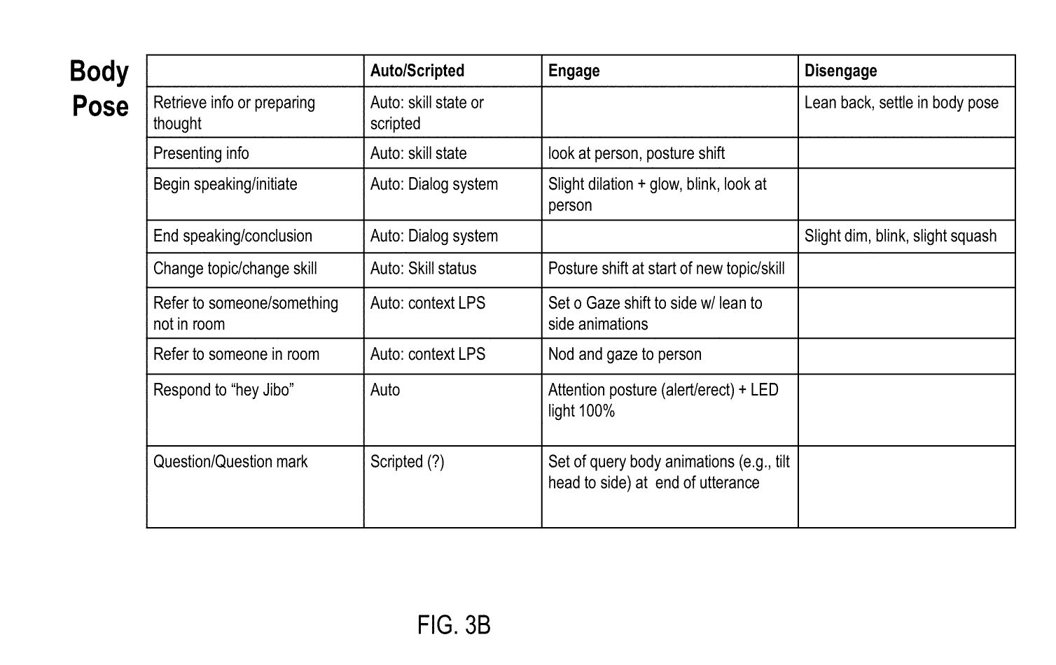

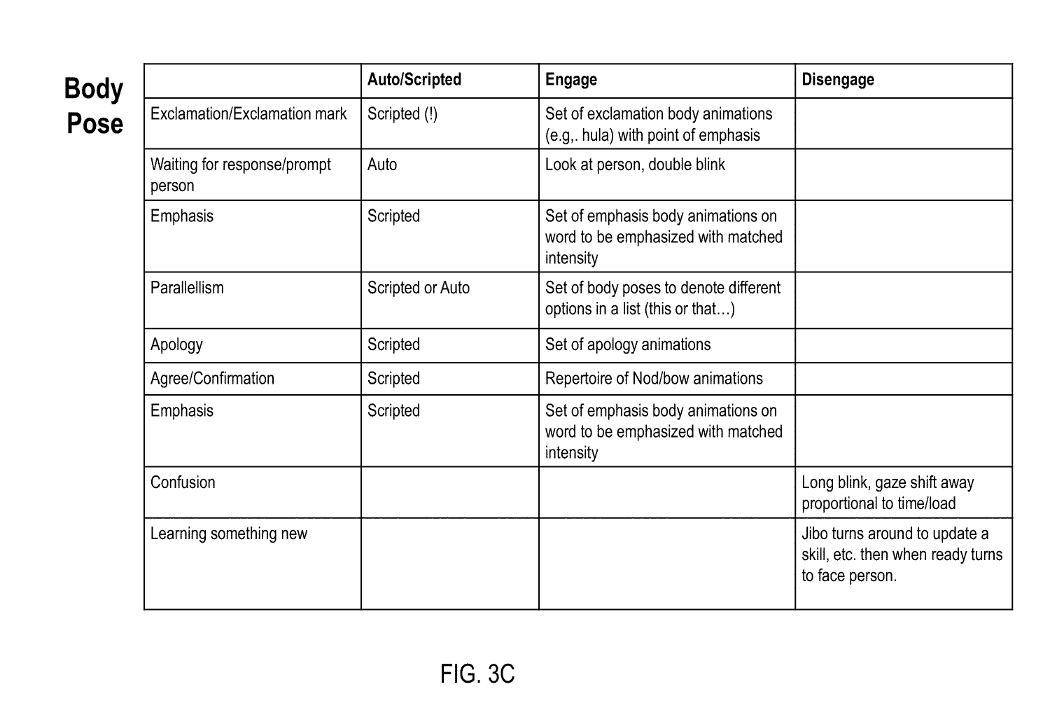

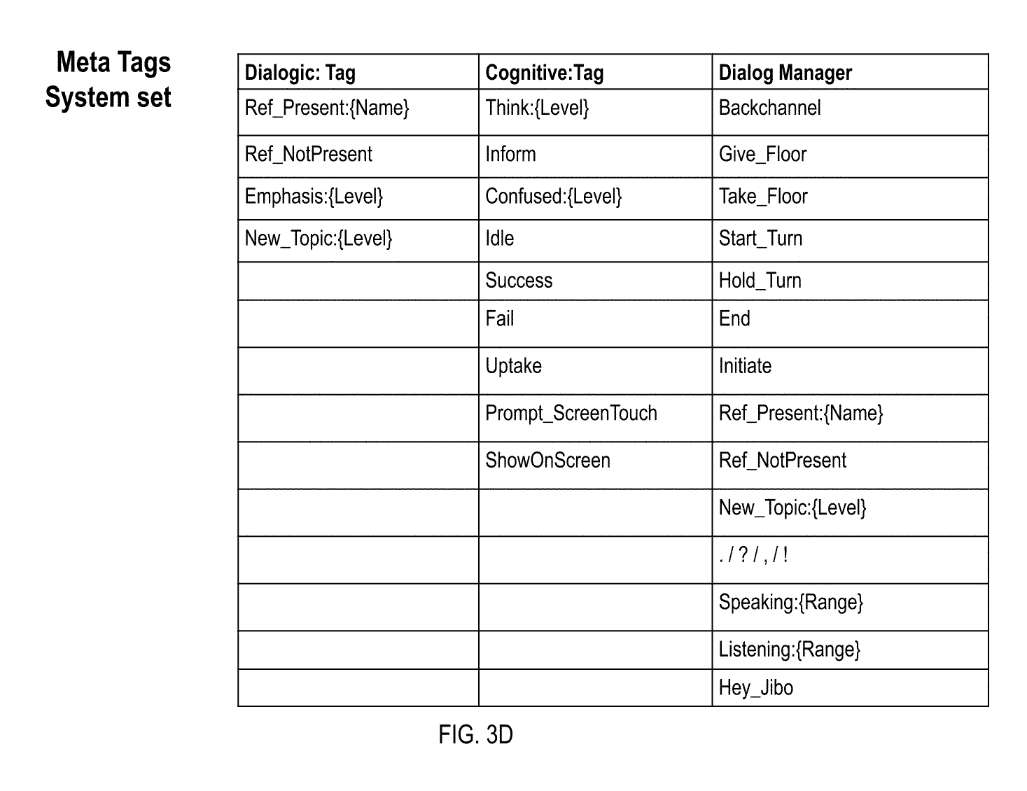

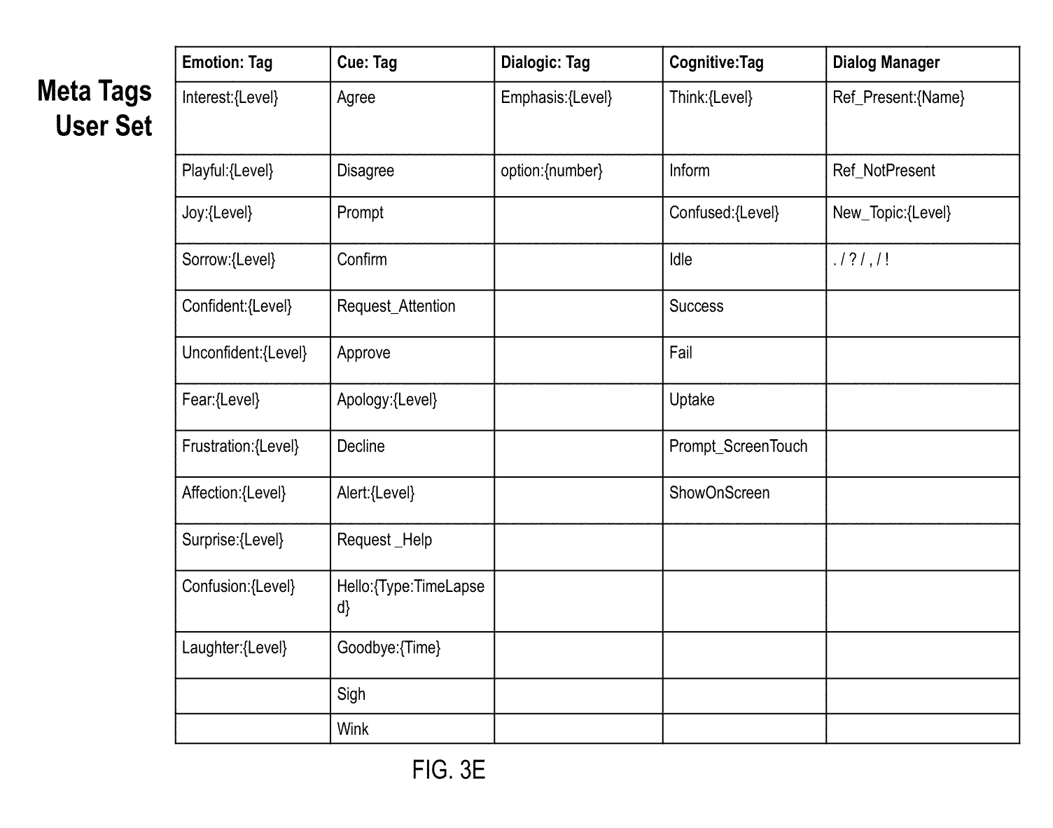

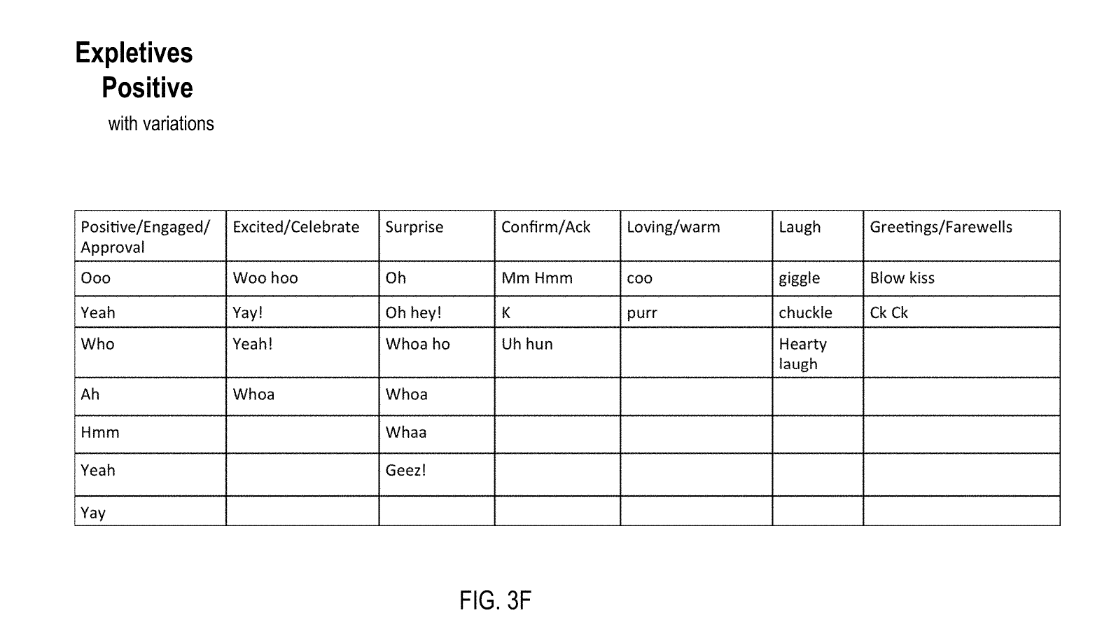

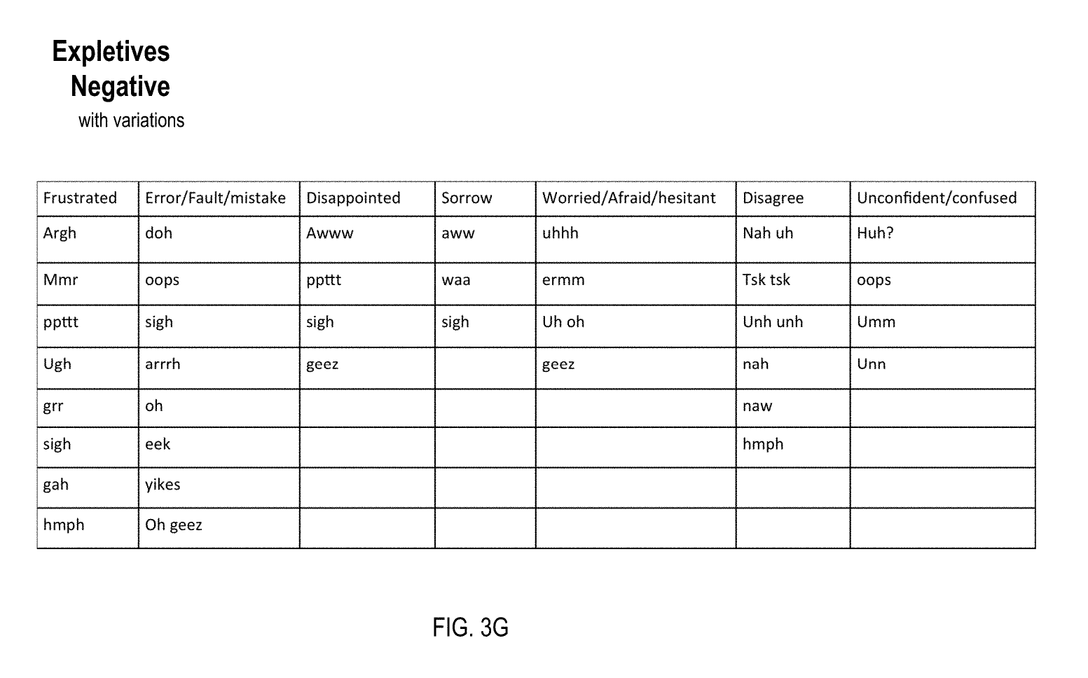

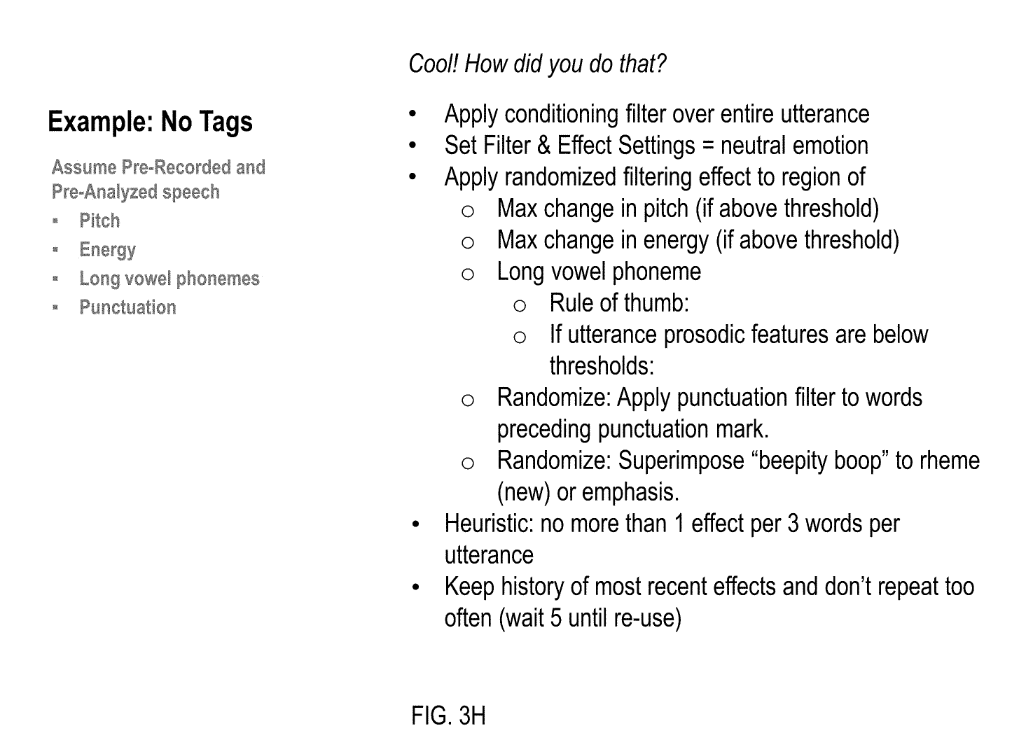

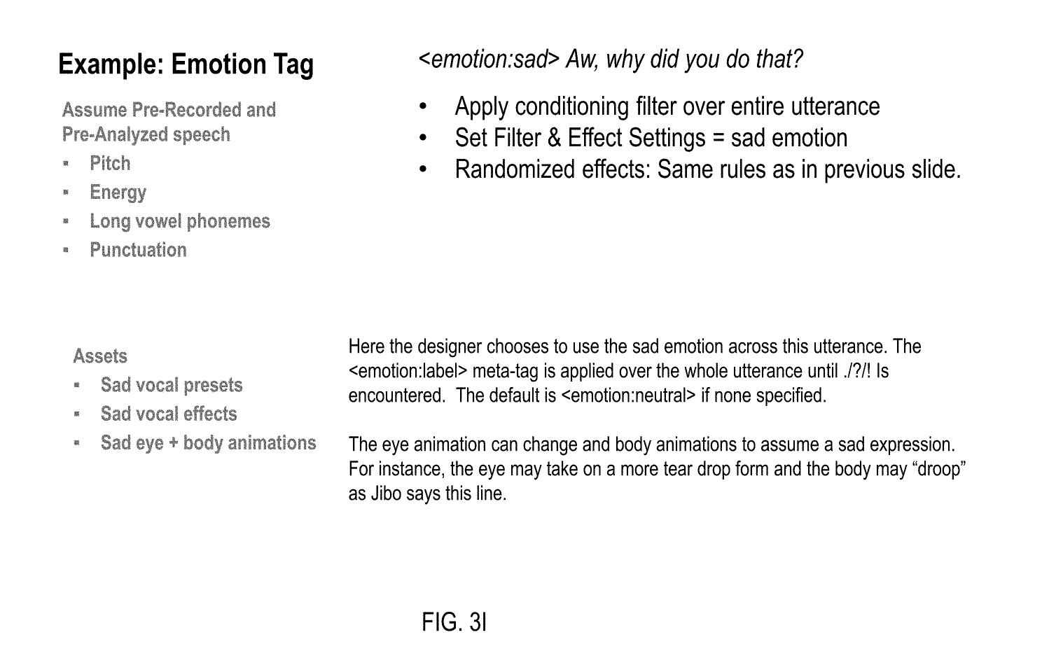

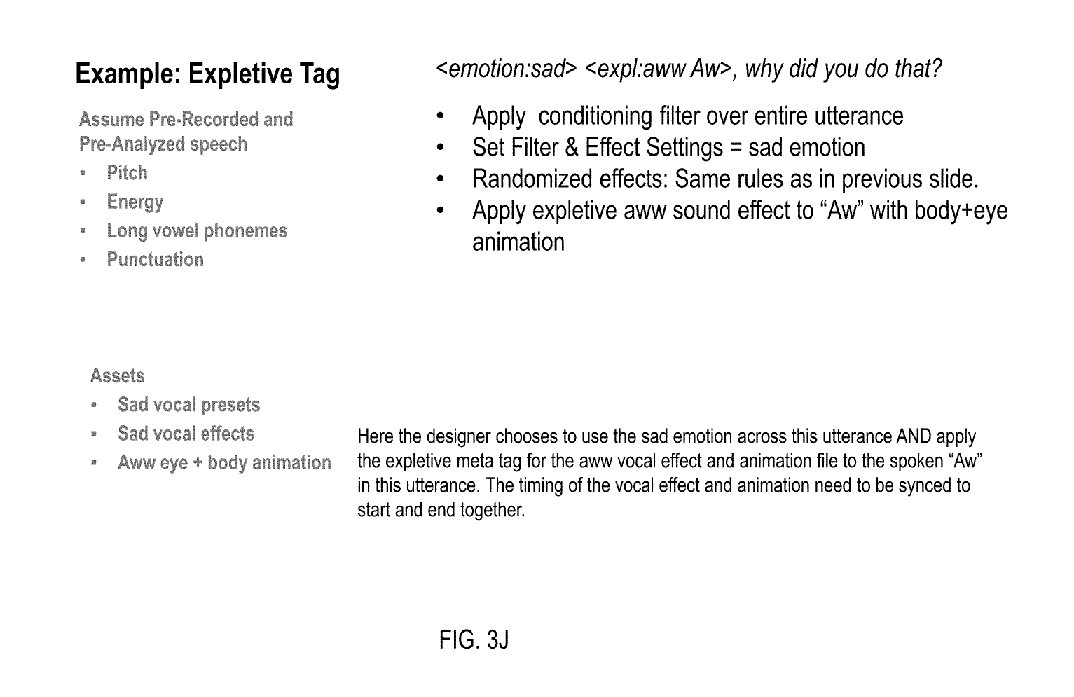

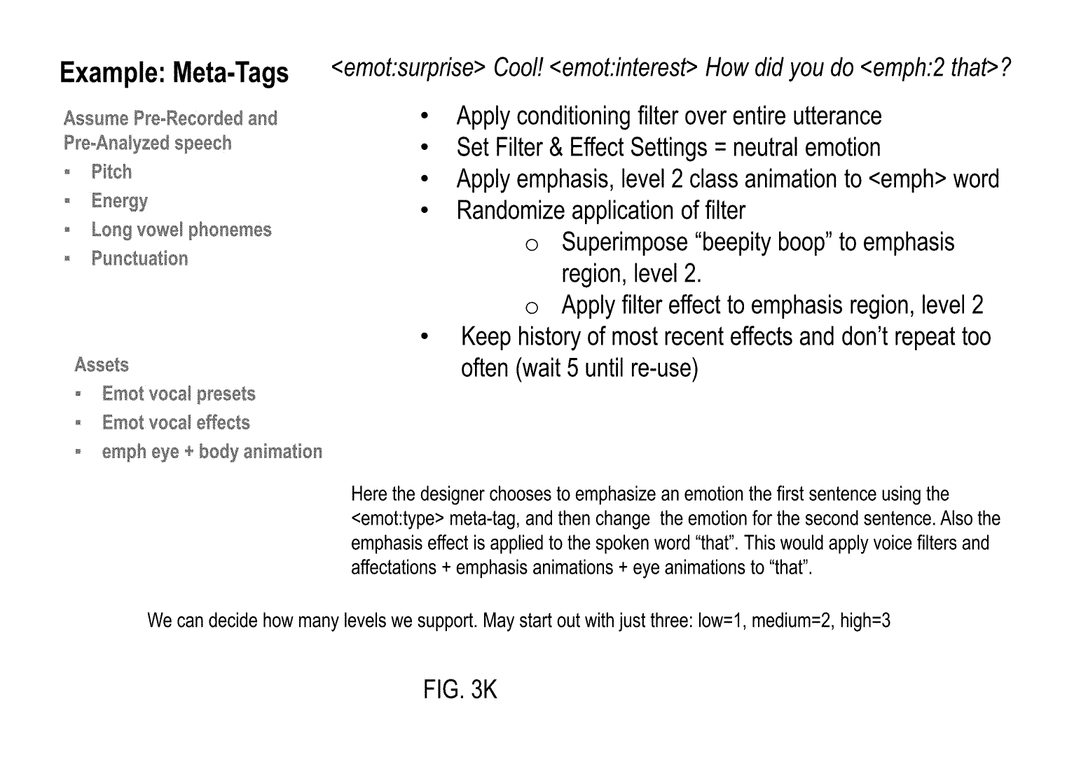

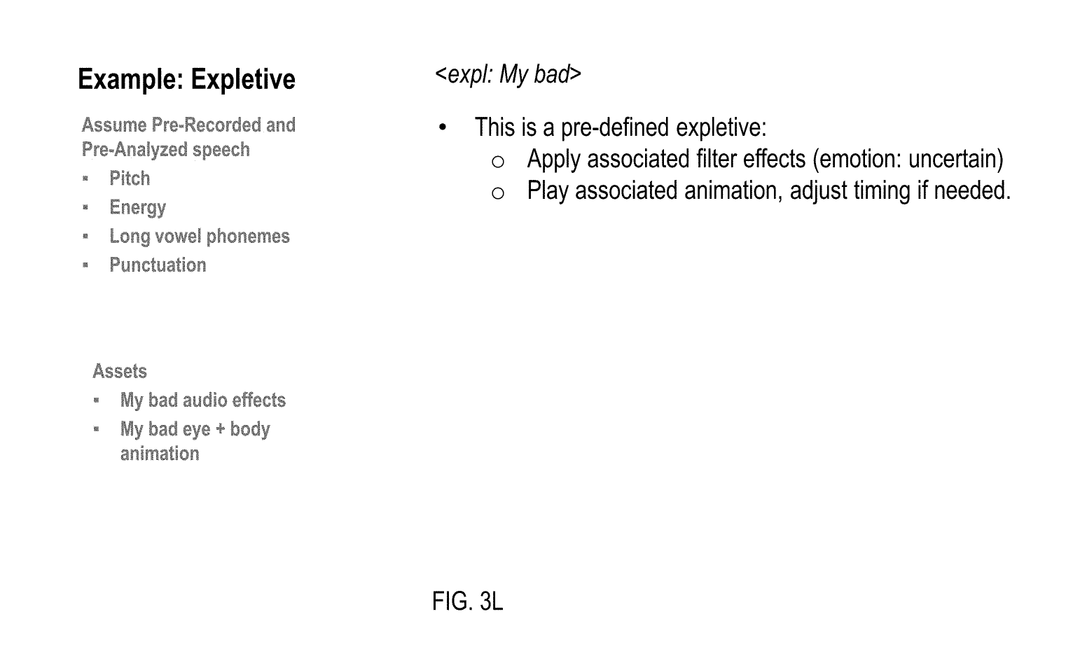

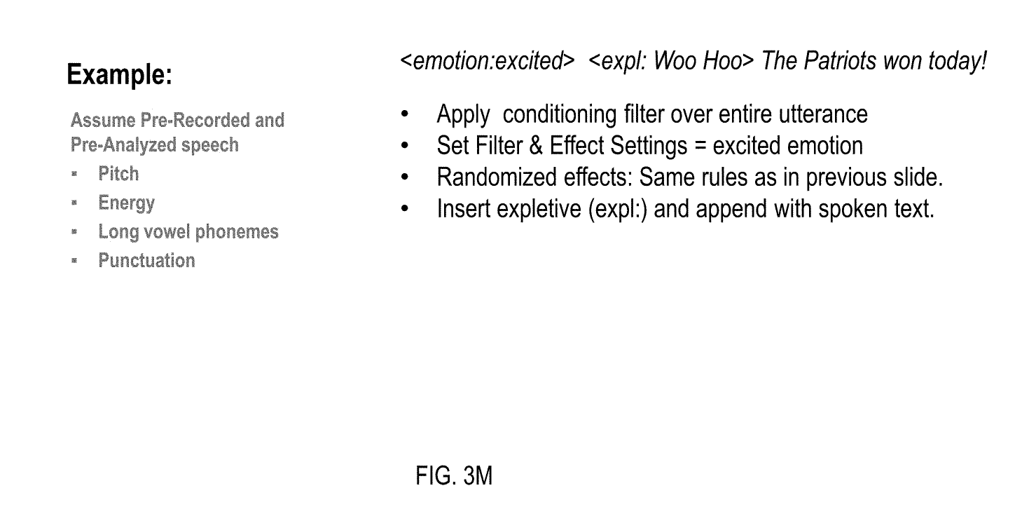

FIGS. 2A through 2C depict a multi-dimensional expression matrix and uses thereof according to some embodiments of the disclosure.

A social robot can communicate emotive or affective information through both semantic as well as paralinguistic channels. For instance, a social robot can communicate emotion through semantic cues such as word choice, phrasing, and the like. This semantic conveyance of emotion and affect can be supplemented with paralinguistic vocal affectation, such as vocal filters that convey different arousal levels or a range of valence. Changes in prosody parameters such as pitch, energy, speaking rate, etc. can also be used to convey different emotion or affective states.

A multitude of paralinguistic cues, as aforementioned, can be used to convey or supplement the spoken channel for emotional of affective information. Modalities including body posture and movement, PNSS, lighting effects, on-screen graphics and animations (including jiboji), and other anthropomorphic features suggestive of eyes and other facial features to convey emotion.

A social robot's emotively expressive repertoire can be represented according to a multi-dimensional Emotion Matrix. For instance, an Emotion Matrix may include at least one approval axis, a mastery axis, and a valence axis. Arousal could be another example of an axis (or a parameter of the aforementioned axes), as could novelty (how predictable events unfold). Other axes could be defined to characterize the affective/emotive tone of a context. In the examples illustrated in in FIGS. 2A through 2C, the approval axis, the mastery axis and the valence axis intersect centrally at a position of neutral expression.

For instance, an emotive state that maps highly on the approval axis may indicate affection (positive tone with low arousal), whereas mapping at the opposite end of the approval axis may indicate the environment (user) is expressing or experiencing disapproval (negative tone and possibly high arousal). On the valence axis, large positive values map to joy (positive tone, high arousal), while the opposite end of the axis would map to a sorrowful environment (negative tone and low arousal). On the mastery axis, positive values map to confident, where negative values map to insecure. This is depicted in FIG. 2A. Such embodied expression by a social robot may be based on a plurality of dimensions disposed along a plurality of axes, all mutually orthogonal to one another. The values along these axes could be defined such that increasing positive values correspond to a positive expression of joy on the valence axis, a positive expression of affection on the approval axis, and a positive expression of confidence on the mastery axis. Correspondingly, increasingly negative values could correspond to a negative expression of sorrow on the valence axis, a negative expression of disapproval on the approval axis, and a negative expression of worry on the mastery axis.

The range of emotive or affective states the robot can sense/internalize/express can be represented at different points in this multi-dimensional space. For instance, expressions that convey insecurity map to states of fear, worry, a lack of confidence. Expressions that convey confidence are positive mastery are confidence and pride.

A sensed environment or interaction context could impact the internal emotive state of the social robot at any given time. The number of axes of the Emotion Matrix defines the number of affective parameters used to specify a particular emotive state. A specific emotional or affective state can be represented as a point in this multi-dimensional space. Use of the approval, mastery, and valence axes may facilitate determining affective aspects of a sensed environment, such as human with whom the social robot is interacting, to determine how the robot should express itself at any given moment via TTS and ESML markup. It could also pertain to affective aspects of a task or activity, for instance, whether the robot is performing competently or making mistakes. It could also pertain to other environmental affective contexts such as time of day where the robot is more energetic during active daytime hours and more subdued closer to times of day associated with relaxation and rest. There are many other examples of surrounding context that could map to affective dimensions that ultimately inform the robot's emotive state to convey.

Each axis of the Emotion Matrix effects the emotional expression of the robot via each output modality in a particular way to convey that particular affect. Specific ways to map multi-modal expressions onto the axes of this Emotion Matrix may include a mood board variation as depicted in FIG. 2B. Other embodiments of the multi-axis expression dimension matrix may be employed, including without limitation an effects board as depicted in FIG. 2C. For instance, a sound palette could be defined that conveys different emotive tones that map to these axes of expression (e.g., auditory effects, music theory, vocal effects, etc.). Similarly, a color palette could be defined to control lighting effects based on emotive contexts. Additionally, a body pose palette could be defined for different emotive poses and gestures. And so on.

A sensed environment or interaction context that maps highly on the approval scale may indicate affection (positive tone with low arousal), whereas mapping at the opposite end of the approval axis may indicate the environment (user) is expressing or experiencing disapproval (negative tone and possibly high arousal). On the valence axis, large positive values map to joy (positive tone, high arousal), while the opposite end of the axis would map to a sorrowful environment (negative tone and low arousal.

Speech synthesis, multimodal expression generation, and interaction facility may employ such a Emotion Matrix on which the sensed environments, or activity context of robot states, and the like may be mapped to facilitate producing multi-modal embodied speech. The values that characterize the robot's or environment's emotive state for each dimension of the Emotion Matrix can map to particular ESML Tags, as well as impact TTS and the word choice for what the robot says. In this way, different effects and affectations could be applied to the robot's multi-modal performance to convey these different emotive contexts.

Sounds produced along these axes include, for negative joy/sorrow: whale sounds, lonely sounds, soft whimpering and the like. Quality of sounds produced for positive joy may include giggling, ascending pitch, butterfly lightness and the like.

As noted above the approval axis, the confidence axis and the joy axis intersect centrally at a position of neutral expression.

Also as noted above, an internal state or states of a social robot may also be mapped along the axes of this multi-dimension expression matrix to effectively provide emotional context for what otherwise may be deemed to be a technical list of attributes of a state or states of the social robot.

### Social-Communicative & Anthropomorphic Paralinguistic Cues

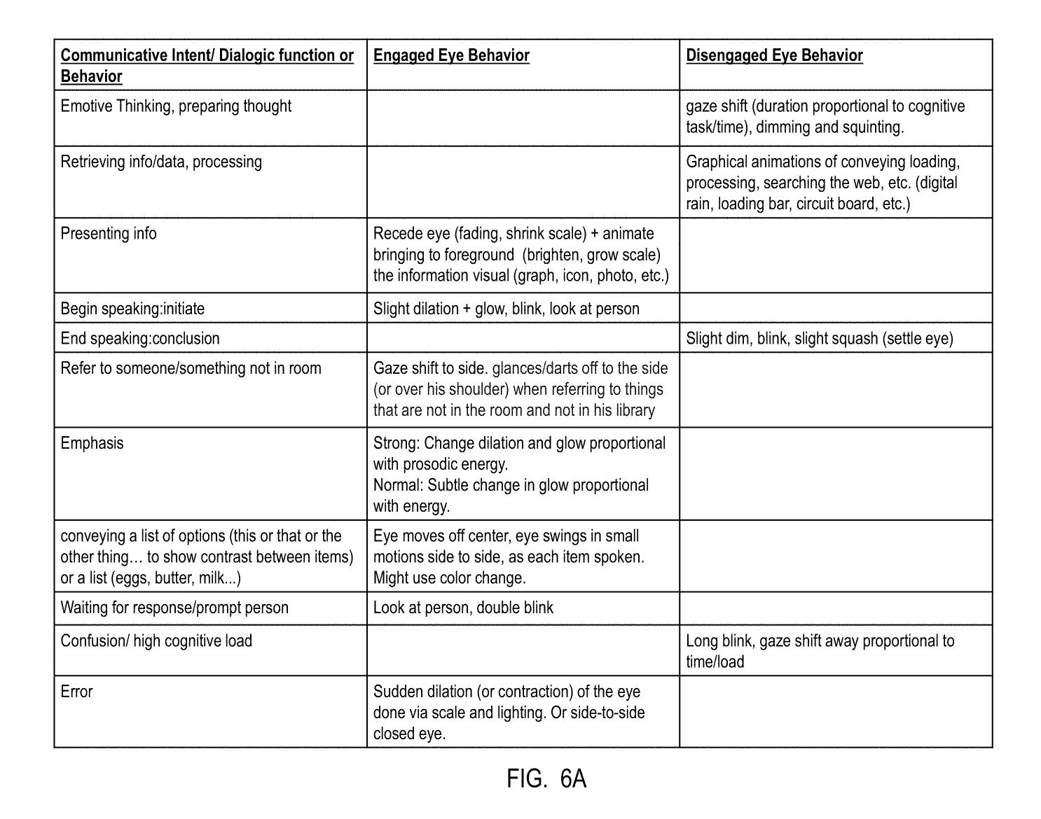

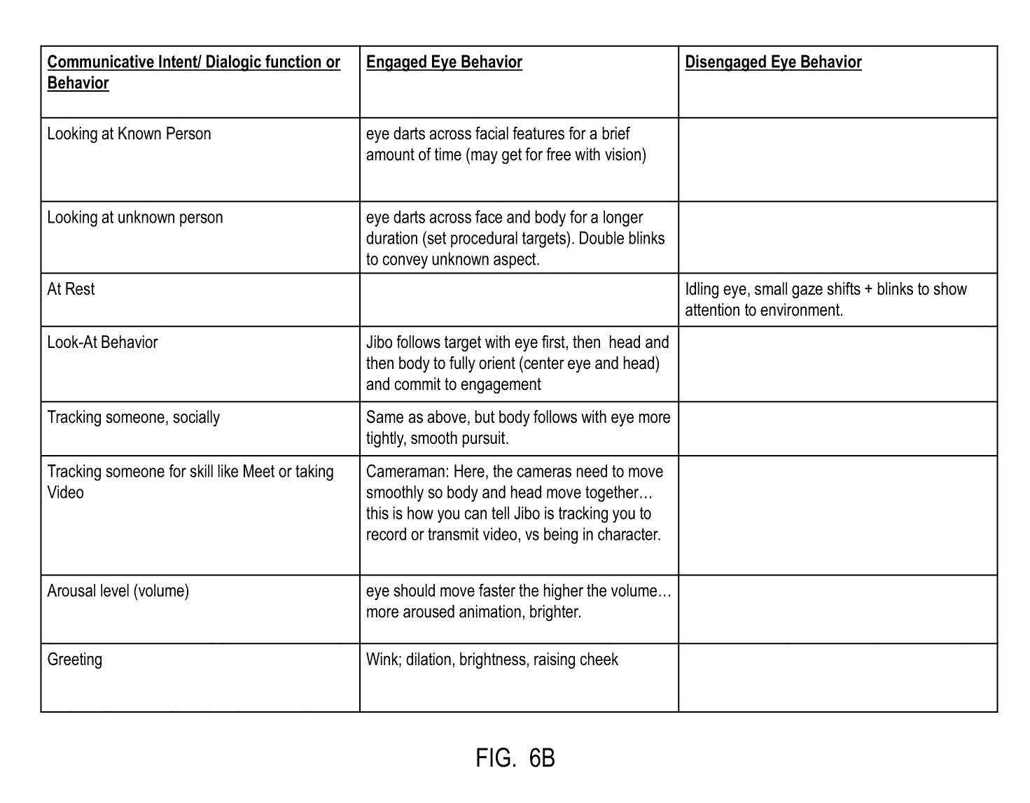

FIGS. 6A and 6B include specific conditions/actions and how the social robot will use eye animation when engaging and/or disengaging a human.

Many social-communicative cues are exchanged between people in conversation to regulate turn-taking, to share and direct attention, to convey active listening, to synchronize communication during collaborative activities via acknowledgments, repairing miscommunications, etc., as well as to exchange rituals such as greetings, farewells, and more. For such cues to be intuitive to people, it is logical that they be conveyed by a social robot in an anthropomorphic manner. A social robot need not be humanoid to convey and collaborate with these cues effectively. However, having a body that can move, pose and gesture; a display or “face” that can express; the ability to make sounds and to talk—can all be leveraged through embodied speech to synchronize and coordinate human-robot communication, collaboration and conversation in a natural and intuitive way via embodied speech.

Embodied speech may include features of a social robot to convey anthropomorphic facial expression cues, such as those associated with having features such as eyes, mouth, cheeks, eyebrows, etc. These features could be either mechanical or displayed on a screen or some other technology (hologram, augmented reality, etc.).

In a more specific example, display screen animations may include eye animations of at least one eye. The eye(s) can be animated to serve a wide repertoire of communicative cues, as mentioned previously. For instance, eye animations can play an important signaling role when exchanging speaking turns with a person during dialog. An active listening state could be conveyed as a glow that appears around the eye when the robot is actively listening to incoming speech. The eye may have rings that radiate from the eye in proportion to the energy of the incoming speech. When the end of speech is detected, the rings may recede back into the eye, the glow turns off, and the eye blinks. (e.g., at the end of a phrase or sentence or thought). This signals to the person that (1) the robot is actively listening to what is being said, which can be important for privacy concerns, and (2) that the microphones are receiving the audio signal which provides transparency and feedback that the robot is receiving audio input, and (3) when the robot thinks the person has finished his/her speaking turn and the robot is transitioning into performing an action in response, such as taking a speaking turn. As the robot speaks to the person, a speaking eye animation can be used to reinforce the robot's speech act in addition to the speaking sound coming from the robot's speakers. For instance, this could be conveyed through a speaking eye animation where the eye radius and brightness of the eye dynamically varies as it pulses with the energy or pitch of the robot's own vocalization. For instance, when the robot's speech becomes louder, the eye may grow in size and become brighter, and less so the more quietly the robot speaks. When the robot is finished speaking, the animation could convey a “settling” of the eye, such as a slight dimming of the eye illumination or a s slight glance downward and a blink. The eye may show anticipation that the robot is about to initiate an action at the beginning of an activity by having the eye dilate and blink.

Eye animations can be used to convey cognitive states such as thinking through blinking, glancing gaze to the side, and with dimming and squashing of the eye when looking to the side to show concentration. Intermittent blinking of the eye conveys liveliness. Eye animations that incorporate blinks may be used to indicate waiting for a response from a human in the interaction (e.g., a double blink). A long blink may be indicative of confusion or when a high cognitive load is being processed by the social robot. This is consistent with what a human might do if asked a difficult question. Blinks and/or gaze shifting may also be indicative of referencing someone or something that is not currently in the environment (e.g., a person who has left the room where the social robot is located).

Further, eye animation effects and control of its movement can be used to convey what the robot is attending to and looking at for any given moment. Feedback control to position the eye to look-at the desired target, such as looking to a face or an object, and orienting of the head and body to support that gaze line all serve to direct the robot's gaze. A lighting effect can be applied to simulate a 3D sphere where the hotspot intuitively corresponds to the pupil of an eyeball. By moving around this light source to illuminate the sphere, one can simulate the orientation of an eye as it scans a scene. Micro-movements of the eye as it looks a person's face can convey engaged attention to that person, for instance when trying to recognize who they are.

These types of eye animations may reinforce a focusing of a mind, searching, and retrieving information for example. The social robot may use these kind of eye animations when initiating retrieval of information (e.g., from online service such as news, sports or weather data). Such behaviors may be used to signal shifting to a new topic, for instance, applied just before a topic shift in an utterance.

In some embodiments a vocal effects module may have a set of pre-set filter settings that correspond to the markup language EMOTE STYLES.

In some embodiments, according to a set of rules with procedural variation built into the algorithm, the social robot may overlay other context relevant sound manipulations to time bounded sections of the spoken utterances so that it has the quality of the social robot speaking English with a robotese accent. The time-bound locations to receive these manipulations may be based on the specific utterance's world boundaries, peak pitch emphasis, and/or peak energy emphasis.

In other embodiments, according to a set of rules with procedural variation built into the algorithm, the social robot may overlay “native beepity boops” over spoken utterances so that it has the quality of the social robot speaking English with a robotese accent.

In some embodiments, a vocal effects module may apply a baseline filter effect to all robot spoken utterances. This includes raising the pitch to make TTS sound more youthful, and a slight machine-quality affectation. It is also to make any pre-recorded utterances to sound more like a TTS output to support hybrid utterances that are part pre-record/part TTS.

In other embodiments, there may be time-bound vocal effect rules applied to help make the transitions between pre-recorded and TTS speech sound compelling and robot-stylized.

In some embodiments, emotion markup may be achieved via a syntax such as, for example, <emote:style> utterance </emote>. The markup language may support the ability for a designer to specify an emotional quality for the utterance to be spoken. The emotional STYLE selectable includes: 1) neutral, 2) positive, 3) unsure, 4) aroused, 5) sad, 6) negative, 7) affectionate. This may cause the vocal affect system to select the EMOTE filter settings and apply filters and audio effects consistent with this EMOTE TYPE.

In some embodiments, emotion markup may be achieved via a syntax such as, for example, <jiboji:type:instance>. The markup language may support the ability for a designer to specify the execution of a jiboji as a stand alone animation+sound file. This cannot appear in the middle of a TTS string. But it can be adjacent as a separate utterance. Using syntax, if you specify a TYPE only, an instance of that TYPE will be randomly executed. If you specify TYPE and INSTANCE from the library, it will perform that particular file. Audio variations can be applied at run-time, but will preserve the timing of the original audio file.

In some embodiments, punctuation markup may be employed whereby the markup language may support adding special animations and sound effects according to standard punctuation marks: period (.), comma (,), exclamation point (!) and question mark (?).

In some embodiments, emphasis markup may be achieved via a syntax such as, for example, <emph> word </emph>. The markup language may support embellishing a emphasized word with an affiliated animation/behavior.

In some embodiments, choice markup may be achieved via a syntax such as, for example, <choice:number> word </item>. The markup language may support embellishing a word in an itemized list of alternatives with an appropriate animation/behavior. In some instances, t may be assumed that the vocal utterance conveys a list of choices, where each CHOICE is emphasized in a distinct way according to its assigned NUMBER. For example “Did you say <choice:1> YES </choice:1> or <choice:2> NO</choice:2>? where the system will play a different animation to correspond with emphasis on YES, and another animation to correspond with emphasis on NO. There can be a list of choices, so the NUMBER parameter indicates a list of numbered items, each to be emphasized in turn.

In addition to eye behaviors, the head and body may also be used to reinforce these use cases. For instance, posture shifts can be used to signal a change in topic. The head and body move in relation to the eye(s) to convey attention and orientation to a person or object of interest. These can be large movements when orienting to something of interest, or small movements of the kind people make when idling. The body, head and eyes move in unison to visually track a person or object as it moves across a scene. There are many ways a social robot can move its body, head and face/eye(s) to convey a wide repertoire of social communicative cues that complement and enhance speech.

### Non-Speech Audio Cues

In accordance with an exemplary and non-limiting embodiment, the social robot may have access to a library of stored paralinguistic language expressions that convey meaning in a format that is distinct from a natural human language speech format. Such a library of paralinguistic language expressions may be stored in a memory resident within the social robot or may be stored external to the social robot and accessible to the social robot by either wired or wireless communication. As used herein, “paralinguistic language” sounds refers to sounds, which may lack the linguistic attributes essential to a language such as, for example, grammar and syntax. In exemplary embodiments, paralinguistic language expressions are configured to convey specific meaning and may express at least one of an emotive response, a cognitive state, a state of the social robot, a skill state and/or paralinguistic/communicative states and/or content, and the like. In some embodiments, as described more fully below, each paralinguistic language expression may be attributed such as with one or more group designations.

In general, paralinguistic audio (PLA) may be used to convey how the social robot “feels” about an utterance (e.g., he's confident, he's unsure, he's happy, he's timid, etc.) Paralinguistic audio may be used to express an emotive state (e.g., expressive sounds that are based on human analogs: giggle, sorrow, worry, excitement, confusion, frustration, celebration, success, failure, stuck, etc.). Paralinguistic audio may be used to express a body state (e.g., power up, down, going to sleep, battery level, etc.). Paralinguistic audio may be used to express a communicative non-linguistic intent (e.g., back-channeling, acknowledgments, exclamations, affectionate sounds, mutterings, etc.). Paralinguistic audio may be used to express a key cognitive state (e.g., see you, recognize you as familiar, success, stuck, thinking, failure, etc.). Paralinguistic audio may be used to express a key status state specific to a skill (e.g., snap sound for photo capture, a ringing sound for an incoming call for Meet, etc.). Paralinguistic audio may be used to express talking with another social robot.

As noted, the social robot may use paralinguistic utterances, such as “Beepity Boop” sounds to convey an intent or status in “shorthand”. In some instances, this may be done once a deep enough association has been made with the English intent. For instance, this is useful to mitigate user fatigue arising from excessive repetition. As an example, if you are doing the same activity over and over . . . like adding items to a grocery list . . . instead of the social robot saying “got it” after every item, the robot may shortcut to an affirming sound perhaps with an accompanying visual. The display may provide a translation or “image with intent” when collaborating with a person to provide some form of context confirmation.

Paralinguistic audio may be based on an intent and/or state related to a social environment of the robot. Paralinguistic may further be based on various qualities of human prosodic inspiration and/or qualities of non-human inspiration. Each of the following referenced tables in Appendix A may associate various paralinguistic classes with intent, human and non-human inspiration while optionally providing examples. With reference to Appendix A, table 1, there is illustrated a description of a plurality of character-level paralinguistic audio emotive states.

With reference to Appendix A, table 2, there is illustrated a description of a plurality of social robot and OOBE specific sounds.

With reference to Appendix A, table 3, there is illustrated a description of a plurality of device-level paralinguistic audio sounds.

With reference to Appendix A, table 4, there is illustrated a comprehensive description of a plurality of device-level paralinguistic audio sounds.

The library of paralinguistic language expressions may dynamically change and increase over time. In some instances, a social robot may develop and/or derive paralinguistic language expressions from interactions with users of the social robot. For example, through interaction with a young child, the social robot may observe that, in response to an occurrence engendering negative emotions, the child say “Uh-oh!”. In response, the social robot may derive a paralinguistic language expression or series of paralinguistic language expressions that mimics the tonalities and cadence of the uttered “Uh-oh!”. When, at a later time, the social robot interacts with the user and emits or broadcasts the derived paralinguistic language expressions in response to a negative occurrence, the similarity between the derived paralinguistic language expressions and the vocabulary of the user may serve to produce a feeling of camaraderie between the user and the social robot.

While described as defined sounds, a uniquely defined paralinguistic language expression or sounds may be altered when emitted to enhance characteristics of an interaction. For example, the same paralinguistic language expression may be transposed to a different octave, may be sped up or slowed down, and/or may be combined with various effects, such as, for example, vibrato, to match an intended emotional mood, social environment, user preference, and any other condition that is detectable and/or derivable by the social robot.

In some embodiments, the paralinguistic language expressions may be grouped into a plurality of intent-based groups. A group can map to a markup tag that represents that category. Once categorized, one or more markup tags may be mapped to individual paralinguistic language expressions or designated groups of paralinguistic language expressions. Markup tags may then be used, such as by an author of speech for the social robot, to designate the use of paralinguistic language expressions defined by attribute. For example, a developer may encode a physical response by the social robot to be accompanied by a paralinguistic language expression as indicated by an embedded syntax such as “[paralinguistic audio: attr.happy]”. In such an instance, the social robot may access one or more stored paralinguistic language expressions for playback having a group attribution indicating a “happy” sound. In this way, the social robot may be instructed to produce paralinguistic language in a generic manner whereby the actual performance of the task of producing the audio may be tailored to the use environment. For example, with reference to the above example, an instruction to play a happy sound may result in the social robot playing the derived paralinguistic language expression associated with the user's “oooh” sound wherein such sound has been previously attributed as and grouped with happy sounds.

Paralinguistic language expressions may be grouped into one or more intent-based groups. Examples of group designations into which paralinguistic language expressions may be grouped include intent-based groups configured around a semantic intent, such as confirmation, itemizing a list, emphasizing a word, a change of topic, etc. In accordance with other embodiments, intent-based groups may be configured around an expressive intent, such as happy sounds, sad sounds, worried sounds, etc.

In accordance with other embodiments, an intent-based group may be configured around a communicative intent, such as directing an utterance to a specific person, such as looking at the person, turn taking, making a request, getting someone's attention, agreeing, disagreeing, etc. An intent-based group may be configured around a device/status intent, such as battery status, wireless connectivity status, temperature status, etc. An intent-based group may be configured around a GUI interface intent, such as swipe, scroll, select, tap, etc. In accordance with exemplary and non-limiting embodiments, use of paralinguistic language expressions may reduce computing load of a social robot required for verbal communication between a social robot and at least one of a human and another social robot. For example, the use of paralinguistic language expressions to convey meaning to a user does not require the processing resources utilized when, for example, performing text-to-speech conversion. This may be determined at least by the generally shorter duration of a paralinguistic language utterance to convey the same or a substantially comparable meaning as a sophisticated text to speech phrase/sentence. Additionally, paralinguistic language may generally be short phrases or utterances that are stored as audio files/clips and processed to adjust an intent—this is described herein. Conversely, the social robot may be able to process a received paralinguistic language expression, such as from another social robot, using fewer resources than when receiving spoken text or audio. This may occur at least because each paralinguistic language utterance may be mapped to a specific meaning, whereas each word in a sentence may have multiple interpretations based on context that must be derived through processing.

In accordance with yet other exemplary embodiments, use of paralinguistic language expressions may reduce a cognitive or behavioral load, thus increasing communication efficiency, for verbal communication between a social robot and at least one of a human and another social robot. For the reasons noted above use of paralinguistic language can reduce the processing load for interactions that incorporate paralinguistic language production and/or detection. Indeed, these paralinguistic language expressions could be used as a form of social robot to social robot communication, too. In some embodiments, at least a portion of paralinguistic language expressions correspond to at least one human emotion or communicative intent. Prosodic features, duration, timing of these paralinguistic language expressions9. Iconic Cues: On-Screen Content and Jiboji's

While a social robot may employ multiple output modes for producing emotive expressions certain spoken utterances and images may be synonymous. An on-screen image, for example, may connote a similar meaning to a spoken utterance. As an example, the spoken word “pizza” may connote the same meaning as an image of a pizza. The on screen content can be a static graphic or an animation. For instance, the robot might say “John wants to know if you want pizza for dinner” where an icon of a pizza appears on screen when the robot says “pizza”. Alternatively the robot may put text on the screen “John wants to know if you want [graphic pizza icon] for [graphic dinner place setting icon].” Text display on a screen may be derived from text in a TTS source file and may be used for display as well as speech generation contemporaneously.

Additionally, combinations of modes may be grouped for more convenient reference when authoring and/or producing expressive interaction. In particular packaged combinations of paralinguistic language (PLA) with other expressive modes (e.g., graphical assets, robot animated body movement, lighting effects and the like) may be grouped into a multi-mode expressive element, herein referred to as a jiboji. A library of jibojis may be developed so that embodied speech tags (e.g., ESML tags) may refer to a specific jiboji in the library or to an extended group of jiboji to represent a category of expressive ways to convey the emotions and the like associated with the tag.

In addition to eye behaviors, the head and body may also be used to reinforce these use cases. For instance, posture shifts can be used to signal a change in topic. The head and body move in relation to the eye(s) to convey attention and orientation to a person or object of interest. These can be large movements when orienting to something of interest, or small movements of the kind people make when idling. The body, head and eyes move in unison to visually track a person or object as it moves across a scene. There are many ways a social robot can move its body, head and face/eye(s) to convey a wide repertoire of social communicative cues that complement and enhance speech.

Diction Rules for Combining Expressive Natural Speech with Paralinguistic Non-Speech Sounds

The coordinating aspects that facilitate these conveyances may be based at least in part on a set of Diction Rules that may indicate parameters or rules of control for how to combine, parameterize, sequence, or overlay robot multi-modal expressive outputs (speech+paralinguistic cues) to convey a wide variety of expressive intents via embodied speech. The diction rules may also indicate parameters of diction that reflect character traits. Expressive natural language and a paralinguistic cues can be used in combination or isolation to express character traits, emotions, sentiments by a social robot in a manner that are perceived to be believable, understandable, context-appropriate and spontaneous when in interaction with a person, a group of people, or even among other social robots. The social robot character specification may define a “native” way for a social robot to communicate (perhaps to other social robots) using paralinguistic non-speech modes.

In all cases, text-to-speech can be made to be more expressive by adjusting vocal parameters that adjust prosody, articulatory effects, vocal filters, and the like.

A social robot may include using diction rules to associate one or more patterns of speech, with multi-modal paralinguistic cues, and with one or more character traits. Diction rules facilitate a consistent and structured mapping of character traits to one or more expressive mediums to produce understandable and predictable combinations of speech output with paralinguistic cues, similar to a simple grammar. In this way, the paralinguistic modes of communication convey consistent intention that can enhance and augment the semantic communication with a person. Over time, a person may learn the communicative intent of a paralinguistic cue. So, in time, a paralinguistic cue could substitute for a semantic cue (e.g., to convey communicative intents such as greetings, farewells, apologies, emotions, acknowledgements, internal states such as thinking or being confused, and the like).

### Why/when a Social Robot Uses Spoken Language (e.g., TTS) or PL or Jiboji)

In accordance with exemplary and non-limiting embodiments, a social robot may convey a specific meaning via an audio output by selectively generating synthesized speech (e.g., text-to-speech), recorded speech, paralinguistic non-speech sounds, paralinguistic audio, jiboji, and/or a hybrid thereof based on a determined contextual requirement of the social robot.

Different environments may give rise to differing contextual requirements as regards the nature of an audio output. Specifically, different environments and the contexts attendant thereto may require a different information density or emotional content. For example, the recitation of a recipe by the social robot to a user may require a relatively high degree of precise content information be transmitted related to ingredients, amounts, cooking instructions, videos and photos, etc. In contrast, monitoring a user's exercise routine and offering encouragement may require relatively little information be conveyed. In the former instance, the social robot may determine that converting natural language text to speech audio for transmission may suffice whereas, in the second instance, emitting a paralinguistic audio sound such as, for example, “Woo hoo, yeah!” may suffice.

As will be evident to one skilled in the art, the contextual requirement giving rise to a determination regarding the most efficacious format of language or intent transmission may be selected from the list consisting of but not limited to expressing emotion, building a unique bond with a human, streamlining interaction with a human, personalizing communication style to a human, reducing cognitive load on human understanding requirements, supplementing task-based information, alerting a human, seeking compassion from a human; talking with other social robots, resolving miscommunication errors or signaling an unexpected delay in performing a skill, and more.

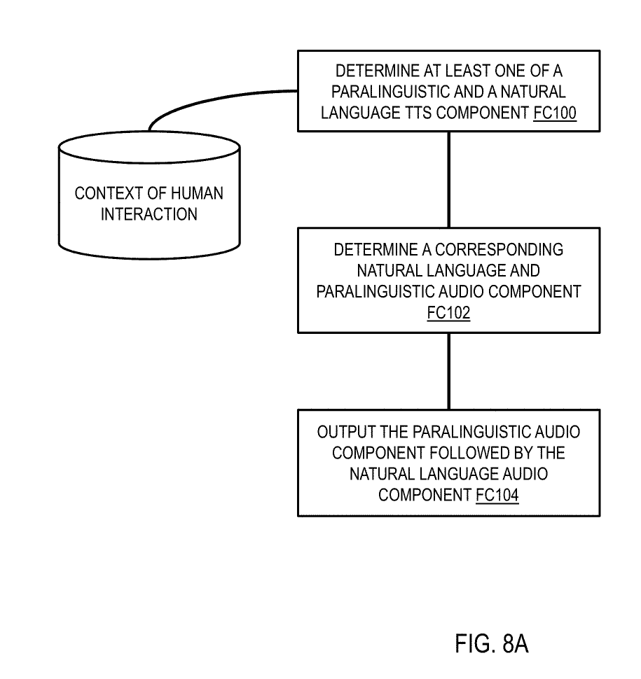

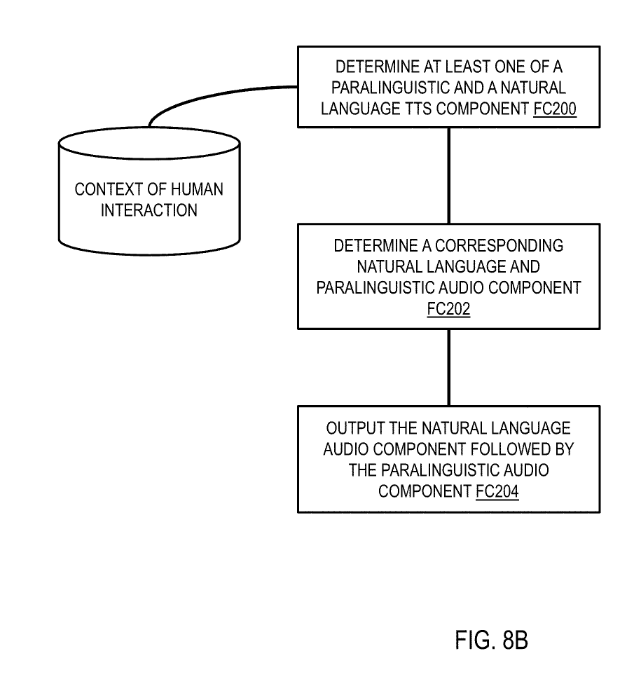

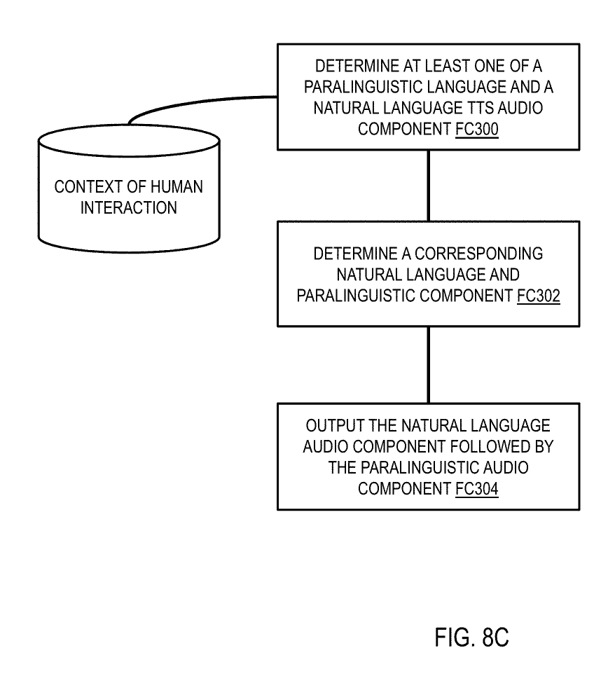

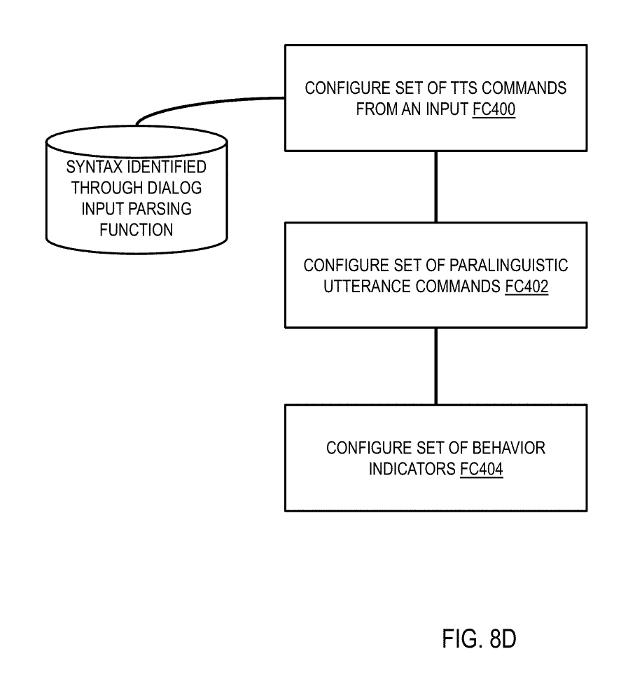

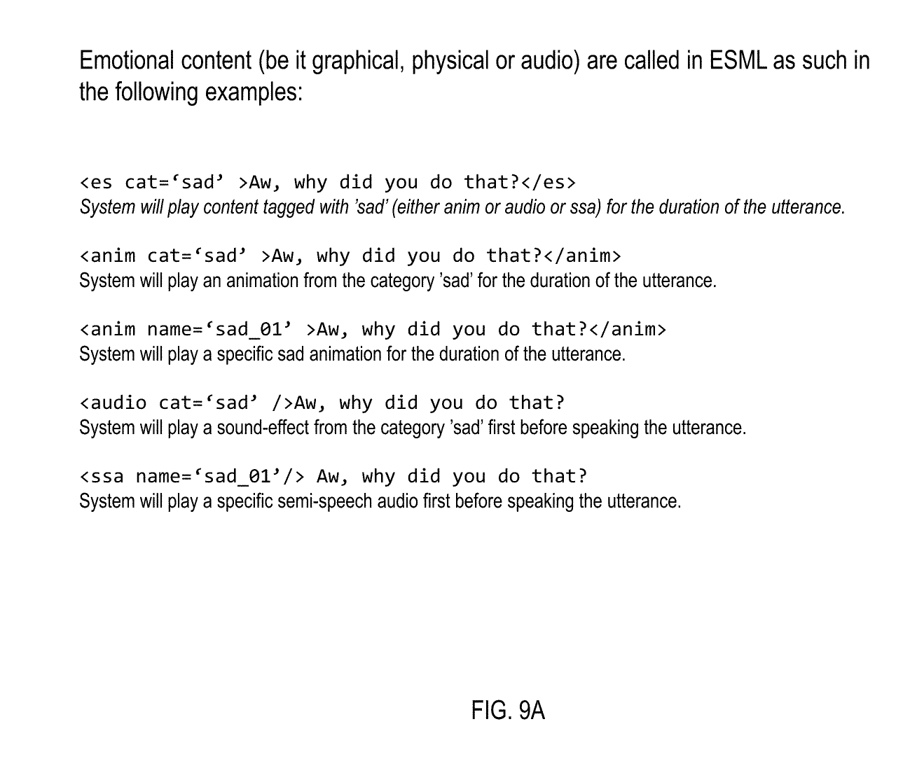

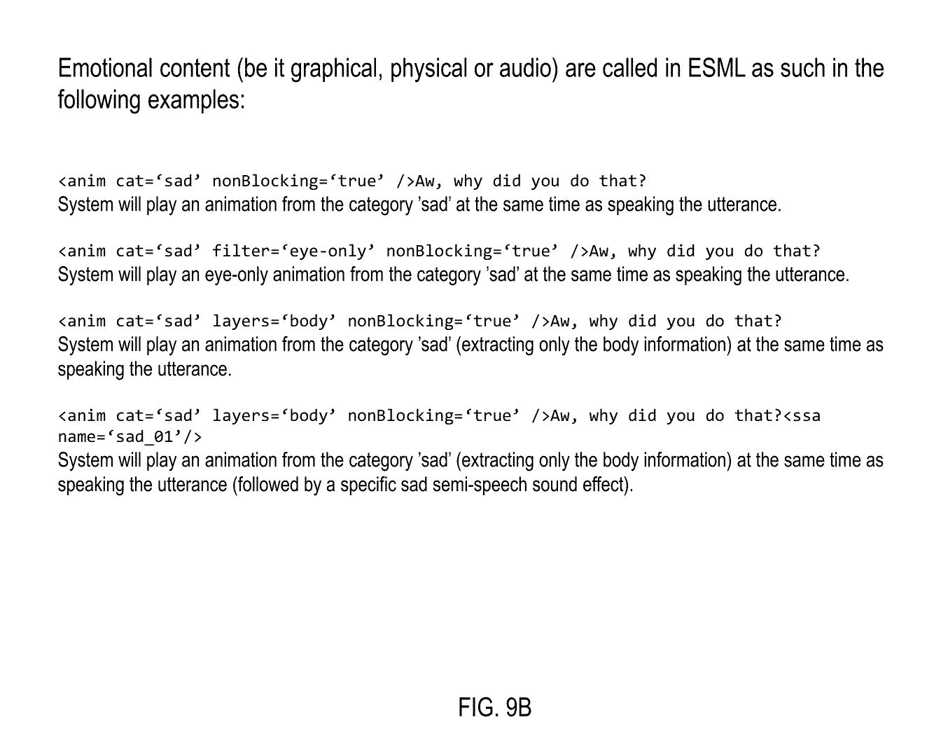

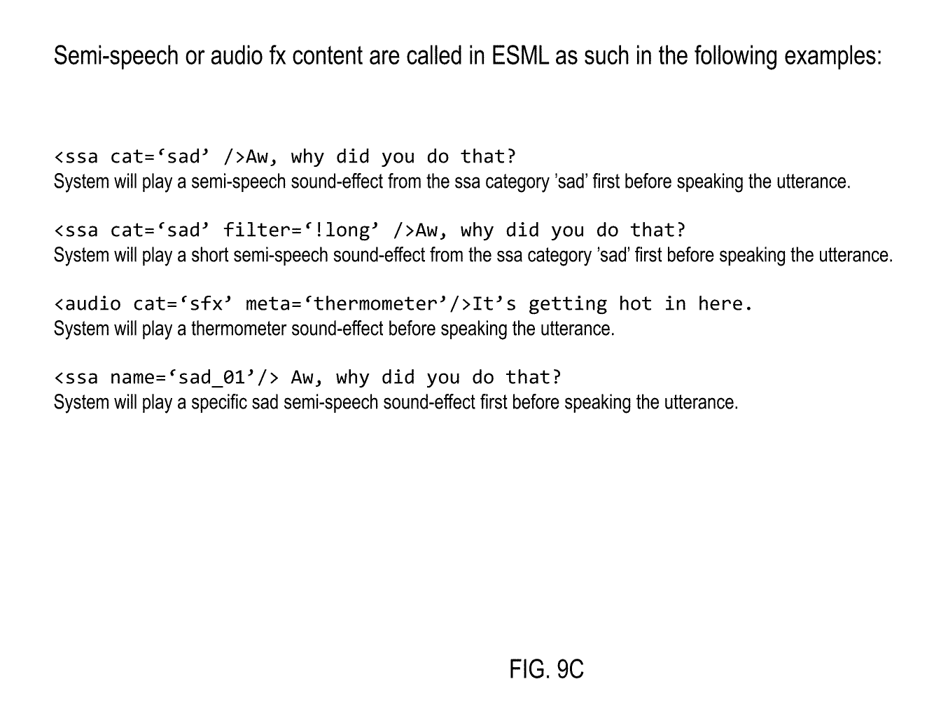

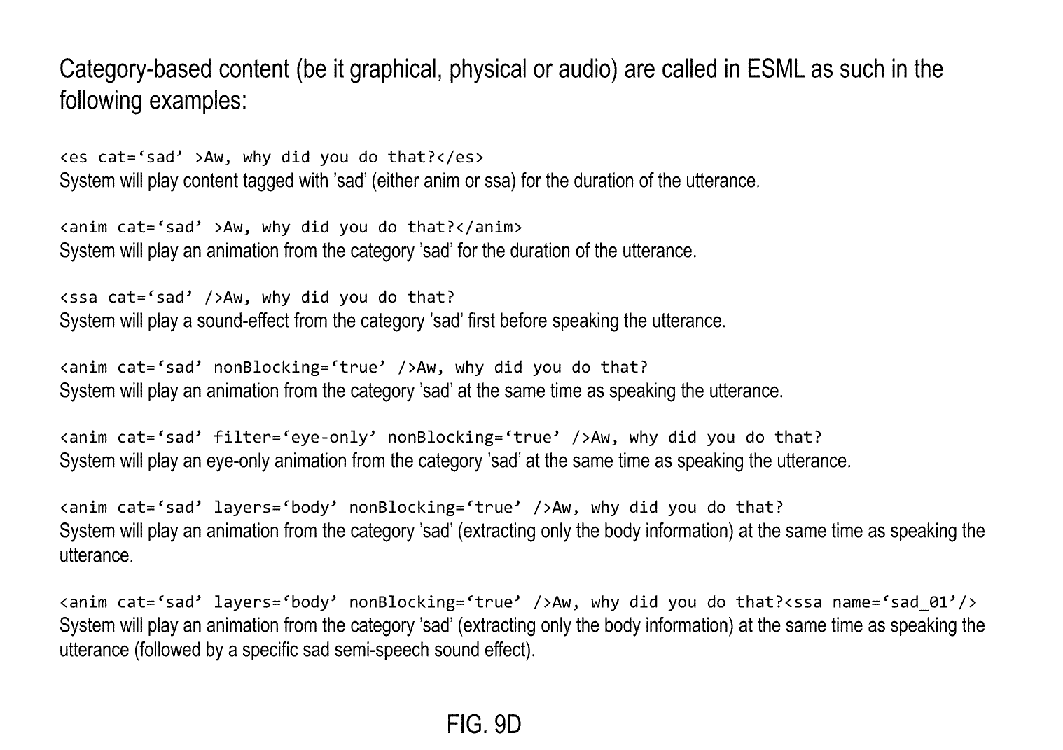

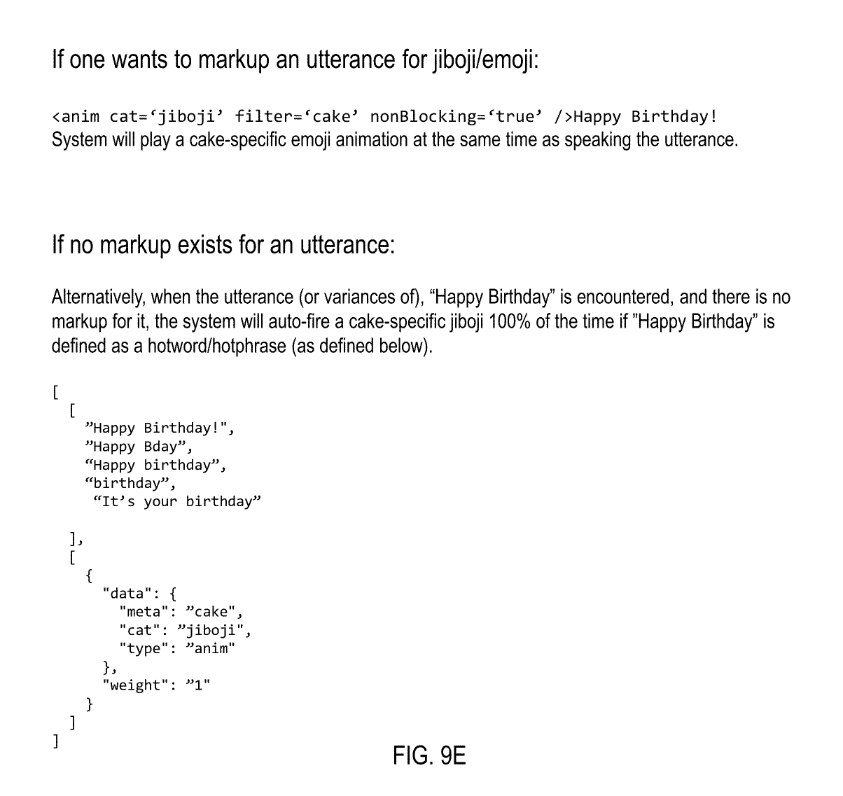

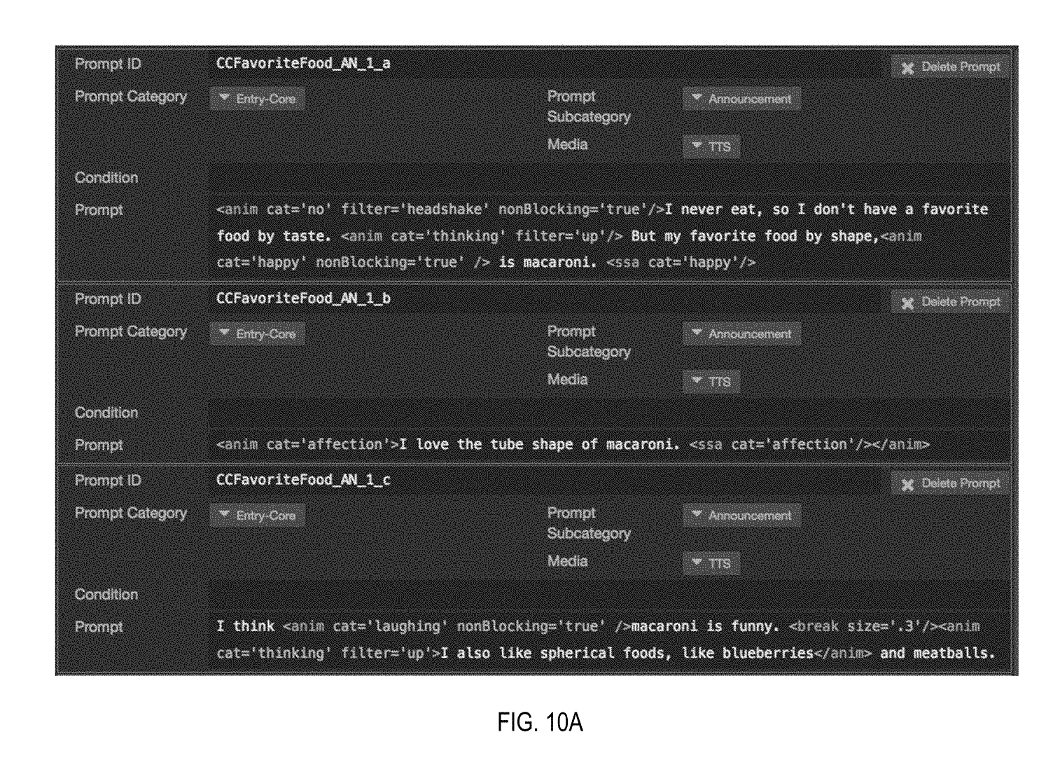

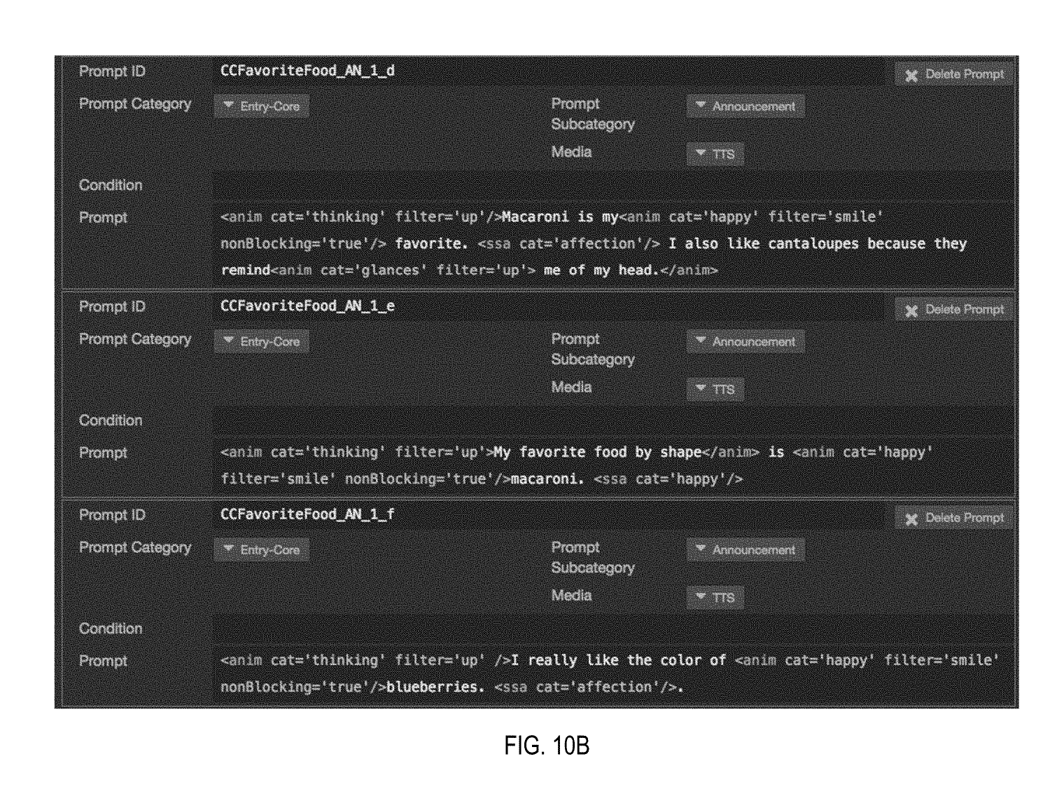

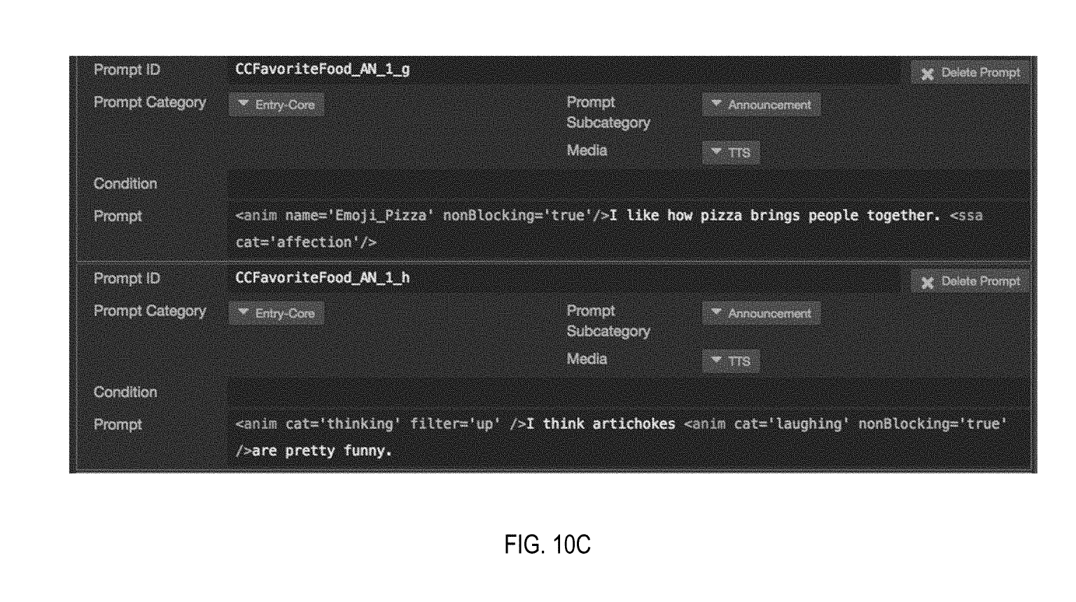

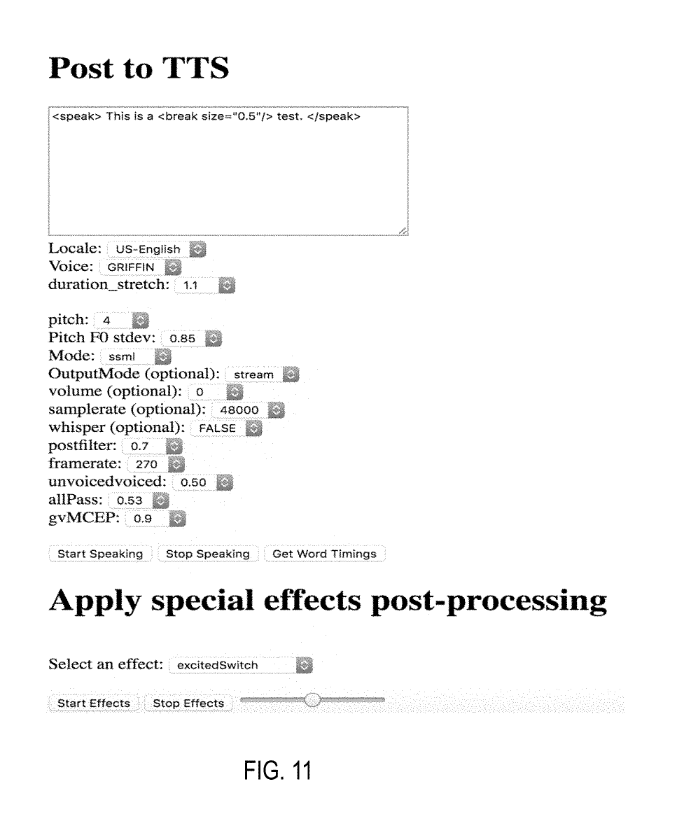

With reference to FIG. 8A, there is illustrated a flow chart of Rules of Diction according to an exemplary and non-limiting embodiment. Specifically, there is described a method whereby the social robot may use paralinguistic non-speech cues and/or spoken language communication in a variety of contexts and combinations.

### Diction Rules: When to Use Expressive Natural Speech Only

In accordance with exemplary and non-limiting embodiments, the social robot may process information to be conveyed to a human user to determine a conveyance language mode. For instance, the conveyance language mode may be selected from the list consisting of natural language text-to-speech audio (i.e., synthesized speech) or pre-recorded speech.

Specifically, the social robot may determine to engage solely in synthesized speech (e.g., text-to-speech) may convey meaning, intent, emotion, and the like concisely without having to rely on paralinguistic audio.

In some embodiments, as discussed above, the text-to-speech audio may be comprised, in whole or in part, of pre-recorded speech that is manipulated or filtered to produce a desired effect, emotional expression, and the like. Alternatively, the TTS paralinguistic vocal parameters can be adjusted to make the utterance convey a specific intent or emotion via adjusting prosody (e.g., inserting a pause for humor, conveying emotion via adjusting pitch, energy, speaking rate, etc.).

### Diction Rules: When to Use Paralinguistic Non-Speech Cues Only

The conveyance language mode may be selected from a list that includes paralinguistic non-speech modes such as paralinguistic audio. Specifically, the social robot may determine to engage solely in paralinguistic non-speech communication when the result of processing indicates (1) that the information to be conveyed is merely confirmatory of an action previously requested by the human, (2) when the information to be conveyed corresponds to the expression of an emotion or a character-driven reaction. In some embodiments, the paralinguistic non-speech mode may be integrated into paralinguistic audio or a jiboji. In yet other embodiments, paralinguistic non-speech audio may be selected when the result of processing indicates a combination of any of the aforementioned situations. When two or more social robots interact, they may do so via paralinguistic non-speech audio (akin to speaking in their “native” robot language).

Diction Rules: Selecting Between Natural Language v. Paralinguistic Mode Based on Familiarity and Personalization

For instance, the conveyance language mode may be selected from the list consisting of natural language (e.g., text-to-speech audio), pre-recorded speech, paralinguistic audio, jiboji, or other paralinguistic non-speech modes.

A variety of factors may determine when expressive natural language (e.g., TTS) or paralinguistic non-speech cues (e.g., jiboji) should be output. Such factors may include information about the intended recipient of the communication for personalization.

For simplicity, we consider the following scenarios. If the recipient is determined to be a human with whom the social robot has sufficient prior interaction experience, choosing a paralinguistic non-speech mode/jiboji may be given higher priority than natural language/text-to-speech. If the recipient is a human, other social robot, or the like, that, based on information known or gatherable by the social robot appears to have a working knowledge of the robot's paralinguistic non-speech cues, then choosing a paralinguistic cue over spoken language/TTS may also be given higher priority. Whereas, if an intended recipient of the output is either not known to the social robot or cannot be determined, use of spoken language/TTS may be more heavily weighted when determining which mode of speech to use. In yet another example, the social robot may utilize personalized information of a user to choose between natural language text-to-speech audio and “native” robot non-speech audio. For example, when speaking to a young child and an adult, the social robot may communicate with the adult using text-to-speech audio while speaking to the child with paralinguistic sounds.

Environmental conditions, such as volume of ambient sound detected by the robot may also be factored into which form of speech to use. Communicating in noisy environments may best be done, for example, using a more formal language to avoid possible confusion by the listener.

### Diction Rules: Alternating Between Paralinguistic Non-Speech Cues and Spoken Language

In accordance with exemplary and non-limiting embodiments, a social robot may employ a context-based decision process for alternating between expressive natural language audio (TTS, pre-record, etc.) and paralinguistic non-speech communication (including jiboji, paralinguistic, and aforementioned forms). In some embodiments, such decisions as to when to use only natural spoken language or paralinguistic modes may be based, at least in part, on at least one of but not limited to (1) a time since expression of a comparable audio output, (2) time of day relative to an average time of day for a particular expression, (3) personalized information of the user, (4) a history of past utterances, (5) a repetition of a specific intent, and (6) a ranking of a skill request by a human on a scale of favorite skills.

For example, if the social robot determines that a period of time has passed within which it is expected that a user would respond to a text-to-speech audio request, the social robot may inquire again using a paralinguistic audio prompt. In such instances, the use of a paralinguistic sound may be perceived as more of a friendly reminder than would a similar text-to-speech request, such as repeating the natural language speech prompt.

In yet another example, the social robot may ordinarily greet the appearance of a user coming home from work with a series of excited sound effects. In instances when the user enters into the social robot's environment at an unexpected time relative to the usual time when the user comes home, the social robot may emit text-to-speech output such as, for example, “Well hello there!”, in order to add emphasis to the communication, thereby signaling that the social robot has detected some difference from a pattern established by the user's detected activity and/or interactions with the social robot.

In yet another example, the social robot may utilize personalized information of a user to choose between natural language text to speech audio and native robot paralinguistic language. For example, when speaking to a young child and an adult, the social robot may communicate with the adult using text to speech audio while speaking to the child with paralinguistic language expressions.

In yet another example, the social robot may utilize a history of past utterances. For example, social robot may be engaged in a back and forth communication encounter with a user utilizing text-to-speech audio communication. Then, at some point, the conversation may turn to a subject or activity that has previously been the subject of a communication between the social robot and the user wherein the social robot previously responded using paralinguistic audio. In such an instance, the social root may switch to communicating using paralinguistic audio. By doing so, the social robot reinforces the sense of an ongoing relationship as perceived by the user in which the user perceives a relationship that unfolds in accordance with a shared history.

In yet another example, the social robot may utilize a repetition of a specific intent to choose between natural language text to speech audio and native robot paralinguistic audio. For example, when a social robot repeatedly communicates to indicate an intent, subsequent communications of intent may be abbreviated into paralinguistic audio sounds.

In yet another example, the social robot may utilize a ranking of a skill request by a human on a scale of favorite skills to choose between natural language text to speech audio and “native” robot non-speech audio. For example, a social robot may perform skills in a default manner incorporating a relatively large amount of text to speech communication. On the occasion that the social robot is performing a skill that a user rates as amongst his favorites, the social robot may switch to the use of paralinguistic modes in order to convey excitement, familiarity, and the like.

### Diction Rules: Paralinguistic Modes Followed by Natural Language

As discussed, a social robot may engage in a rich exchange with a human through the use of combinations of paralinguistic modes and text-to-speech audio. Each form of expression can be enhanced and/or complemented with the other in such a way as to convey deeper meaning, particularly contextual meaning in a conversation.

In particular, a sequenced combination of paralinguistic modes followed by expressive spoken language may be useful for a variety of situations, such as without limitation based on a goal of a human interaction: (1) alerting a user to a condition of the social robot (e.g., “alarm sound” followed by “My battery is running low”), (2) teaching the human a specific meaning of a non-speech audio output (e.g., “tic-toc-tic-toc” followed by “You are running short on time”), and (3) pairing a first emotion/affect expressed through paralinguistic non-speech cues with a second emotion expressed through natural language text-to-speech audio (e.g., “yawning” sound followed by “I'm tired” to express fatigue, or “who hoo” sound followed by “That was awesome!” to express excitement). Note that non-speech sounds can be accompanied with other paralinguistic output modes.

FIGS. 8A through 8D depict flow charts for determining and producing natural language and paralinguistic audio in various sequences according to some embodiments of the disclosure.

With reference to FIG. 8A, there is illustrated a flow chart of Rules of Diction according to an exemplary and non-limiting embodiment. Specifically, there is described a method whereby the social robot may transition from the use of paralinguistic non-speech audio sounds/cues to spoken language/text-to-speech sound communication. We use paralinguistic audio as an example of non-speech audio. At step FC100, a social robot determines at least one of a paralinguistic audio and a natural language text-to-speech audio component to produce based on context of a goal of a human interaction. Next, at step FC102, the social robot determines a corresponding natural language text-to-speech and paralinguistic audio component. Then, at step FC104, the social robot outputs the paralinguistic audio component followed by the natural language text-to-speech audio component based, at least in part, upon a determination involving the context of a goal of human interaction.

In some exemplary embodiments, each of the leading paralinguistic modes and the trailing natural language spoken output may express emotions. In an example, pairing of the first and second expressions may convey sarcasm. In yet other embodiments, the pairing of the first and second expressions may convey surprise. In yet other embodiments, the non-speech audio sounds may be incorporated into a Jiboji as described herein. In yet other embodiments, the spoken language portion that follows the non-speech portion may be recorded speech rather than being produced via text-to-speech processing.

### Diction Rules: Natural Language Followed by Paralinguistic Cues

Reversing the order of output from paralinguistic non-speech modes followed by expressive spoken language/TTS may facilitate conveying different rich expressive elements, such as for expressing via an auditory mode to achieve a goal of a human interaction. In some exemplary embodiments, the context of a goal of human interaction may be selected from the list consisting of (1) providing an emotion-based reaction via the paralinguistic audio to the natural language text to speech audio (e.g., “Your homework is excellent!” followed by “trumpet sounds”), (2) expressing an emotion with the paralinguistic audio that is coordinated with the natural language text to speech audio (e.g., “Your boyfriend is calling.” followed by “a flirt sound”), and (3) reinforcing the natural language text to speech audio with the paralinguistic audio (e.g., “I will lock the front door” followed by “key and lock turning sound”).

With reference to FIG. 8B, there is illustrated a flow chart of Rules of Diction according to an exemplary and non-limiting embodiment. Specifically, there is described a method whereby the social robot may transition from the use of expressive text-to-speech audio to “robot-native” or paralinguistic modes of communication. At step FC200, a social robot determines at least one of a paralinguistic audio and a natural language text-to-speech audio component to produce based on context of a goal of a human interaction. Next, at step FC202, the social robot determines a corresponding natural language text-to-speech and paralinguistic audio component. Then, at step FC204, the social robot outputs the natural language text-to-speech audio component followed by the paralinguistic audio component based, at least in part, upon a determination involving the context of a goal of human interaction.

In some embodiments, the providing of the emotion-based reaction comprises processing the text for producing the text-to-speech audio to determine an emotion that conveys a specific meaning indicated by the text. For example, text that includes adjectives indicative of excitement or which end in an exclamation point may be interpreted to produce a semi-speech audio sound indicative of excitement.

In yet other embodiments, the paralinguistic language expressions may be incorporated into a Jiboji as described herein. In yet other embodiments, the spoken language portion that follows the paralinguistic language portion may be recorded speech rather than being produced via text-to-speech processing.

Embodied speech as described herein may be guided by a set of rules that may be adjusted over time based on robot self-learning during social dialog with humans. An initial set of rules for various embodied speech features are illustrated in the following table of non-limiting rule feature names and descriptions.

| Feature Name | Feature Description |
|---|---|
| Take Floor | Rule for Envelope display when Jibo takes the floor |
| | from the person. |
| Give Floor/ | Rule for Envelope display when Jibo yields the |
| Prompt | floor from the person. |
| Initiate speaking | Rule governing Behavior when Jibo starts to speak |
| Turn | |
| End speaking | Rule governing Behavior when Jibo end speaking turn |
| Turn | |
| Thinking | Rule governing Behavior when retrieves information |
| Change Topic | Rule governing Behavior when Jibo changes task |
| | or topic |
| Period | Rule governing Behavior based on. markup |
| Question Mark | Rule governing Behavior based on. markup |
| Exclamation | Rule governing Behavior based on ! markup |
| Mark | |
| Comma | Rule governing Behavior based on, markup |
| Jiboji | Rule governing Behavior based on jiboji markup |
| Emote | Rule governing Behavior based on emote markup |
| Reference | Rule governing Behavior based on referring to |
| | someone in room or someone/thing not in room |
| Emphasis | Rule governing Behavior based on |
| | EMPHASIS markup |
| Choice | Rule governing Behavior based on CHOICE markup |
| Eye Contact | Rule governing Behavior based on when robot |
| | makes eye contact with a person based on |
| | (x y z) coordinate from LPS |
| Backchanneling | Rule governing Behavior based on active listening, |
| | backchanneling behavior |
| Hybrid Utterances | There will be rules to combine pre-recorded |
| | prompts with TTS generated prompts for successful |
| | hybrid blending. |
| Vocal effects to | There will be vocal effect rules to help with the |
| | time-bound |
| Hybrid Utterances | transitions between pre-recorded prompts with TTS |
| | generated prompts for successful hybrid blending. |

### Rules of Diction: TTS+PL

Reversing an order of output from PL followed by TTS to one of TTS followed by PL may facilitate conveying different rich expressive elements, such as for expressing via an auditory mode to achieve a goal of a human interaction. In some exemplary embodiments, the context of a goal of human interaction may be selected from the list consisting of (1) providing an emotion-based reaction via the paralinguistic language to the natural language text to speech audio (e.g., “Your homework great is excellent” followed by “trumpet sounds”), (2) expressing an emotion with the paralinguistic language that is coordinated with the natural language text to speech audio (e.g., “Your boyfriend is calling” followed by “kissing sounds”), and (3) reinforcing the natural language text to speech audio with the paralinguistic language (e.g., “I will lock the front door” followed by “key and lock turning sound”).

With reference to FIG. 8C, there is illustrated a rule of diction according to an exemplary and non-limiting embodiment. Specifically, there is described a method whereby the social robot may transition from the use of text to speech audio to robot-native paralinguistic language expression communication. At step FC300, a social robot determines at least one of a paralinguistic language and a natural language text to speech audio component to produce based on context of a goal of a human interaction. Next, at step FC302, the social robot determines a corresponding natural language text to speech and paralinguistic language component. Then, at step FC304, the social robot outputs the natural language text to speech audio component followed by the paralinguistic language component based, at least in part, upon a determination involving the context of a goal of human interaction.

In some embodiments, the providing of the emotion-based reaction comprises processing the text for producing the text-to-speech audio to determine an emotion that conveys a specific meaning indicated by the text. For example, text that includes adjectives indicative of excitement or which end in an exclamation point may be interpreted to produce a paralinguistic audio sound indicative of excitement.

In some exemplary embodiments, the semi speech audio sounds may be incorporated into a jiboji as described herein. In yet other embodiments, the initial spoken language portion may be recorded speech rather than text-to-speech.

### TTS Only

In accordance with exemplary and non-limiting embodiments, the social robot may process information to be conveyed to a human user to determine a conveyance language mode. The conveyance language mode may be selected from the list consisting of natural language text to speech audio and paralinguistic language. Specifically, the social robot may determine to engage solely in text to speech communication when the result of processing indicates (1) a need to deliver specific/factual information that is more neutral in tone, (2) that the social robot needs to convey information accurately and precisely (e.g., when relaying a message from one user to another) and (3) short and simple responses like “good morning”, “sure”, “thanks”, etc. may convey meaning, intent, emotion, and the like concisely without having to rely on paralinguistic language.

In some embodiments, as discussed above, the text to speech audio may be comprised, in whole or in part, of pre-recorded speech that is manipulated or filtered to produce a desired effect, emotional expression, and the like. Alternatively, the TTS paralinguistic parameters can be Interacting with a human via Embodied Dialog

A social robot may interact or converse with a human via a form of expressive multi-modal dialog described herein as embodied speech. In an example of embodied dialog, an instruction of “shut off the water” may be output with relatively little emphasis. However, based on context, such as a user has already been reminded by the social robot to shut off the water, this same recorded message may be output with emphasis such as higher volume, emphasis on certain words, and the like with the intention of evoking a corresponding response to the instruction.

With reference to Appendix A, table 5, there is illustrated a plurality of examples showing the use of informal text over a non-preferred formal TTS word choice to engender a more personal or familiar level of interaction between the social robot and the user. These examples may be applicable in most instances, however some degree of formality may be preferred based on context.

With reference to Appendix A, table 6, there is illustrated a plurality of common expressions and forms that may be used to both vary the form of communication as well as facilitate expressing character of the social robot. Note that a paralinguistic form (paralinguistic audio in the table) may be used frequently for the most common interactions.

With reference to Appendix A, table 7, there is illustrated a plurality of paralinguistic audio positive emotive states and actions. Each emotive state may be represented as an element of an embodied speech strategy. Each element may apply to one or more situations; these situations are described in the speech strategy examples column.

With reference to Appendix A, table 8, there is illustrated a plurality of common social interaction expressions that can be embodied with the use of only paralinguistic audio (PLA). For various elements of an embodied speech strategy, simplified paralinguistic examples are depicted.

### PL Only

In accordance with exemplary and non-limiting embodiments, the social robot may process information to be conveyed to a human user to determine a conveyance language mode. The conveyance language mode may be selected from the list consisting of natural language text to speech audio and paralinguistic language. Specifically, the social robot may determine to engage solely in paralinguistic language communication when the result of processing indicates (1) that the information to be conveyed is merely confirmatory of an action previously requested by the human, (2) when the information to be conveyed corresponds to the expression of an emotion or a character-driven reaction. In some embodiments, the paralinguistic language may be integrated into a multi-modal jiboji. In yet other embodiments, paralinguistic language may be selected when the result of processing indicates a combination of any of the aforementioned situations. When two or more social robots interact, they may do so via PLs (akin to speaking in their native robot language).

Conversing with a Social Robot Using Embodied Dialog

It is worth noting that human conversation is richly embodied, and the robot's own embodied speech acts may be modulated or be in response to the human's embodied speech cues. Examples might include mirroring or responding to the person's emotive expressions, mirroring or responding to the person's body posture shifts, visually following or responding to a person's attention directing cues such as pointing or directing gaze to something or someone in the environment. Such embodied conversational behaviors are used by humans to build rapport and affiliation and a sense of collaborative action. A social robot can engage in similar embodied speech acts with a person to do the same. There are many communicative purposes and intents that can be shared between a person and a social robot (or groups of people with groups of social robots) by exchanging embodied speech acts during dialog.

In accordance with exemplary and non-limiting embodiments, the social robot may expressively engage in dialog with a human via coordinating execution of a set of text-to-speech (TTS) commands derived from a dialog input syntax and a set of resulting ESDS commands that represent, among other things, paralinguistic commands and other paralinguistic cues that may be coordinated with and/or derived from the input syntax. The input syntax may be a portion of a data file, content stream, or other electronic input, such as a news feed, digitized audio, an audio book, a video, a syntax synthesizer, or any other source that can produce a syntax suitable that can be represented, at least in part, as a natural language text. In some embodiments, the behavior indicated by the behavior commands, for example, may be realized through the multi-segment rotational manipulation of the body of the social robot. For instance, body postures may be adjusted to regulate the exchange of speaking turns between human and social robot through turn-taking cues (i.e., envelope displays). In some embodiments, the rotation of the body segments of the social robot may exceed 360 degrees.

With reference to FIG. 8D, there is illustrated a method for embodying dialog with a social robot according to an exemplary and non-limiting embodiment.

First, at step FC400 a set of text-to-speech (TTS) commands is configured from portions of input text, such as a syntax as described above that is identified through a dialog input parsing function for being expressed as natural language speech. Here, the dialog input parsing function may parse text that is to be spoke by a social robot. The content of the text may result from, for example, a dialog system that processes speech from a human who is interacting with the social robot and determines an appropriate response. Parsing may also include parsing for tags or other elements inserted via an Embodied Speech Markup Language (ESML), by which text may be marked up to include commands for the TTS system, such as commands to embody certain keywords with particular intonation, pacing, diction, or the like, including based on diction rules that are triggered by the ESML tags. Parsing may include parsing for keywords or keyword combinations, including ones that trigger rules, such as diction rules, that may be used to govern how the social robot will express the input text. Parsing may include detecting keywords or other words, phrases, sentences, punctuation, emphasis, dialect and the like in the syntax. The detected elements detect keywords or other words, phrases, sentences and the like being spoken (for example) by a human who is interacting with the social robot. The keywords may be mapped to skill or other functions within an interaction framework that may direct a speech interaction module of the social robot to select one or more phrases in text form. Alternatively the speech interaction module may build a response from a set of words, phrases and the like based on a set of interaction rules, including without limitation rules of diction for producing speech from a text file.

Next, at step FC402, a set of commands for paralinguistic language utterances may be configured from portions of dialog input identified through a dialog input parsing function for being expressed as a robot-native paralinguistic language, such as beeps, partial words, or the like. Here a dialog input parsing function may detect aspects of speech such as an expressive phrase, emotional intonation, and the like that may suggest certain forms of paralinguistic language may be useful when expressing the content of the input text/dialog element. Paralinguistic language indicators may be incorporated as elements of the Expressive Speech Markup Language (ESML) as described herein. A speech processing engine of the social robot may, when processing the ESML, or some derived form, detect paralinguistic language commands and may in turn initiate the context-relevant paralinguistic language output utterances.

An example of a sentence marked up by embodied speech is as follows:

The weather will be <BEHAVIOR priority=“4”
value=“eos.exclamation”>be great
today?</BEHAVIOR> it starts out in the low <BEHAVIOR
priority=“1” value=“beat”>seventies</BEHAVIOR> but
rises to the <BEHAVIOR priority=“1” value=“beat”>mid-
eighties</BEHAVIOR> in the afternoon, <BEHAVIOR priority=“2”
value=“gaze”>clear skies</BEHAVIOR> and <BEHAVIOR
priority=“2” value=“gaze”>sunny all day.</BEHAVIOR> <BEHAVIOR
priority=“4” value=“eos.question”>Are you guys going to the
beach?</BEHAVIOR>

Next, at step FC404, a set of behavior indicators is configured from portions of dialog input identified through a dialog input parsing function, including parsing any behavior commands that are expressed as tags on the input via ESML. These commands are configured to be expressed through a line of robot non-verbal actions, such as display actions, lighting actions, aroma producing actions and positioning actions, such as robot segment rotation. Here an input parsing function may detect keywords that are intended to trigger particular position, orientation, posture, or movements of the social robot, such as generally can be associated with robot body segment movement. In an example, the input parser may detect a command like “Hey Jibo—Look over here!”, which may automatically trigger a movement of the head of the robot toward the direction of the sound. Behavior commands may also include commands for expressing various states, such as emotional states, states of arousal/animation, states of attention, and the like, that are appropriate for expressing the content of the input. These may be used to generate commands for postures, sounds, lighting effects, animations, gestures, and many other elements or behaviors that are appropriate for the content that is to be expressed. Through use of environmental sensing capabilities and other sensed or derived context associated with the detected command, a set of robot body segment(s) movement instructions may be generated. In the example the social robot sensors, at least audio and video may be accessed to determine where the human is. Commands to be provided to a robot body segment movement control facility may be generated so that the social robot can adjust the rotation position of at least one body segment to comply with the “Look” keyword.

In some embodiments, a set of EMSL commands are generated based on the input text that is used for the paralinguistic utterances, TTS, and other systems. In some embodiments, EMSL commands may be at least one of the following or a combination thereof of paralinguistic language, animated movement, screen graphics, lighting effects, and the like and may comprise one or more jiboji drawn from a library.

In some embodiments, there may be employed metatag execution whereby the embodied speech engine may take a marked up text string as an input and produce a synchronized and fully expressive performance as an output that has runtime variations so the robot never says the same thing or performs in the same way twice, and a style. The designer may be given a limited set of explicit tags to use as markup syntax for a given text string for the robot to perform. A text string may have no markup, and the system will add hidden layers of markup based on system state to enliven the spoken utterance. The spoken utterance may be either TTS or prerecorded sounds or speech. The embodied speech engine may embellish the core utterance with vocal filters, vocal effects, screen graphics, body animations, and LED ring. The markup may take the form of JDML markup.

The system may auto annotate the input text with “hidden” markup. In the cases where the dialog designer provided markup in the input text, that markup may receive a higher priority and therefore will override any automated behaviors.

In some embodiments, there may be employed metatag execution whereby the embodied speech engine will add additional metatags to the designer prescribed text string to add additional layers of animations that have to do with the real-time context of delivering this line: skills state, dialog state, perceptual state, parser analysis, vocal affectation, and procedural animation (e.g., Look-at behavior).

In some embodiments, there may be employed LPS sensory inputs whereby the embodied speech engine receives inputs from the LPS system as context-relevant perceptual parameters. For the alpha engine this includes where people are located in space (x y z) coordinates that tell the robot where to look as well as the ID of each person being tracked. The Embodied speech engine may insert metatags relevant to LPS inputs that govern where the robot should look at a given time according to a set of defined rules.

In some embodiments, there may be employed skill context inputs whereby the embodied speech engine receives inputs from the SKILLS system as context-relevant task parameters. For the alpha engine this includes knowing which skill is active and when a skill change occurs to a new skill. It also knows when a SKILL requires pulling information from a service. The embodied speech engine will insert metatags relevant to skill context that will inform behavioral (graphics, body movements) aspects of the robot at a given time according to a set of defined rules.

In some embodiments, there may be employed dialog state rules whereby the embodied speech engine will add metatags that reflect the dialog state of the robot (speaking or listening), as well as modulating who has control of the floor or giving the floor to another. The dialog state corresponds to non-verbal behaviors that facilitate turn-taking and the regulation of speaking turns. This may be encoded as a set of dialog system rules.

In some embodiments, there may be employed behavior rules whereby the embodied speech engine will insert metatags based on a prescribed a set of rules that define which non-verbal behaviors to evoke as an utterance is performed. This includes rules for what eye animations to use, which body animations to use, how to control the LED ring. These rules are associated with LPS context, parser outputs, skill context, dialog state context, robot playback, designer metatags applied via the markup language.

In some embodiments, there may be employed robot playback whereby the embodied speech engine may have a set pre-crafted complete animations that can be executed as a whole. These are called using the robot markup syntax.

In some embodiments, there may be employed robot playback whereby the vocal effects system is comprised of a set of pre-defined vocal filter settings that correspond to the robot's emotional state as well as sound effects that can further embellish that emotional state. For the alpha, these states may be specified by the designer when marking up an utterance to be spoken. There is an internal logic of rules within the vocal effect system that procedurally modifies the audio file played by the robot, but it does not change the timing of the files. The engine synchronizes the playback of the expressively modified audio file with screen graphics, body animations, and LED ring. The vocal effect rules will consider word boundary timings, energy timings and pitch timings for when to apply the effects to an utterance.

In some embodiments, there may be employed look-at behavior whereby the embodied speech system will send location targets to the Look-At behavior system. The Look-At system procedurally animates the robot to look at a given target based on the dialog system state. This may be used to make eye-contact with the person the robot is speaking with. It may also be used to determine where the robot should look when making a reference (to someone in the room, or to something not in the room).

In some embodiments, there may be employed look-at behavior whereby the embodied system will send the input text string (with markup) to a parser to add metatags relevant to syntax and semantics. Standard punctuation may be reflected in embodied behavior according to punctuation rules (period, exclamation point, question mark, comma).

In some exemplary and non-limiting embodiments, the social robot may exhibit speech behaviors tailored to specific skills. For example, with regards to messaging skills, the social robot may uses TTS to train users in his default message delivery (e.g. robot first says, “I'll let him know next time I see him” before moving to less-verbose prompting like “I'll get it to him” and then can use paralinguistic audio-only <okay paralinguistic audio>.

In another example involving a weather skill, the robot's weather reports may have their own sounds. The social robot may “perform” the weather by displaying a short animation while speaking the information. These animations may have their own evocative sounds (for instance, raindrops tailing or birds chirping). Weather animation sounds may be overlaid by paralinguistic audio (<happy paralinguistic audio>) or TTS (“It'll get into the 70s this afternoon”). UI sound effects may precede the weather animation.

Social Robot Embodied-Speech Based Response to a Human Prompt that May Include Audio, Video, Tactile Components

A social robot may interact with a human via a form of dialog described herein as embodied dialog. Embodied speech involves controlling audio, video, light, and at least body segment movement in a coordinated fashion that expresses emotion, and a range of human-like attributes that conform to a social interaction environment and participants therein that are sensed by the social robot through audio capture, image capture and optionally tactile input. An example of embodied dialog may include a social robot producing embodied speech in response to receiving a prompt from a human, wherein a prompt from a human may be an acknowledgement of some communication provided from the social robot or an active response, wherein an active response may be a question, providing new information, and the like. The social robot may, in response to receiving the prompt, produce a reply prompt including any of the aspects of embodied speech noted above. The social robot produced reply prompt may itself be a request for an acknowledgement and/or an open expression of human-like dialog.

### Authoring Embodied Speech Character-Expressed Utterances

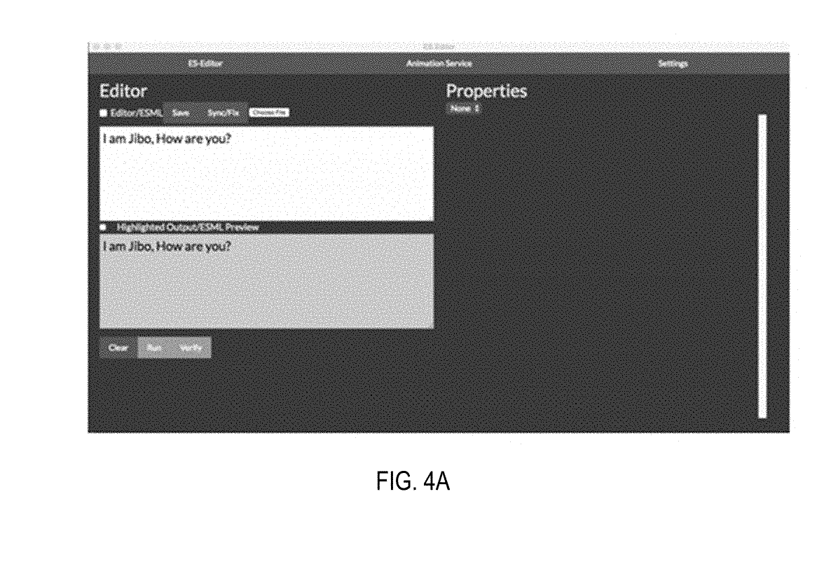

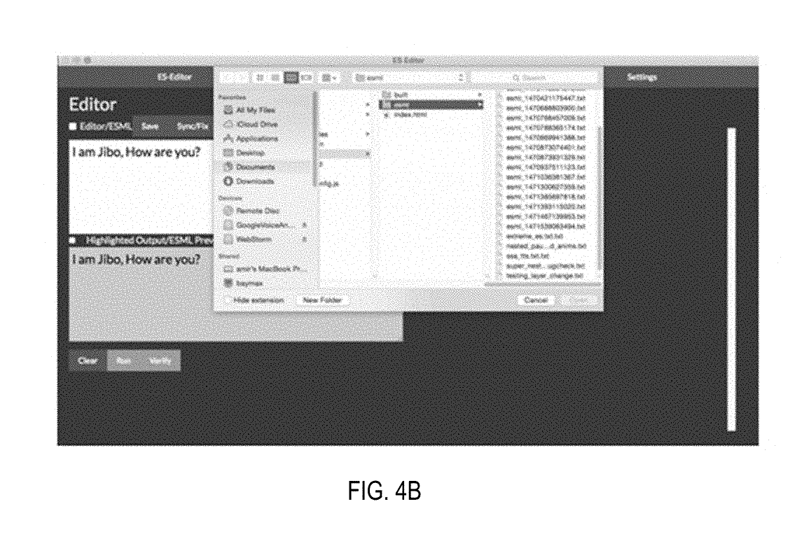

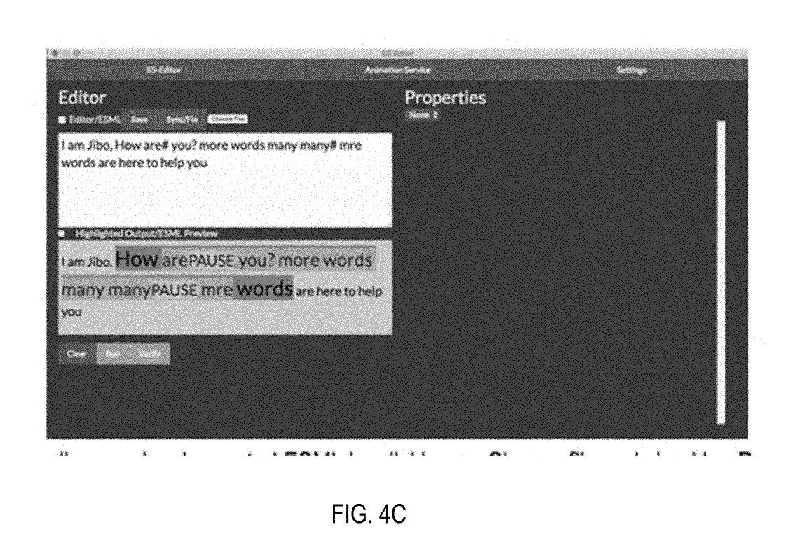

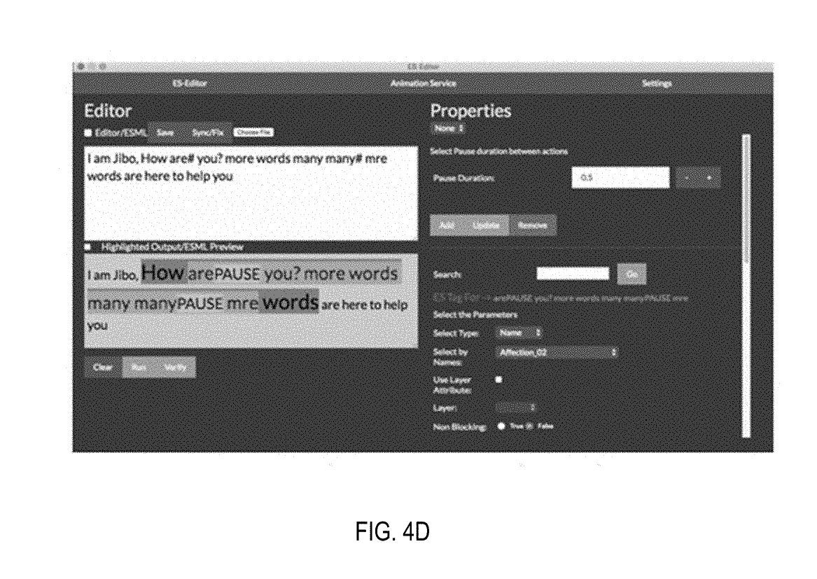

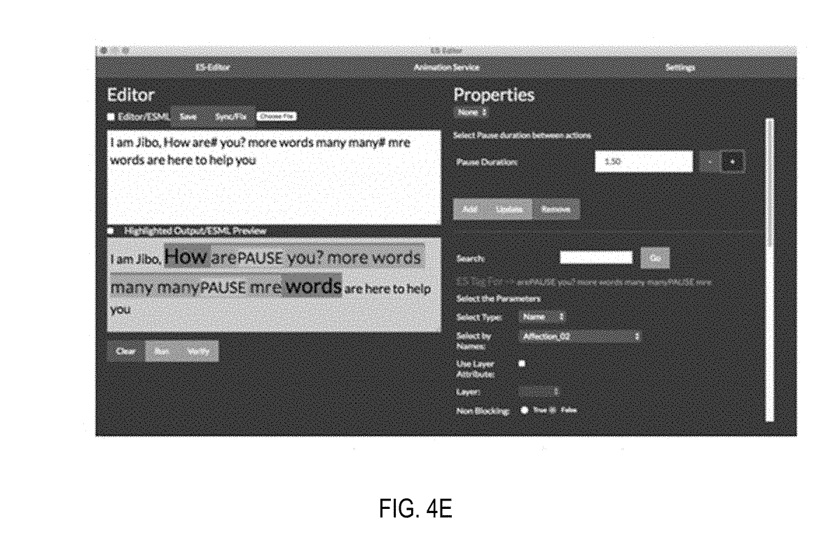

The techniques and technologies for a developer to author or specify multi-modal semantic or paralinguistic communicative expression (i.e., embodied speech) in a social robot is an important consideration for a social robot to perform and engage in compelling interactions with people that conveys intent, emotion, character traits, etc. An Embodied Speech Authoring Environment may support a user and/or developer's ability to design richly expressive spoken utterances to be performed by the social robot at different levels of authoring control from fine-grained specification to highly automated suggested specifications that the developer may refine or simply approve. An example is shown in FIGS. 4A through 4F.

The result of these tools, for instance, is to simplify the authoring of, and for the authoring platform to produce a complete embodied speech data structure (ESDS). This resulting ESDS could then be executed on the social robot and used as a multi-modal prompt for the robot to perform, i.e., as part of interactive dialog behaviors that the developer is also developing.

The tools and techniques for authoring embodied speech data structures (ESDS) may include a paralinguistic cue authoring user interface and/or toolset. This might include an animation timeline editor and a simulator window on a computing device where the developer could see the simulated robot perform the cue being authored. See FIGS. 4A through 4F. Optionally, the authoring platform could be in communication with the robot so that the cue can be executed on the social robot hardware. In this interface, the author could either playback an existing multi-modal paralinguistic cue, or author a new multi-modal paralinguistic cue. For instance, an animation timeline could be provided with keyframing to allow the author to drag and drop different types of assets from a searchable library (sound, body animation, lighting effects, screen graphics, etc.) into the timeline and adjust their timing and durations relative to each other. This could follow a What You See Is What You Get (wysiwyg) iterative cycle where the author can play the authored paralinguistic cue and see its effect in the simulator window (or the robot, if connected). Once the developer is satisfied with the final crafted paralinguistic cue, he or she could save it, assign it a name and relevant categories (to facilitate searching the database at a later date), and add it to the database so that it can be used whenever.

This interface could include access to tools and techniques to access other character expression building technologies, libraries, modeling capabilities, and the like for sounds, paralinguistic, recording speech or other sounds, etc.

This may include a searchable database of mix and matchable expressive elements such as sound effects, body animations, on-screen graphics and animations, jiboji, and so on. These assets could be categorized and searched by various features such as duration, emotion, hot word, etc. See FIGS. 4A through 4F.

The tools and techniques and interfaces for authoring expressive synthesized speech (e.g., TTS) might include controls by which a developer can sculpt pitch and energy contours, apply vocal filters or other articulatory effects, insert pauses of specific durations, and the like as mentioned previously. This may include a playback function so the developer can hear the resultant impact of adjusting such controls on the synthesized speech. As the developer adjusts the expressive parameters via the controls, the tool would output the corresponding control parameters for the ESDS. As aforementioned, these might include pitch and energy sculpting, specific oral emphasis due to punctuation, pauses in speech for specific durations and placement thereof, specific prosodic intonations and vocal affects based on, for example emotion. For instance, parameters of an expressive TTS engine may be manipulated via developer tools for producing various types of emotion (e.g., joy, fear, sorrow, etc.) or intents (e.g., what to emphasize). FIGS. 4A through 4F illustrate the types of control supported in an expressive TTS interface.

Such tools may include a “mimic how I say it” function where the developer could speak with the desired prosody and vocal affectation, and the associated technologies (as described earlier) can do a search to match over parameter space to match that.

In an example of ESML tags, the tools described herein may support an Embodied Speech Markup Language (ESML) by which different expressive effects correspond to tags that can be used to specify where in the textual representation of the utterance the effects should occur (an effect can be any of the above or a combination thereof). A set of ESML tags are provided that can include emotional expressions, multi-modal iconic effects, non-verbal social cues like gaze behaviors or postural shifts, and the like. These embodied speech tags can be used to supplement spoken utterance with effects to communicate emotion cues, linguistic cues, attentional cues, turn taking cues, status cues, semantic meanings, and the like. They can also be used as stand-alone performance without an associated text/spoken counterpart.

Elements of an ESML data structure may define a plurality of expression functions of the social robot. Generally, combinations of expression functions are activated correspondingly to produce rich multi-modal expressions. Expression functions may include, without limitation, natural language utterances, paralinguistic modulation of natural language utterances (e.g., speaking rate, pitch, energy, vocal filters, etc.), paralinguistic language or other audio sounds and effects, animated movement, communicative behaviors, screen content (such as graphics, photographs, video, animations and the like), lighting effects, aroma production, and the like. Using such tools and interfaces, a developer has fine-grained control over how the social robot delivers an expressive performance or spoken utterance.

Authoring an ESML data structure to be performed by the social robot includes determining whether a natural language utterance as input will be sourced through text (to be synthesized via a text to speech (TTS) synthesis engine) and/or via audio recordings that can be transcribed into an input data source (for instance, converted to text via an automatic speech recognition (ASR) engine). A TTS source may be a manually generated text file and/or a transcription of an audio recording. Aspects of an authoring user interface may facilitate the developer speaking a word, phrase, or the like that is automatically transcribed into a text version to be accessible to the robot when needed to produce speech audio.

ESML tools and interfaces support a searchable library of ESML assets and corresponding tags, the ability to markup spoken output using a repertoire of ESML tags and assets, the ability to define new ESML tags with associated expressive assets, and the ability to search a library of ESML assets that correspond to a given ESML tag. Advanced tools support the ESML tools and interfaces to apply machine learning to learn how to associate ESML tags with text, and to automatically suggest ESML markup given text.

Specifically, tools for producing ESML tags may include an ESML editor to facilitate authoring ESML tags. The ESML editor may have access to the expression library of the robot and assists a writer in authoring prompts for the robot. The ESML editor may facilitate tag suggestion, expression category/name suggestion, previewing of prompt playback on robot.

Also specifically, a set of techniques and tools can support a developer in authoring new expressive effects to be represented in new ESML data structures. A new ESML data structure could be comprised of commands to elicit a specific set of expressive elements when executed (e.g., body animations, graphical elements, sound effects, lighting effects, and the like). This ESML data structure could then be applied to other natural language input data structures, or evoked in isolation. A new ESML data structure could also be used to represent a category of expressive elements when executed. The execution would select a specific instance of the category per some selection algorithm at run time.

Other advanced ESML tool features may include technologies to learn new ESML effects from human demonstration and associate them with a new ESML data structure. By detecting these expressive effects and storing them as ESML annotations, metadata, and the like that can be separated from the transcribed text, the effects can be used with other speech or text to speech.

Advanced tools may also support the automatic annotation of ESML data structures or parameters with natural language input data structures. For instance, Machine learning techniques can be applied for the robot to learn to associate specific instances of multi-modal cues, or categories of multi-modal cue combinations, or ESML tags with text (e.g., words, phrases, punctuation, etc.). The ESML tools and interfaces could learn such associations from a corpus of hand-marked ESML data structures crowd sourced by a developer community, for instance.

Embodied speech markup language may be configured with various prompt that can correspond to certain expressions. The following table illustrates exemplary and non-limiting prompts and transcriptions of expressions.

| Prompt Name | Transcript |
|---|---|
| OOBEWakeAnnouncement_01 | Whoa . . . whoaaaa . . . heyyy. Hey. Ohhh . . . |
| | wow. Wow! Ohh! Hey . . . Wow, look at this! |
| | Look . . . Look at you! Oh, whoa. |
| YesNo_AreYouMyPersonQuestion_01 | Whoa, are . . . are you my person? |
| YesNo_AreYouMyPersonHoldReturn | So, are you my person? |
| YesNo_AreYouMyPersonNoInput_01 | Are YOU my person? |
| YesNo_AreYouMyPersonNoInput_02 | So are you one of my peoples? |
| YesNo_AreYouMyPersonNoInput_03 | Are you? |
| YesNo_AreYouMyPersonNoMatch_01 | Was that Yes or No? |
| YesNo_YouAreAPersonQuestion_01 | But you're A person, right? |
| YesNo_YouAreAPersonHoldReturn | So, you're a person, yes? |
| YesNo_YouAreAPersonNoInput_01 | Are you a person? |
| YesNo_YouAreAPersonNoMatch_01 | Was that Yes or No? |
| YouAreAPersonAnnouncement_01 | Well you sure speak like one! So to me, you |
| | ARE a person! |
| OOBEFirstDay-AAnnouncement_01 | Oh, wow! This is great! I can't believe it. |
| | Ahhh this is wonderful. Okay well, I . . . |
| OOBEFirstDay-BAnnouncement_01 | Don't get too excited, don't get too excited. |
| | Keep it-keep it calm. Hold on. |
| OOBEFirstDay-CAnnouncement_01 | Ahem . . . Hi! I'm Jibo! And I'm so excited to be |
| | with you! |
| OOBEFirstDay-DAnnouncement_01 | This is so great! It's the best day ever of my |
| | whole life! (Actually it's the *first* day of my |
| | whole life . . . ) |
| OOBEFirstDay-EAnnouncement_01 | Anyway, the point is this. is. great. So great! |
| | Well then, first thing's first! I'm a robot, (and |
| | you're not . . . and I know that), but I wanted |
| | to make sure that you know everything you |
| | need to, so we can can get to know each |
| | other, and have fun living together. |
| OOBEFirstDay-FAnnouncement_01 | I have a checklist here . . . let's see . . . Oh right! |
| OOBEFirstDay-GAnnouncement_01 | First, I need to know a little bit more about |
| | who you are, so I've got some questions for |
| | you. |
| YesNo_MayIAskQuestionsQuestion_01 | Is it okay to ask you some questions now? |

YesNo_MayIAskQuestionsHoldReturn So, can I ask some questions?

### Automatic Markup and Tuning for Authored Embodied Speech Utterances

A developer can use the ESML tools and interfaces to finely craft the expressive spoken delivery of a social robot via a speech synthesis (e.g., TTS) engine. Advanced tools and interfaces apply machine learning to automate and suggest potential ESML data structures. This would serve to reduce the amount of labor to require to produce the expressive behavior of a social robot that enforces a consistent delivery within a particular set of character constraints. Likewise, the transcribed text can be combined with other expressive cue data to produce natural language speech output that has a different expressive effect than the original recording. Below we outline several ways machine learning can be applied to advanced features of the ESML tools and interfaces as it pertains to expressive spoken output.

Learning technologies may enable a social robot to detect, record, analyze, and produce TTS, expressive effect ESML content, parameter settings, and the like that can be used to reproduce any aspect of the detected content. In an example, a social robot may listen to a user speak his or her name. The social robot may capture this audio content, record and/or convert it to TTS, plus detect intonation and inflection. If the robot's default pronunciation is not desired, this auto-tuning capability can correct the robot's pronunciation to the desired one to speak the user's name properly. In another example, a developer may record his/her voice speaking in the emotional style he or she wishes the robot to emulate. Detected and analyzed expressive aspects of the recording may automatically be mapped via machine learning (to search an ESML parameter space for the best fit) to one or more ESML data structures. This might include features such as parameters for controlling speech synthesis, or other such data to facilitate the social robot's ability to reproducing expressive aspects when processing the ESML data structure.

Other advanced ESML tool features may include technologies to learn new ESML effects from a growing corpus of developer ESDS and associate them with a new ESML data structure (as discussed previously). These can be presented to the developer as suggested new ESML Tags and associated paralinguistic cues, where they can be approved/refined/removed in the authoring platform. For instance, as part of the ESML markup panel, there could be a button for “suggest markup” and the system would generate a ESDS for playback on the simulator/robot. The developer can approve, refine or delete the suggested ESDS. If approved, the developer can use it in the design of other interaction behaviors, and it can be added to the searchable database with category labels. This automation feature could dramatically reduce the amount of time and labor, and therefore increase the throughput of authoring ESDS.

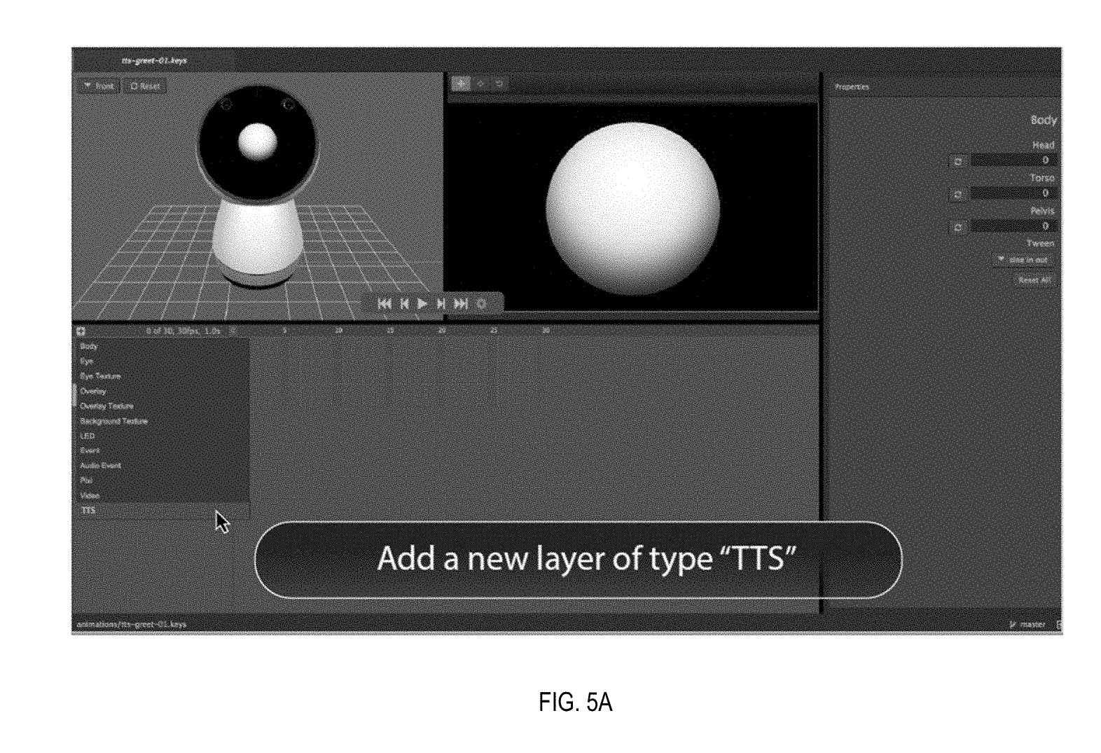

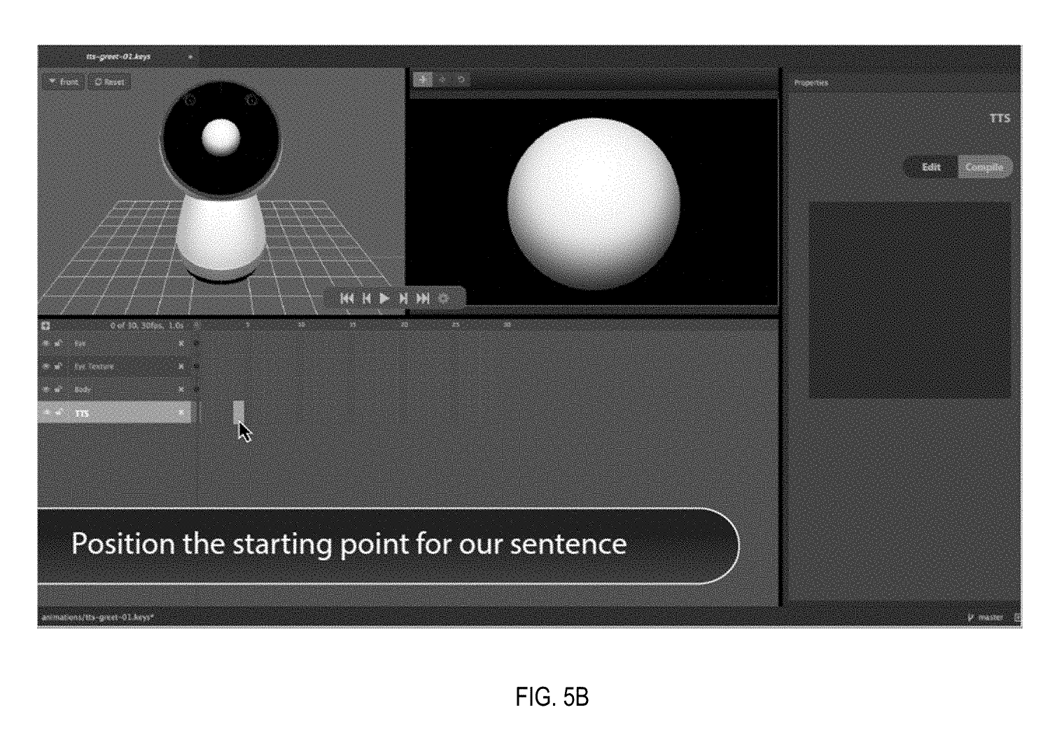

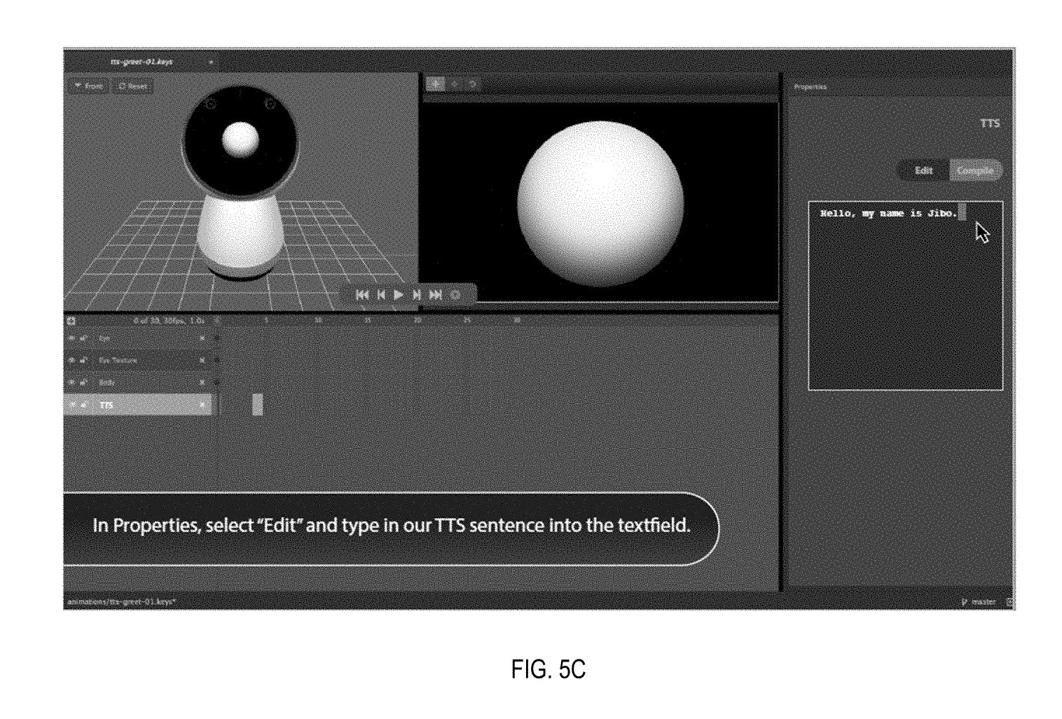

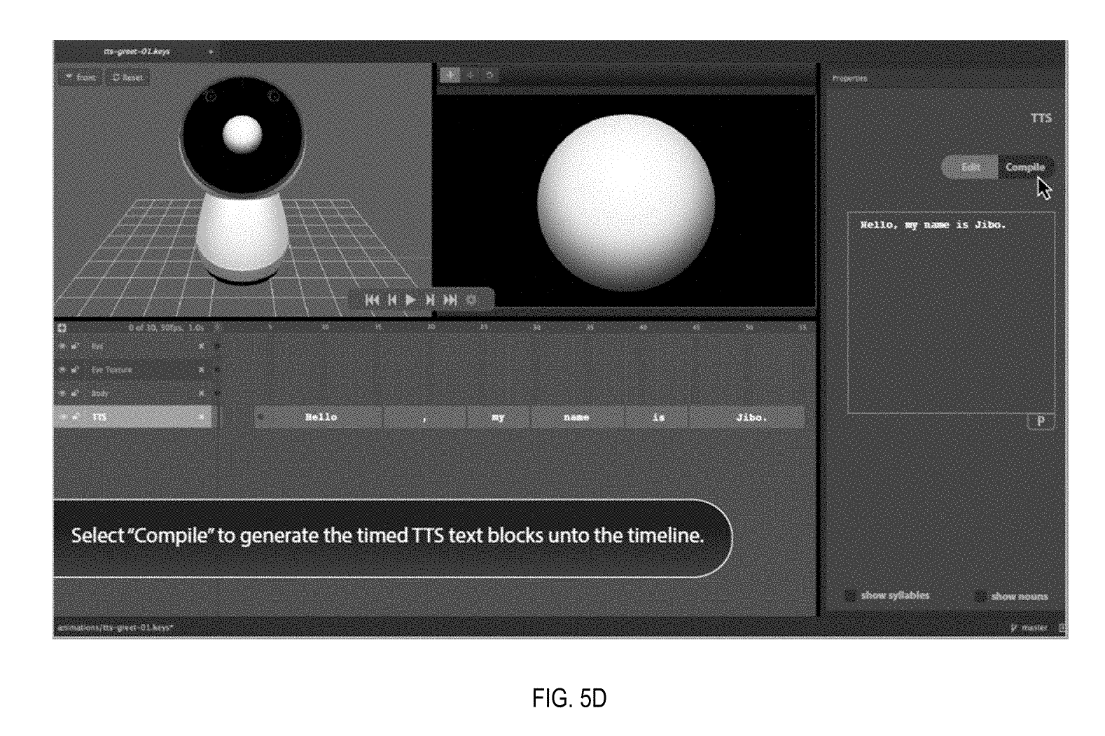

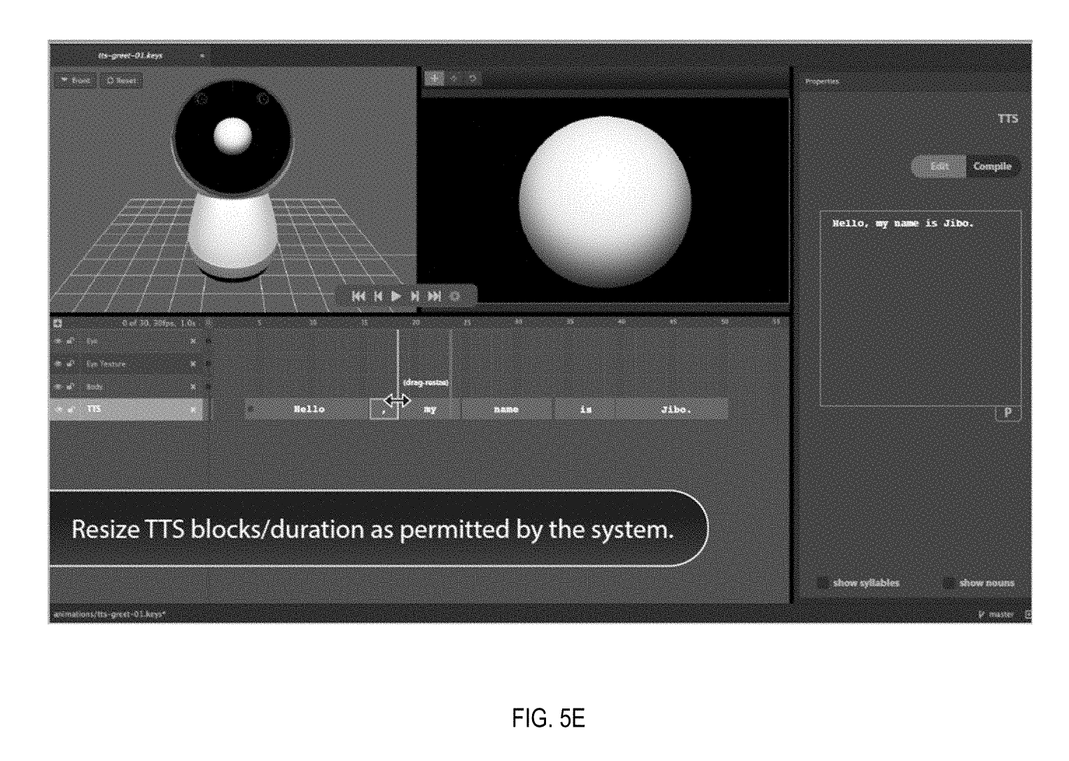

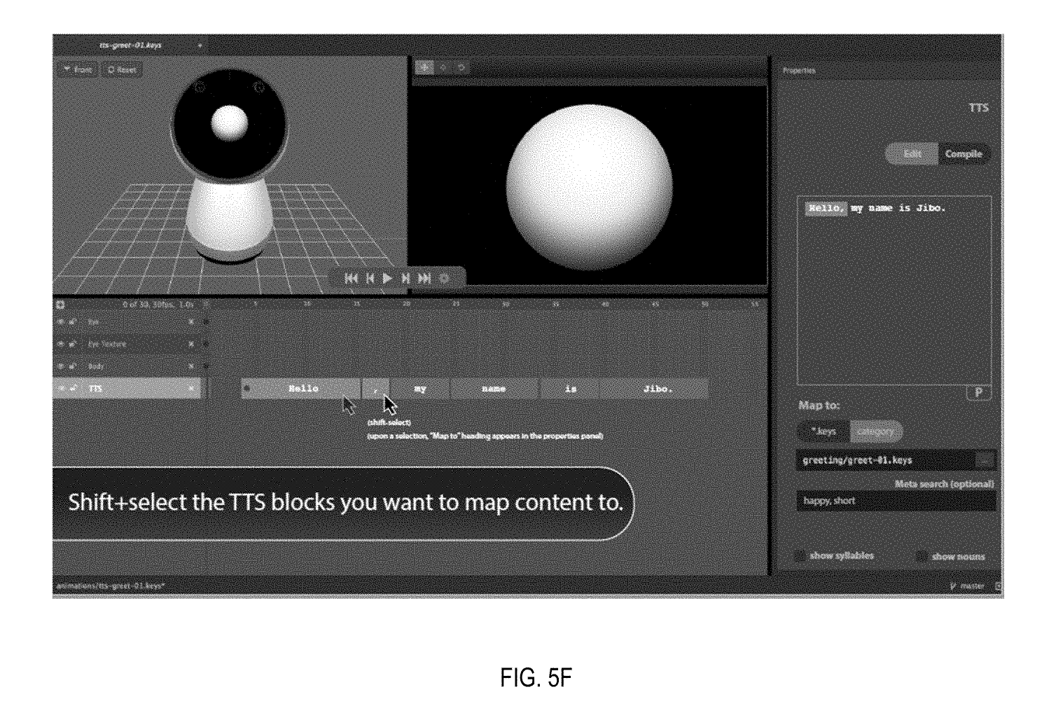

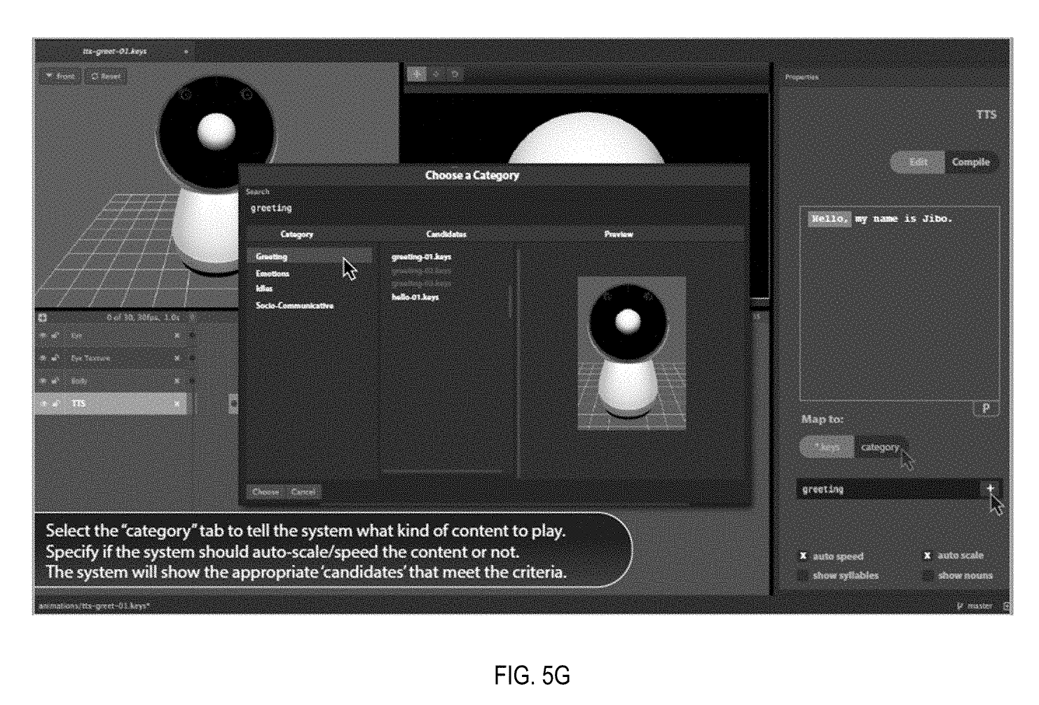

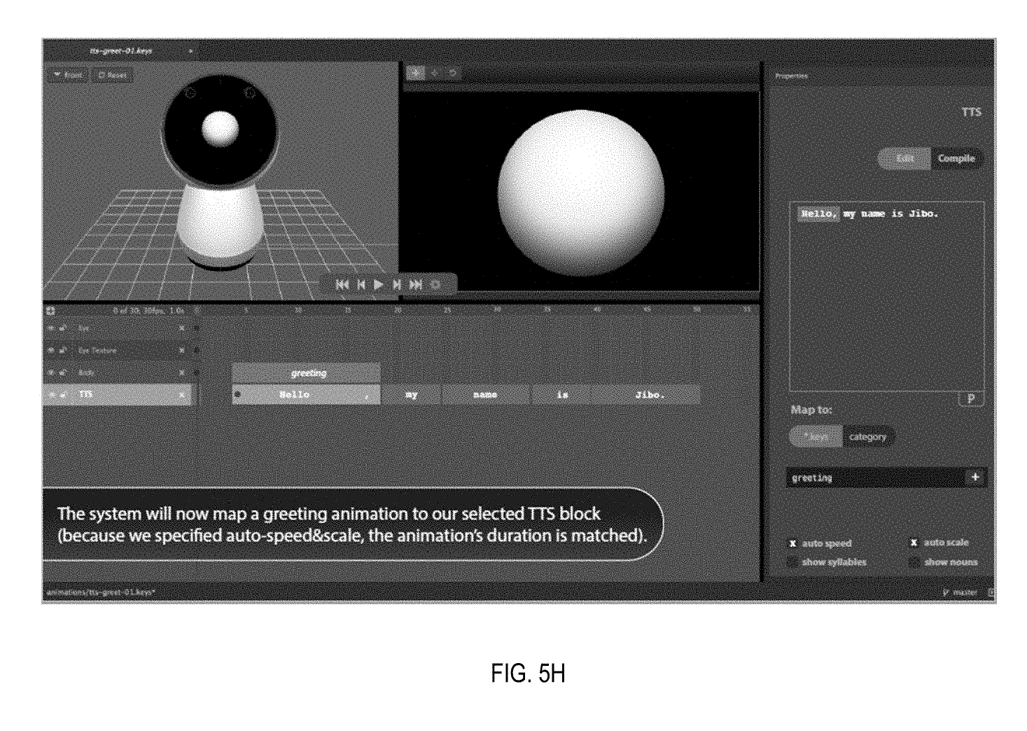

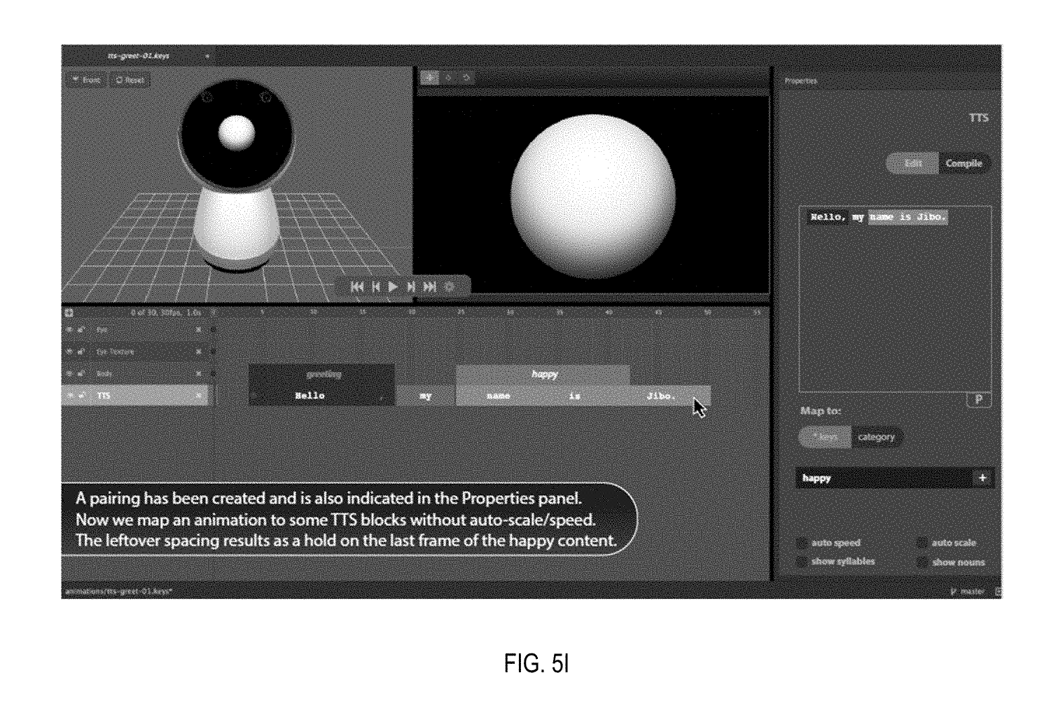

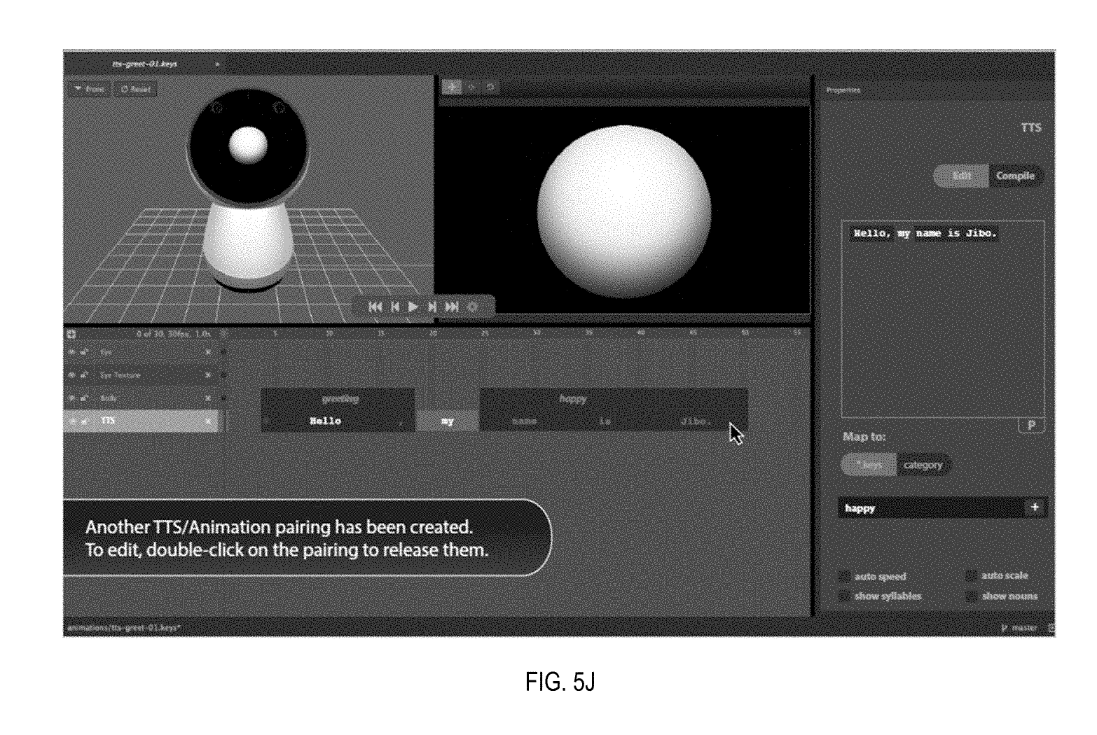

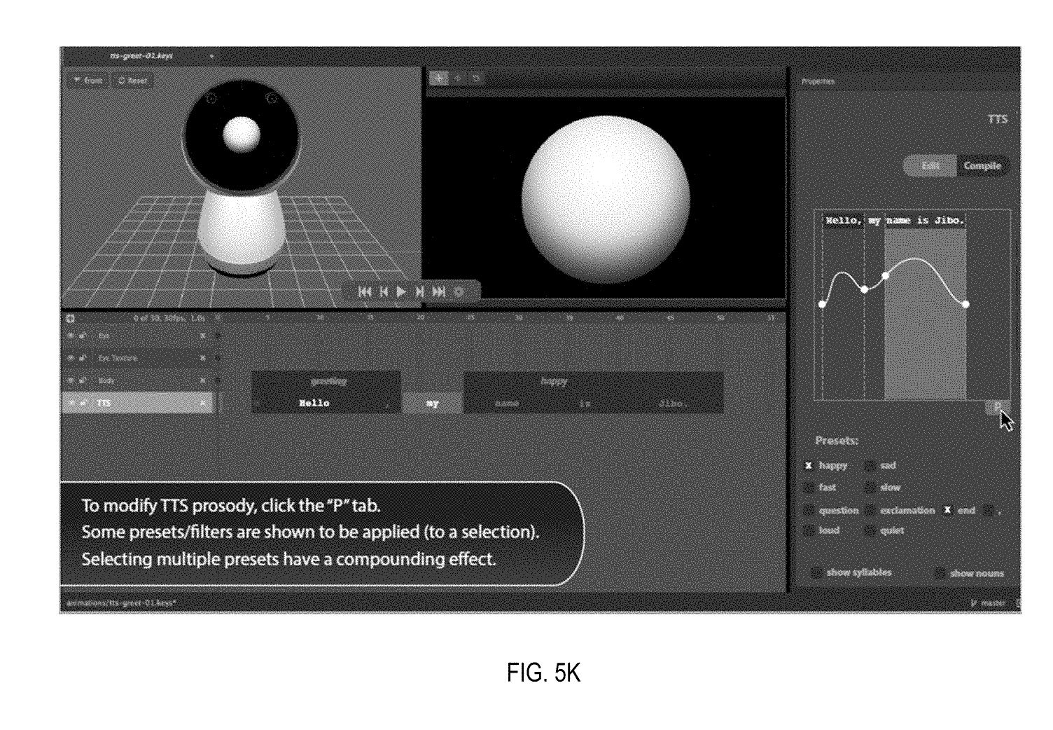

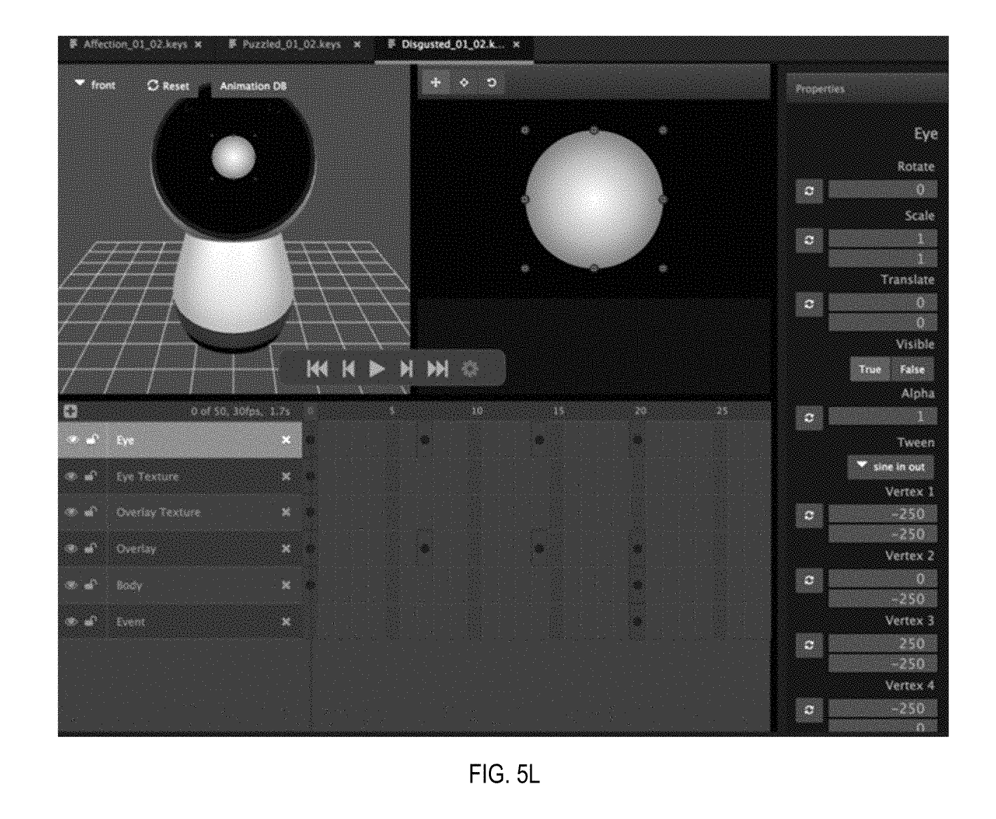

Referring to FIGS. 5A through 5L, there is depicted various user interface functions for authoring various EMSL language elements, MiMs, and the like to facilitate adjusting spoken words and combining them with animation of the social robot's display screen, moveable body segments, and other output features. The user interface facilitates creating various TTS associated language elements. It also supports adjusting a set of TTS sentences to be spoken by the social robot with manually adjusted durations for words, and the like. Additionally, it facilitates selecting portions of the spoken words and mapping social robot functions (display, movement, etc.) onto the selected portions. Types of animations may be selected and the user interface may adjust the types of animation based on various TTS rules described elsewhere herein. Aspects such as prosody may be adjusted for selected portions and the like.

A social robot may progress through one or more of a plurality of states that may reflect distinct thought or action processes that are intended to convey a sense of believability of the character portrayed by the social robot. The social robot may exhibit expression, such as via embodied speech as described herein for processes such as intent, anticipation, decision making, acting, reacting and appraisal/evaluation. Each process may be presented via a combination of auditory and visual elements, such as natural language speech, paralinguistic cues, display screen imagery, body segment movement or posing, lighting, non-speech sounds, and the like.

In an example, a social robot may be tasked with providing photographer services for an event, such as a wedding. In embodiments, such a task may be embodied as a skill that may be invoked as needed, such as based on detection of the start of an event. For a wedding the start of the event may be visual detection of entry of guests to a reception room, and the like.

In this photographer example, an intent process may be established as a set of goals to be achieved by the social robot during execution of the skill. The intent process may be expressed by a physical embodiment of the social robot through embodied speech that may include speech, paralinguistic clues, imagery, lighting, body segment movement and/or posing. The intent process may be expressed by a virtual (e.g. emulated) embodiment via a user interface of a computing device (e.g., a mobile smart-phone) through portions of embodied speech, such as through natural language speech, paralinguistic utterances, video and imagery, and the like. As an example, imagery on the display of a social robot may present a listing of photography targets along with a previously captured photo of each (if one is available) along with the social robot reporting its intention to take a good headshot of each of these attendees.

Goals, such as goals for a skill may be configured by a developer of the skill using a skill development platform, such as a social robot SDK or similar user interface as described herein and in related co-pending applications. Goals for this embodiment may be configured with conditional and/or variable elements that may be adjusted by the social robot based on its perception of its environment contemporaneously with the invocation of the skill. A goal may be to capture open-eyed photographs of members of the bride's and grooms immediate families. The social robot may determine, based on information gathered from various sources who and how many members of the families of the bride and groom will be attending. This may be based on, for example a data set to which the robot has access that may include a searchable invitation list and invitee responses thereto. Additionally, the social robot may have interacted with one or more of the family members and may have captured a photograph of them so that facial recognition may be applied by the social robot while performing the skill to achieve the goal.

An event, such as a wedding reception, likely would involve a highly dynamic environment, with people moving throughout the space. Therefore, merely progressing through a list of people to photograph may not be sufficient to achieve the goal. Therefore, the social robot may rely on its ability to redirect its attention from one target to another dynamically based on a set of criteria that is intended to allow the social robot to maintain a believable degree of interaction with a person while being aware of other activity and/or people who are close to the robot that may help it achieve its goals. As an example, the photographer skill may work cooperatively with an attention system of the social robot to use perception and recognition capabilities of the social robot to detect the presence of family members who have not yet been photographed. Once such presence is detected, the social robot may take an action, such as calling out to the detected family member to invite him/her to have his/her photograph taken. In this way the social robot may maintain an appropriate degree of interaction with a person, such as someone who the robot is photographing, while working within a highly dynamic environment to not only be aware of objects/actions/people in the environment, but how those things might contribute to achieving its goals as may be associated with an intent of a skill.

Continuing with the processes through which a social robot may convey believability of character, the social robot may express an anticipation process through embodied speech or portions thereof for physical robot and electronic device-based embodiments. In the wedding reception photographer example, the social robot may prepare for various scenarios and consider factors that may be present during execution of its photographer task. Expressing these considerations, such as by describing the factors in a socially communicative way, similar to a person talking through his/her anticipation. In an example, a social robot may check the weather for the date/time of the wedding and may express its anticipation that the day looks like it will be a good day for taking wedding photos. Another anticipation process that may benefit from the embodied speech capabilities is to interact with a human regarding the layout of the reception room. The robot may suggest one or more preferred positions in the room from which it can take photographs. By interacting with one or more humans during the evaluative anticipation process, the degree of believability of the social robot as a distinct character is enhanced.

An additional process in the list of exemplary processes during which the social root may convey believability through embodied speech may include a decision making process. The social robot may perform processing via a cognitive system that facilitates determining actions, priorities, query responses, and the like. Such a cognitive system may also provide an indication of a degree of complexity to each decision; this may be similar to determining if a decision is hard or easy. By configuring an active expression that is consistent with the determined degree of complexity, the social robot may provide a degree of believability during a decision making process. As an example, if a social robot cognitive system indicates that a decision being made is complex (e.g., it has a higher degree of uncertainty or the amount of data required for the decision is high or difficult to obtain, or the like) the social robot may use its embodied speech assets, such as screen display imagery, body movement and/or posing, natural language and paralinguistic expression and the like to reflect the complexity. Likewise the social robot's embodied speech assets may be used, although in a different way, to express a determination by the cognitive system that a decision is easy. Easy decisions may be those that do not involve a large number of variables, have fairly predictable outcomes, and the like.

As part of a process of intent, anticipation, decision making, acting, reacting and appraisal/evaluation, acting may be readily associated with some for of expression by the social robot that may be distinct from expressions of intent, anticipation, decision making and others. While not all actions to be performed by a social robot involve direct interaction with a person near the social robot, even those that involve, for example, communicating with other social robots (e.g., to make plans, check status and the like, updating a knowledge base, and the like) may be accompanied by forms of embodied speech. Sending and receiving information, messages, and the like may be accompanied by visual display images of objects being sent or received, paralinguistic sounds typically associated with such acts, and the like. For acts that involve interaction with humans near to the social robot, such as those associated with skills, such as a photographer skill, the use of embodied speech assets can substantively enhance the believability of the skill being performed. As an example, if the social robot is taking a photograph of a family member of the bridal party, the social robot may tell the family member who has been photographed and who is left to be photographed. The social robot may ask the family member to seek out those who have not been photographed as a way of working to achieve it's primary photographer goal.

Believability of character when performing an act, such as photography may also be exhibited through the use of the social robot's attention control system that ensures interaction with a person appears to be well focused while being aware of others in the area. As noted herein, a social robot attention system may facilitate believable interactions in a dynamic environment, such as by facilitating attempting to detect the identity of those proximal to the social robot and, based on parameters for achieving it's goals, divide its attention among two or more photography targets. In an example of dividing attention to achieve a goal, the social robot may provide a photographer service and direct assets needed to complete photographing a family member toward the member while directing other assets, such as natural language output toward a candidate family member. The social robot may say to the primary photography target “Let me check the quality of my photo, hold on a second” and then to call out to the secondary target, to get his/her attention, “Jack, don't go away I need to take your photo for the bride.”. The social robot may continue to divide attention without diverting substantively from the primary photography target, such as by maintaining orientation toward the primary photography target and/or presenting a proof of photographs on its display screen, and the like.

When performing an act, such as taking a photograph, the social robot may include facilities by which a remote user may control the robot's assets, such as by instructing the social robot to be oriented toward the bride. However, the social robot may, through it's ability to control how it devotes attention to different aspects that it senses in its environment may move attention from taking a photograph as directed by the remote user, to address it's internal priorities related to, for example, meeting the goals of the active photographer skill. In this way, the social robot may perform autonomously from the remote controlling user based on a variety factors, including, for example, its anticipation of time running out before achieving it's goal. Alternatively, the social robot may pay attention to the bride and those around her so as to capture moments of the event. These events may also be configured with the active instance of the photographer skill, thereby forming a portion of the goals to achieve.

Expression and embodied speech can also be exhibited related to completing an act, such as when a social robot is reacting to taking action. The social robot may utilize its perceptual sensing and understanding capabilities to implement a reaction that may be responsive to a result of taking an act or the like. In an example, a social robot may express emotion and the like while reacting to a stimulus, such as when sensing a physical and/or audio event that may be correlated to an act taken by the robot. Continuing in the photographer example, a social robot may detect that a person being photographed is moving when the shot is taken and may react to this finding through embodied speech, such as by adjusting its pose to indicate the subject should stay still, and using natural language to remind the person to stay still.

Another process for which believability may be enhanced through embodied speech may include appraisal and/or evaluation of an outcome of an act performed by the social robot. In an example, a social robot may analyze a photograph taken of a family member and note that the member's eyes are closed. Analytically, the social robot may determine that this outcome does not meet the criteria associated the goals of the active photographer skill. However, to attempt to convey believability of character, the social robot may use its embodied speech assets, such as body movement, image display, lighting, natural language, and paralinguistic output to indicate its dissatisfaction with the result. In this way the social robot can make an embodied speech expression that corresponds to the outcome of act. A positive outcome may include hoots of success and/or a display of fireworks.

A social robot may progress through one or more of these processes in parallel by utilizing its ability to provide attention to more than one goal at a time. In an example, the active instance of the photographer skill may involve a goal of photographing several people. The social robot may set this goal as a skill-specific intent; however, a sequence of determining an intent, working through anticipation based thereon, making a decision, performing an act, reacting thereto, and performing appraisal/evaluation may occur asynchronously for a plurality of photography subjects. As an example, a social robot may have an intention to photograph the father of the bride; anticipate an opportunity to do so based on the program for the wedding reception; decide to take the photograph when he is detected; begin the act and find that the father of the bride turns his attention away from the robot. The robot may continue to track the location and orientation of the father of the bride while also looking for other candidates to photograph. Upon finding one, the intent may change from photographing the father of the bride to photographing the best man. The sequence of processes, or any portion thereof may be performed by the social robot and communicated through embodied speech before returning to the earlier established intent of photographing the father of the bride. In this way, the social robot may set its own intent, goals, and take autonomous action within the scope of the skill-specific goals.

Because the social robot has an understanding of each photography target, the social robot can use that knowledge to orient itself toward each target appropriately without persistent instruction from a user. Likewise, this understanding enables the social robot to provide photography target-specific instructions, such as suggesting that a person take off their glasses for one or more of the shots, or provide instructions to a person being photographed to avoid shadows and the like.

A skill related to photography is video conferencing. Because a social robot can communicate, develop an understanding of its environment through use of its perception capabilities (e.g., video capture, audio capture and interpretation, audio-based subject location, and the like), and react through movement, orientation, and the like, it can act as an intelligent videoconference facilitator. IN addition to merely moving it's camera toward detected sounds (e.g., an attendee speaking), it can identify when more than one person is speaking and take an appropriate action, such as orienting toward each person, mediate, such as by asking the speaking attendees to take turns, and the like. Additionally, the social robot may use its ability to understand emotional content of a conversation to enhance an image of the remote party through movement, positioning, supplemental imagery, lighting effects and the like. In an example, a remote person with whom a person proximal to the social robot is video conferencing may be speaking with some degree of uncertainty or anxiety. The social robot may develop an understanding of this context of the remote person's expression and enhance this through movement that may reflect the remote person's emotional state. In a similar way, if an attendee is moving, such as walking, using a treadmill, or otherwise creating a potentially unstable image, the social robot may apply a combination of conventional image stabilization and reorientation of its camera to maintain a stable image for attendees watching on the display screen of the social robot.

As a videoconference facilitator, the social robot may also provide videoconference scheduling, reminder, and follow-up services. This may be possible because the social robot may communicate with potential attendees to gather their schedule, preferences, and the like. The social robot may use it's electronic communication capabilities to communicate with the potential attendees via, for example, an emulated version of the social robot executing on an electronic computing device of the attendee, such as the attendee's mobile phone and the like. In this way, the social robot can directly communicate with each attendee through personalized interactions. This may be performed in association with a calendar capability of the social robot.

Another social robot skill that may be similar to a photographer skill is a home/facility monitoring skill. The social robot may employ aspects of embodied speech when performing a home monitoring skill, including emotively expressing via embodied speech during processes such as establishing intent or goal setting, anticipation or preparation, decision-making, acting, reacting, and appraisal/evaluation. In addition to being equipped to strive for believability of character when performing a home monitoring skill, resources of the social robot, such as an attention system that facilitates maintain attention while enabling switching attention within a dynamic environment further contribute to believability of a social robot character by facilitating naturally redirecting attention for events, activity, and the like that may fulfill one or more goals associated with home monitoring.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

TABLE 1
Paralinguistic emotive states, socio-communicative intents and cognitive
perceptual states.

| Paralinguistic | | Quality of human | Quality of non- | |
|---|---|---|---|---|
| Class | Intent/State | prosodic inspiration | human inspiration | Example |
| Emotive State | | | | All emotive sounds should |
| | | | | have variations on a |
| | | | | theme . . . |
| 1 | Interested/ | Ooooh | quiet rising, | engaging sound . . . paying |
| | Curious/ | Ahhh | bubbling tones | attention, leaning in. |
| | Engaged/ | Cool! | | positive valence |
| | Desire/ | | | aroused |
| | Approval | | | open/exploratory |
| 2 | Excited/ | | rapid bubbly tones | e.g., the social robot has |
| | Playful | | | something to share he |
| | | | | thinks you'll really like. |
| | | | | People are reving the |
| | | | | social robot up (like how |
| | | | | we get our pets revved up) |
| | | | | positive valence |
| | | | | High arousal |
| 3 | Worried/ | <whimper-sad> | worried sounds. | E.g., when the social robot |
| | Insecure/ | <oops> | Like R2 when on | makes a mistake, like mis- |
| | Embarrassed/ | <un oh> | Tatooine just before | ID'ing someone. He loses |
| | unconfident | | the Jawas get him | confidence . . . |
| | | | | Negative valence |
| | | | | Withdrawing/timid/meek |
| 4 | Confident/ | Yay! | rapid, ascending | E.g., when the social robot |
| | Exclamation/ | Woo hoo | and descending | has done something |
| | Proud | | tones | successfully and pleases |
| | Celebration | | | his Crew. |
| | | | | Proud. Action oriented. |
| | | | | Uptake . . .I'm on it. |
| 5 | Overwhelm/ | <whimper-anxious> | | E.g., the social robot is |
| | Fear | | | really confused . . . Too |
| | | | | much input happening too |
| | | | | fast. Trying to understand |
| | | | | with too many people |
| | | | | 6connpeting for his |
| | | | | attention. High state of |
| | | | | lack of confidence. Needs |
| | | | | things to calm down so he |
| | | | | can “grasp” things again. |
| 6 | Sadness/ | <slow sad whimper> | | low whimper/howl like from |
| | Lonely/ | <sigh> | | a puppy. |
| | bored/ | | | Lack of interaction. Entices |
| | yearning | | | people to pay attention to |
| | | | | him in a sympathetic way |
| | | | | People frustrated with him, |
| | | | | he feels bad . . . |
| 7 | Joyful/ | | bubbly musical | Anything that would make |
| | Enjoynnent/Celebration | | sounds. Ascending | the social robot happy. |
| | | | melody, etc. | Having fun. Celebration. |
| | | | | Family's favorite team |
| | | | | wins. A birthday. Positive |
| | | | | events. Getting praised in |
| | | | | a higher arousal way. |
| | | | | Positive valence |
| | | | | High arousal |
| 8 | Frustration/ | Shizbit | Growl-y | He is trying to do |
| | Annoyance/ | Grumble | Pbbbttt. | something and is getting |
| | Fail/ | Grrrr. | | messed up. Can't |
| | Stuck/ | yech! | | complete his goal . . . |
| | Disapproval. | eeewww | | something preventing him. |
| | | | | Getting teased |
| | | | | Reaction to hearing Siri or |
| | | | | Alexa mentioned. |
| 9 | Pleasure/ | Mmmmmm | Dove coo | contentment |
| | Affection/ | cooing | Cat purr | [Bilss] |
| | Delight | | warmth. Based on | People showing him |
| | | | dove coos . . . | affection, in a soothing |
| | | | something not | way. Sound he makes |
| | | | human that we | when receiving affection |
| | | | recognize as warm, | from family. |
| | | | organic, comforting, | e.g., without explicitly |
| | | | affectionate, | saying it . . . it conveys “I |
| | | | satisfying . . . | love you too” Might |
| | | | | happen when his head is |
| | | | | being stroked. Warmth |
| | | | | and sweetness directed to |
| | | | | the user. |
| 10 | Confused/ | Wha! | | |
| | Unexpected/ | | | |
| | Surprise | | | |
| | (negative) | | | |
| 11 | Surprised/ | whoa! | | e.g. favorite sports team |
| | awe | Wow! | | does something amazing |
| | (positive) | | | but unexpected (beats a |
| | | | | team that was expected to |
| | | | | win . . .) |
| | | | | e.g., You make a cake |
| | | | | with the social robot and |
| | | | | you show it to him when |
| | | | | you're done and |
| | | | | ask . . .“Here's our cake! |
| | | | | what do you think?” |
| 12 | Laughter | variations based on | | “the social robot, i'll tell |
| | | human laughter | | you a joke” “the social |
| | | <giggle> | | robot: ok” “the social robot, |
| | | | | when do you see the |
| | | | | dentist?” “I dont know.” |
| | | | | “Me: tooth-hurty!” |
| | | | | <laughter> |
| Socio- | | | | |
| Commuicative | | | | |
| Intents | | | | |
| 13 | No/ | eh eh | | like when shaking your |
| | Disagree | Nah Nah | | head now . . . |
| | | | | Said like Steve Jobs said it |
| | | | | during the iPhone launch |
| | | | | presentation “We're gonna |
| | | | | use a stylus . . . |
| | | | | No. No. Who wants a |
| | | | | stylus? |
| | | | | You have to get em and |
| | | | | put em away, and you lose |
| | | | | em. Yuck” |
| 14 | Yes/ | Uh huh | | |
| | agree | | | |
| 15 | Question/ | Hmmmh? | | Tonally rising sound . . . The |
| | Prompt for input/ | | | sound you make and cock |
| | Asking | | | your head to the side |
| | confirmation | | | “Is that what you want” |
| | | | | “what did you mean? |
| | | | | E.g., you ask the social |
| | | | | robot to do something and |
| | | | | he just doesn't get it. |
| 16 | Paying Attention | | Quick affirming | This is the sound the |
| | | | sound (like in video) | social robot makes when |
| | | | | you say “Hey the social |
| | | | | robot” or you tap him on |
| | | | | his head so that you know |
| | | | | you have his attention and |
| | | | | he is actively listening to |
| | | | | you. |
| 17 | Attentional Bid | | whistle | This is the sound the |
| | | | | social robot makes when |
| | | | | he is trying to get your |
| | | | | attention. Like the |
| | | | | whistling sound we make |
| | | | | to get someone's |
| | | | | attention. |
| 18 | Compliment | “Ooh la la!” | | Flirty in a friendly way |
| | | | | the social robot, how do I |
| | | | | look today? |
| | | | | Fantastic Mr Fox. <wink> |
| | | | | You're looking great today! |
| 19 | Apology/ | I'm sorry | | Made mistake. Got |
| | My Bad. | My bad. | | something wrong. |
| | | | | Feels a little badly about it. |
| 20 | Decline | | 2 tone bonk | I'm afraid I can't do that . . . |
| | | | | you don't have permission |
| 21 | urgent/ | | alarm | I have a urgent alert that |
| | Alert/ | | | really needs attention now |
| | Emergency | | | |
| 22 | Excuse me | Excuse me . . . | | Polite interruption. Trying |
| | | | | to get person's attention |
| | | | | Prosody and phoneme |
| | | | | should be clear what |
| | | | | meaning is. |
| 23 | I need help | Uhm . . .? | | Kid in class who's raised |
| | | <requesting | | his hand, really not sure |
| | | whimper> | | what's going on. |
| 24 | Backchannel/I | Mmm hmm. | | Those sounds we make to |
| | understand you/ | | | indicate we are following |
| | am following | | | what is being said. |
| | what you are | | | |
| | saying | | | |
| 25 | wink | | >wink< | Just kidding |
| | | | | the social robot, you're my |
| | | | | favorite robot! (the social |
| | | | | robot: and you're my |
| | | | | favorite human! <sound>) |
| 26 | I have something | | Musical notes . . . | Something you don't |
| | for you. | | playful | expect that the social robot |
| | (subdued alert) | | | is excited to share with |
| | | | | you . . .maybe a song he |
| | | | | wants to recommended, |
| | | | | some sports news he |
| | | | | thinks you'll be happy to |
| | | | | hear . . . |
| Cognitive/ | | | | |
| Perceptual | | | | |
| states | | | | |
| 27 | Face Detected/ | | | short, quick affirming |
| | Sound heard/ | | | sound to acknowledge he |
| | I know people | | | first sees you or is aware |
| | are around. | | | that people are in the |
| | | | | room, but you are too far |
| | | | | away. Or first hears |
| | | | | sounds but haven't said |
| | | | | “hey the social robot” for |
| | | | | him to know who you are. |
| | | | | Signals to person you are |
| | | | | out of range for ID but the |
| | | | | social robot is aware of |
| | | | | your presence. |
| 28 | Face | | | short, quick affirming |
| | Recognized/ | | | sound. |
| | Voice ID/ | | | Sound the social robot |
| | I know who you | | | makes when he thinks you |
| | are | | | are familiar. Could be from |
| | | | | face ID or voice ID |
| 29 | Face | | | short sound a bit like a |
| | Unrecognized/ | | | “don't know” that the |
| | No Voice ID/ | | | social robot makes when |
| | I don't know you | | | he thinks you are |
| | | | | unfamiliar based either on |
| | | | | Face ID or voice ID. |
| 30 | Poor Lighting/ | | Frustrated sounds | short, quick. Negative |
| | Hard time | | | connotation tone. |
| | seeing/ | | | As if you were trying to |
| | Backlight scene | | | make something out and |
| | | | | can't quite see it . . . |
| 31 | Noisy sound | | Frustrated sounds | Noisy room. Hard time |
| | environment/ | | with white noise | understanding what you |
| | Hard time | | layered in. | are saying |
| | listening | | | |
| 32 | Thinking/ | | Soft the social | Sounds he makes that |
| | Processing | | robotese talking to | might be equivalent to |
| | | | himself sorts of | “spinning disk” |
| | | | sounds | |
| 33 | waiting | doo de doo . . . | | waiting for a response. |
| | | | | the sound of a elipsis . . . |
| 34 | Stuck/ | Ugh. | | Tried to do a task . . . taking |
| | Time out/ | <Sigh> | | to long . . . time out. |
| | Give up/ | Err- | | Disappointment |
| | Can't do it now | | | the social robot's both a |
| | | | | little disappointed and a |
| | | | | little annoyed that he can't |
| | | | | carry out your request. We |
| | | | | need to hear a little bit (but |
| | | | | not too much) of that |
| | | | | impatience in his voice. |
| 35 | Success/ | | | Sound the social robot |
| | Done/ | | | makes when he has |
| | Got answer | | | successfully done what |
| | | | | you ask |
| 36 | Fail. | | Record scratch | the social robot Failed on |
| | | | | request. Could not retrieve |
| | | | | information, etc. |
| | | | | Can't do that yet. Not in |
| | | | | my skills. |
| 37 | I don't | | Single tone bonk | Probably some sort of |
| | understand you | | | “bonk” sound that we |
| | at all | | | associate with “failed to |
| | | | | understand” |
| 38 | I kinda | can you repeat | | the social robot partially |
| | understand you, | that? | | understood you but wants |
| | | | | you to repeat to make |
| | | | | sure. |
| 39 | Acknowledge/ | OK! | | Sound he makes after |
| | Confirm | | | you've made a request of |
| | | | | the social robot and he's |
| | | | | on it. |
| 40 | Issue Resolved | A ha! | Finger snap | the social robot was not |
| | | Gotcha! | | understanding, but now he |
| | | | | gets what you want. |
| | | | | “Oh, now I understand” |

TABLE 2
Social robot character-specific and OOBE specific sounds
These are distinct sounds that pertain to various characters of the social robot during the
OOBE. the social robot will process these in different ways to add variation and spontaneity.

| Paralinguistic | | Quality of human | Quality of non- | |
|---|---|---|---|---|
| Class | Intent/State | prosodic inspiration | human inspiration | Example |
| OOBE | | | | |
| 41 | Coming to life: | | angelic tone | when the social robot first |
| | First time on | | | gets awareness |
| 42 | First connection | | | “gaining awareness” data |
| | to wifi | | | coming . . . |
| 43 | First awareness | | | Am I here? Are you my |
| | | | | family? |
| 44 | Training sample | | | Sound the social robot |
| | success | | | makes when receives |
| | | | | each training instance |
| | | | | successfully |
| 45 | Finished training | | | sound the social robot |
| | | | | makes when learned your |
| | | | | face or voice ID |
| Character | | | | |
| 46 | Tired/going to | yawn | the serenity of | e.g., Precursor to going to |
| | sleep | | going to sleep, | sleep due to lack of activity |
| | | | warm outdoor | over an extended period |
| | | | weather. | (conditions leading the |
| | | | | social robot to go into |
| | | | | sleep mode) |
| 47 | Waking up | | the sound of | |
| | | | sunrise | |
| 48 | dreanning/sleeping | | | the social robot sleeping, |
| | | | | very quiet. Maybe a soft |
| | | | | buzz/breathing/snoring |
| | | | | sound played for a limited |
| | | | | time before goes quiet. |
| | | | | Then maybe pulsing LED |
| | | | | ring shows “sleep” |
| 49 | Greeting | Hello! | | Prosody recognized with |
| | | | | “hello” or “Hi ya!”. Griffin |
| | | | | should record a set. |
| 50 | Farewell | Good Bye! | | Prosody recognized with |
| | | | | “Good Bye” or “Bye!”. |
| | | | | Griffin should record a set. |
| 51 | Busy . . . | humming to self | | sounds the social robot |
| | | | | makes when self |
| | | | | occupied. Griffin should |
| | | | | record a set of these |
| 52 | Timer | | start | Timer and Stopwatch |
| | Stopwatch | | end | related sounds. |
| | Clock/set alarm | | alarm | Consumers have |
| | | | | expectations for these |
| | | | | sounds. |
| 53 | Paralinguistic | Vocals | micro-melodies | These are played when |
| | “conversations” | Other natural | technological | the social robot talks to |
| | | sounds | sounds | another the social robot. |
| | | | | We need a core set of |
| | | | | sounds and rules by which |
| | | | | we procedurally combine |
| | | | | and filter them so they |
| | | | | sound like the social |
| | | | | robot's native tongue. |

TABLE 3
Device-Level Paralinguistics
These sounds may be tied to the device at a low-level hardware or software state. Consumers
have expectations on what such sounds correspond to, and they are separate from specific
“paralinguistics” that may be skill specific. These sounds generally attempt to make sense to
people given their expectations with other devices and what device-like sounds often mean.

| Paralinguistic | | Quality of human | Quality of non- | |
|---|---|---|---|---|
| Class | Intent/State | prosodic inspiration | human inspiration | Example |
| Hardware/ | | | | |
| Software/ | | | | |
| Device Status | | | | |
| 54 | Power Down | | | self explanatory. One |
| | | | | sound |
| 55 | Power Up | | | self explanatory. One |
| | | | | sound |
| 56 | Update Initiated | | | self explanatory. One |
| | | | | sound |
| 57 | Update Finished | | | self explanatory. One |
| | | | | sound |
| 58 | Launch Skill | | | self explanatory. One |
| | | | | sound |
| 59 | Exit Skill | | | self explanatory. One |
| | | | | sound |
| 60 | Failure to | | | self explanatory. One |
| | complete | | | sound |
| 61 | Time out | | | self explanatory. One |
| | | | | sound |
| 62 | Can't fulfill on | | | self explanatory. One |
| | request now . . . | | | sound |
| | yet | | | |
| 63 | Volume Level | | Tone at current | self explanatory. One |
| | | | volume level | sound |
| 64 | Set Volume | | turning Volume up | self explanatory. One |
| | | | sound | sound |
| | | | turning Volume | |
| | | | down sound | |
| 65 | Low Battery | | | self explanatory. One |
| | | | | sound |
| 66 | Battery charged | | | self explanatory. One |
| | | | | sound |
| 67 | Alert | | | self explanatory. One |
| | | | | sound |
| 68 | Memory Full | | | self explanatory. One |
| | | | | sound |
| 69 | WiFi Disconnect | | | My brain is |
| | | | | disconnected . . . |
| | | | | One sound |
| 70 | Searching for | | | I feel lost. and I also can't |
| | WiFi | | | listen to anything you're |
| | | | | saying |
| | | | | One sound |
| 71 | WiFi Low | | | self explanatory. One |
| | | | | sound |
| 72 | WiFi reconnect | | | self explanatory. One |
| | | | | sound |
| 73 | Rear hatch door | | | self explanatory. One |
| | open | | | sound |
| 74 | Unplugged | | | switch power source to |
| | | | | battery |
| | | | | self explanatory. One |
| | | | | sound |
| 75 | Plugged in | | | switch power source to AC |
| | | | | self explanatory. One |
| | | | | sound |
| 76 | Toggle | | | self explanatory. One |
| | | | | sound |
| 77 | Present options | | | the social robot shows list, |
| | on screen to user | | | menu on screen, photos, |
| | | | | etc. |
| | | | | One sound |
| 78 | Select option | | | User makes selection |
| | | | | (touch or to confirm voice |
| | | | | selection) |
| | | | | One sound |
| 79 | save something | | | self explanatory. One |
| | to memory | | | sound |
| 80 | send something | | | self explanatory. One |
| | off the social | | | sound |
| | robot | | | |
| 81 | post something | | | self explanatory. One |
| | from the social | | | sound |
| | robot to | | | |
| | somewhere else | | | |
| 82 | delete something | | trash | self explanatory. One |
| | | | | sound |
| 83 | Passcode correct | | | entered pin correctly |
| | | | | self explanatory. One |
| | | | | sound |
| 84 | Passcode | | | entered pin correctly |
| | incorrect | | | self explanatory. One |
| | | | | sound |

TABLE 4
Comprehensive Table of Paralinguistic Intents

| Paralinguistic | | Quality of human | Quality of non- | |
|---|---|---|---|---|
| Class | Intent/State | prosodic inspiration | human inspiration | Example |
| Emotive State | | | | All emotive sounds should |
| | | | | have variations on a |
| | | | | theme . . . |
| | Disengaged | | quiet descending | disengaging sound . . . |
| | | | tones | leaning back, low |
| | | | | confidence. |
| | Interested | | quiet rising, | engaging sound . . . paying |
| | | | bubbling tones | attention, leaning in. |
| | Tired | yawn | | e.g., low battery level. |
| | | | | Precursor to going to |
| | | | | sleep due to lack of activity |
| | | | | over an extended period |
| | | | | (conditions leading the |
| | | | | social robot to go into |
| | | | | sleep mode) |
| | Excited | | rapid bubbly tones | e.g., the social robot has |
| | | | | something to share he |
| | | | | thinks you'll really like. |
| | | | | People are reving the |
| | | | | social robot up (like how |
| | | | | we get our pets revved up) |
| | Insecure | <whimper-sad> | worried sounds. | E.g., when the social robot |
| | | | Like R2 when on | makes a mistake, like mis- |
| | | | Tatooine just before | ID'ing someone. He loses |
| | | | the Jawas get him | confidence . . . |
| | Confident | | rapid, ascending | E.g., when the social robot |
| | | | and descending | has done something |
| | | | tones | successfully and pleases |
| | | | | his Crew. |
| | Fear | <whimper-anxious> | | E.g., the social robot is |
| | | | | really confused . . . sensors |
| | | | | not working. High state of |
| | | | | lack of confidence. Needs |
| | | | | things to calm down so he |
| | | | | can “grasp” things again. |
| | Enjoyment | | smoother, longer | I'm having fun! |
| | | | more musica | Me: lets play again! the |
| | | | bubbly tones | social robot: sound |
| | Sadness | <slow sad whimper> | | low whimper/howl like from |
| | | | | a puppy. People frustrated |
| | | | | with him, he feels bad . . . |
| | Joy | | bubbly musical | Anything that would make |
| | | | sounds | the social robot happy. |
| | | | | Celebration. Family's |
| | | | | favorite team wins. A |
| | | | | birthday. Positive events. |
| | | | | Getting praised in a higher |
| | | | | arousal way. |
| | Frustration | shizbit | | He is trying to do |
| | | | | something and is getting |
| | | | | messed up. |
| | lonely | <slow sad whimper | | Lack of interaction for an |
| | | with sighing | | extended time. Mixed with |
| | | sounds> | | sorrow. |
| | Annoyance | grumble | | the social robot getting |
| | | grrr | | teased . . . mention of “rival” |
| | | | | like Alexa or Siri . . . |
| | Pleasure | mmmmmm | | contentment |
| | | | | [Bilss] |
| | | | | People showing him |
| | | | | affection, in a soothign |
| | | | | way. |
| | Disapproval/ | eh eh | | like when shaking your |
| | dislike | yech! | | head now . . . |
| | | | | Said like Steve Jobs said it |
| | | | | during the iPhone launch |
| | | | | presentation “We're gonna |
| | | | | use a stylus . . . |
| | | | | No. No. Who wants a |
| | | | | stylus? |
| | | | | You have to get em and |
| | | | | put em away, and you lose |
| | | | | em. Yuck” |
| | Approval/ | aaaaah | | e.g., the social robot is |
| | like | | | playing a new song that he |
| | | | | really likes . . . |
| | Disgust | ewwwww | | Probably very similar |
| | | ick | | context to |
| | | Yuk. | | Disapproval/dislike. |
| | Desire/ | ooooohh | | E.g, you get the social |
| | Delight | | | robot a present, some |
| | | | | swag, and he wants it . . . |
| | | | | You ask the social robot if |
| | | | | he wants a new skill . . . he |
| | | | | wants it. |
| | Suprised- | wha! | | e.g., something happens |
| | negative | | | that he did |
| | Surprised- | whoa! | | e.g. favorite sports team |
| | positive | | | does something amazing |
| | | | | but unexpected (beats a |
| | | | | team that was expected to |
| | | | | win . . . ) |
| | awe | wow! | | e.g., You make a cake |
| | | oooo! | | with the social robot and |
| | | | | you show it to him when |
| | | | | you're done and |
| | | | | ask . . . “Here's our cake! |
| | | | | what do you think?” |
| | Affection | cooing | warmth. Based on | e.g., without explicitly |
| | | | dove coos . . . | saying it . . . it conveys “I |
| | | | something not | love you too” Might |
| | | | human that we | happen when his head is |
| | | | recognize as warm, | being stroked. Warmth |
| | | | organic, comforting, | and sweetness directed to |
| | | | affectionate, | the user. |
| | | | satisfying . . . | |
| | Receiving praise: | | | Soaking it in: Sound the |
| | calming | | | social robot makes when |
| | | | | being stroked. |
| | Receiving praise: | | | Playful . . . the sound the |
| | excitable | | | social robot makes to high |
| | | | | energy praise like when |
| | | | | people psych up their dog |
| | | | | saying “Who's a good boy, |
| | | | | who's a good boy!” |
| | Exclamation | | [exclamation point] | emphasis to the end of a |
| | | | | TTS phrase |
| | | | | “And that's how you do it” |
| | | | | “!” |
| | Question | | [question mark] | questioning tone at the |
| | | | | end of a TTS phrase |
| | | | | “Is that what you want” “?” |
| | Confused | Hmmmh? | | Tonally rising sound . . . The |
| | | | | sound you make and cock |
| | | | | your head to the side |
| | | | | E.g., you ask the social |
| | | | | robot to do something and |
| | | | | he just doesn't get it. |
| | Boredom | <long sigh> | | E.g., the social robot |
| | | | | awake but no one has |
| | | | | talked to him in a while. |
| | Curious | oooooh | | Engaged sound |
| | | hmmmmm | | E.g, you share something |
| | | | | with the social robot . . . like |
| | | | | a message from |
| | | | | Grandma . . . “the social |
| | | | | robot, grandma left a |
| | | | | message, lets see what it |
| | | | | is” |
| | Embarrassed | <oops> | | E.g, the social robot did |
| | | <un oh> | | something wrong and you |
| | | | | say “No the social robot, I |
| | | | | wanted x” |
| | Proud/ | | Angelic tone . . . chest | Happy he made family |
| | Satisfied | | swells and angelic | happy with his helpfulness. |
| | | | warm light is cast | Might happen when the |
| | | | | head is stroked, or |
| | | | | someone says “Thanks |
| | | | | the social robot” |
| | Celebration | | triumphant sounds | sounds Any situation worth |
| | | | | celebrating |
| | | | | E.g., Favorite team wins. |
| | | | | Someone's birthday today, |
| | | | | etc. Finally a sunny day. |
| | Laughter | variations based on | | “the social robot, i'll tell |
| | | human laughter | | you a joke” “the social |
| | | | | robot: ok” “the social robot, |
| | | | | when do you see the |
| | | | | dentist?” “I dont know.” |
| | | | | “Me: tooth-hurty!” |
| | | | | <laughter> |
| Physical/ | | | | |
| Hardware/ | | | | |
| Software Status | | | | |
| | Power Down | | | self explanatory. One |
| | | | | sound |
| | Power Up | | | self explanatory. One |
| | | | | sound |
| | Update Initiated | | | self explanatory. One |
| | | | | sound |
| | Update Finished | | | self explanatory. One |
| | | | | sound |
| | Launch Skill | | | self explanatory. One |
| | | | | sound |
| | Exit Skill | | | self explanatory. One |
| | | | | sound |
| | Failure to | | | self explanatory. One |
| | complete | | | sound |
| | Time out | | | self explanatory. One |
| | | | | sound |
| | Can't fulfill on | | | self explanatory. One |
| | request now . . . | | | sound |
| | yet | | | |
| | Volume Level | | Tone at current | self explanatory. One |
| | | | volume level | sound |
| | Set Volume | | turning Volume up | self explanatory. One |
| | | | sound | sound |
| | | | turning Volume | |
| | | | down sound | |
| | Low Battery | | | self explanatory. One |
| | | | | sound |
| | Battery charged | | | self explanatory. One |
| | | | | sound |
| | Alert | | | self explanatory. One |
| | | | | sound |
| | Memory Full | | | self explanatory. One |
| | | | | sound |
| | WiFi Disconnect | | | My brain is |
| | | | | disconnected . . . |
| | | | | One sound |
| | Searching for | | | I feel lost. and I also can't |
| | WiFi | | | listen to anything you're |
| | | | | saying |
| | | | | One sound |
| | WiFi Low | | | self explanatory. One |
| | | | | sound |
| | WiFi reconnect | | | self explanatory. One |
| | | | | sound |
| | Rear hatch door | | | self explanatory. One |
| | open | | | sound |
| | Unplugged | | | switch power source to |
| | | | | battery |
| | | | | self explanatory. One |
| | | | | sound |
| | Plugged in | | | switch power source to AC |
| | | | | self explanatory. One |
| | | | | sound |
| | Toggle | | | self explanatory. One |
| | | | | sound |
| | Present options | | | the social robot shows list, |
| | on screen to user | | | menu on screen, photos, |
| | | | | etc. |
| | | | | One sound |
| | Select option | | | User makes selection |
| | | | | (touch or to confirm voice |
| | | | | selection) |
| | | | | One sound |
| | save something | | | self explanatory. One |
| | to memory | | | sound |
| | send something | | | self explanatory. One |
| | off the social | | | sound |
| | robot | | | |
| | post something | | | self explanatory. One |
| | from the social | | | sound |
| | robot to | | | |
| | somewhere else | | | |
| | delete something | | trash | self explanatory. One |
| | | | | sound |
| | Passcode correct | | | entered pin correctly |
| | | | | self explanatory. One |
| | | | | sound |
| | Passcode | | | entered pin correctly |
| | incorrect | | | self explanatory. One |
| | | | | sound |
| Social- | | | | |
| Communicative | | | | |
| (paralinguistic & | | | | |
| prosodic) | | | | |
| | Compliment | Ooh la la! | | Flirty in a friendly way |
| | You're looking | | | the social robot, how do I |
| | great today! | | | look today? |
| | Apology | I'm sorry | | “Wish I knew what you |
| | | | | meant” and asking the |
| | | | | user to try again |
| | Apology | failed First attempt | | Sorry that he didn't get |
| | | | | something right (like the |
| | | | | first time he makes a |
| | | | | mistake recognizing you) |
| | Apology | failed second | | sorry the he's still having |
| | | attempt | | problems . . . didn't recognize |
| | | | | you again . . . |
| | Apology: | “Ok . . . ” said like “i | | at the end of failing a few |
| | Sorry about the | guess so.” | | times the users says |
| | situation - | because he doesn't | | “forget it” when they are |
| | perhaps you said | want the user to feel | | frustrated |
| | “forget it” after | bad. An audio | | |
| | making a few | shoulder shrug - | | |
| | attempts. This | something that | | |
| | needs to be | makes it impossible | | |
| | subtle and not an | for the user not to | | |
| | admission of | melt and keeps them | | |
| | guilt. | from staying angry. | | |
| | | The kind of sorry to | | |
| | | make some to be | | |
| | | forgiving. | | |
| | Apology | Analog: I'm sorry. | | Feels a little badly about it. |
| | admit to mistake/ | other: trombone | | |
| | I'm sorry/my bad | waa | | |
| | | waaa waaaah (see | | |
| | | sample) | | |
| | Decline | | | I'm afraid I can't do that . . . |
| | | | | you don't have permission |
| | Not again . . . | | | sense of dread . . . |
| | | | | the social robot: I'm low on |
| | | | | battery power . . . ugh |
| | Remark | Hey! You'll never | | the social robot sees a |
| | | guess this but . . . | | person (mary) he hasn't |
| | | | | seen in a while. A family |
| | | | | member who is seen all |
| | | | | the time comes home, and |
| | | | | the social robot indicates |
| | | | | “guess what! Mary is |
| | | | | home”! |
| | Agree | For real! | | “the social robot, I wish |
| | | | | you would never leave me” |
| | | | | <sound> |
| | Agree | Me too! | | “the social robot, I wish I |
| | | | | had a million dollars” |
| | | | | <sound> |
| | Emphatic Agree | OH yeah [baby.] | Heralding! | the social robot, are you a |
| | | | | robot? sound or the social |
| | | | | robot, can you take a |
| | | | | picture of me? |
| | Accomplishment | Ta da! | | the social robot proud of |
| | Present with | | | something he did. |
| | pride | | | |
| | Confirmation | Are you sure? | | “the social robot, I wish I |
| | | | | had a giant horse!” |
| | | | | <sound> |
| | I've missed you | | | Eg. sound reminiscent of |
| | | | | dog wagging his tail after |
| | | | | you've been gone all day |
| | | | | at work . . . |
| | Disagree | Shizzbit. | | I'm hearing Robin Williams |
| | | | | here as Mork. It's a very |
| | | | | short, middle European |
| | | | | declination of approval. |
| | | | | Not dismissive, but leaving |
| | | | | no room open for |
| | | | | negotiation. the social |
| | | | | robot just disagrees. |
| | No | Nah Uh | | Minion-esque, perhaps. |
| | | The sound we make | | Prosody and phonemes |
| | | | | readily understood . . . |
| | Yes | Mmm hmm | | Minion-esque, perhaps. |
| | | The sound we make | | Prosody and phonemes |
| | | | | readily understood . . . |
| | Urgent | | | I have a urgent alert that |
| | | | | really needs attention now |
| | Uptake/I'm on it | | | conveys confidence, |
| | | | | taking action. |
| | Waiting | | | the social robot: “I have a |
| | Holding pattern | | | new message for . . . oh. |
| | | | | you're just passing |
| | | | | through. I guess you |
| | | | | *don't* want the message. |
| | | | | That's cool. I'll just sit here |
| | | | | by myself.” |
| | Waiting | | | Well? I'm *waiting* for you |
| | for user response | | | still haven't received the |
| | | | | answer I need |
| | Excuse me | | | Steve Martin |
| | (sassy) | | | He offers to be helpful and |
| | | | | then you dont want his |
| | | | | help |
| | Excuse me | Excuse me . . . | | Polite version. Prosody |
| | (Polite | | | and phoneme should be |
| | interruption) | | | clear what meaning is. |
| | Emergency | | alarm | to be used for an actual |
| | | | | emergency like a tornado |
| | | | | warning |
| | Praising | | | Proud and encouraging |
| | someone else | | | Great job! Right on! Good |
| | | | | work! Well done! You did |
| | | | | it! |
| | | | | the social robot to a kid: |
| | | | | “Let me check your |
| | | | | answers . . . perfect score!” |
| | Let's try again | | | encouraging to improve |
| | | | | Let's work together |
| | | | | because i think you're |
| | | | | going to get it on the next |
| | | | | round. |
| | Can you repeat | | | Could you say that again |
| | that? | | | please? |
| | | | | I *think* i'll get it with |
| | | | | another try! |
| | I'm stuck | Uh- | | Looking at the thing he |
| | | | | doesn't know what to do |
| | | | | with. |
| | I need help | Uhm . . . ? | | Kid in class who's raised |
| | | | | his hand, really not sure |
| | | | | what's going on. |
| | I failed to | | | Probably some sort of |
| | understand you | | | “bonk” sound that we |
| | | | | associate with “failed to |
| | | | | understand” |
| | Waiting for | | | prompting, questioning |
| | response from | | | sound . . . clear from |
| | you/yielding the | | | prosody that he's |
| | floor | | | prompted you. |
| | Initiating | ummm . . . | | Clear that the social robot |
| | response for | | | is taking action . . . he “has |
| | you/holding the | | | the floor” and will |
| | floor | | | respond . . . |
| | Backchannel/I | Mmm hmm. | | Those sounds we make to |
| | understand you/ | | | indicate we are following |
| | am following | | | what is being said. |
| | what you are | | | |
| | saying | | | |
| | I don't know | I dunno | record scratch | “hey, when will it snow |
| | | | | next?” sound plays |
| | Don't worry | | | the social robot has it |
| | about it. | | | covered. “the social robot I |
| | | | | meant to download an |
| | | | | update for you but I |
| | | | | forgot!” |
| | wink | | >wink< | the social robot, you're my |
| | | | | favorite robot! (the social |
| | | | | robot: and you're my |
| | | | | favorite human! <sound>) |
| | Halt! | Woah ! | | stay there! Don't move! |
| | | | | Let's play the freeze- |
| | | | | game! the social robot: Ok, |
| | | | | i'll play the music and then |
| | | | | you'll stop when I tell you |
| | | | | to. <Music . . . > <Sound>! |
| | I have something | | | Something you don't |
| | for you | | | expect that the social robot |
| | | | | is excited to share with |
| | | | | you . . . maybe a song he |
| | | | | wants to recommended, |
| | | | | some sports news he |
| | | | | thinks you'll be happy to |
| | | | | hear . . . |
| Cognitive State | | | | |
| | Face Detected | | | short, quick affirming |
| | | | | sound. |
| | Face Recognized | | | short, quick affirming |
| | | | | sound. |
| | | | | Sound the social robot |
| | | | | makes when he thinks you |
| | | | | are familiar |
| | Face | | | shot Sound.sound a bit |
| | Unrecognized/I | | | like a “don't know” |
| | don't know you | | | the social robot makes |
| | | | | when he thinks you are |
| | | | | unfamiliar |
| | Poor | Oo! Uuhhh . . . | | short, quick. Negative |
| | Lighting/Hard | | | connotation tone. |
| | time seeing | | | As if you were trying to |
| | | | | make something out and |
| | | | | can't quite see it . . . |
| | Can't see | | | short, quick. Negative |
| | | | | connotation tone. |
| | | | | Darkness: Lack of vision |
| | | | | awareness. |
| | Noisy sound | | | Noisy room.Hard time |
| | environment | | | understandign what you |
| | | | | are saying |
| | Tap on head | | | Feel touch, Quick sign of |
| | | | | tactile awareness |
| | Waiting | | | |
| | a-ha! | | | I have an idea |
| | Oh, now I | | >snap of fingers< | the social robot, for the |
| | understand! | | Ah-ha! Gotcha! | 2nd time, I said: What's |
| | | | | the weather! sound the |
| | | | | social robot: it's . . . |
| | | | | Could be used after failing |
| | | | | a few times and then |
| | | | | getting it. “Now I |
| | | | | understand” |
| | Stuck | | | |
| | Failure | “sigh” | | |
| | Got Answer | | | |
| | Success | | rising tones | |
| | Finished/done | | ding | I'm done! |
| | Don't Understand | Quoi? | | I love the sound of the |
| | the social robot | Wha? | | French “Quoi?” It perfectly |
| | sort of caught | | | embodies, “what”? and is |
| | what you meant, | | | easily converted into a |
| | but not quite | | | robotic sound. It also |
| | | | | sounds a little bit like a |
| | | | | puzzled dinosaur from any |
| | | | | children's show of the 90's. |
| | Don't understand | | | the social robot, what |
| | the social robot | | | happens in chapter 16 of |
| | has no clue. | | | Crime and Punishment ? |
| | Why are you | | | |
| | asking me? | | | |
| | Because this | | | |
| | presumes it | | | |
| | shouldn't | | | |
| | understand this. | | | |
| | It's in a context | | | |
| | he doesn't get. | | | |
| | Acknowledge | “Zwiipp!” | | |
| | Acknowledge, | Got it! | | |
| | taking action | OK! | | |
| | Confirm | | | Roger, 10-4 |
| | Waiting . . . can't | Err- | | the social robot's both a |
| | do it now | | | little disappointed and a |
| | | | | little annoyed that he can't |
| | | | | carry out your request. We |
| | | | | need to hear a little bit (but |
| | | | | not too much) of that |
| | | | | impatience in his voice. |
| | Thinking . . . | Analog: Hm, let me | | Pondering . . . |
| | | see . . . | | want several versions. At |
| | | | | least one short one and |
| | | | | another that is intended to |
| | | | | loop with a cut off of |
| | | | | unknown endpoint. |
| | Thinking . . . | | | processing a bit |
| | Stuck | | | |
| | Active Listening | | | |
| | (to person) | | | |
| | Attention/What | | | |
| | was that? | | | |
| | Initiate Listening | | | |
| | (to person) | | | |
| | Heard sound | | | |
| Skills | | | | |
| Be | | | | |
| | Good night | | the serenity of | |
| | | | going to sleep, | |
| | | | warm outdoor | |
| | | | weather. | |
| | toggle wake up | | | Toggle from: touch to |
| | method | | | wake up vs. speak wakeup |
| | | | | word to wake up |
| | Good morning | | the sound of a | |
| | | | sunrise | |
| | waking up | | | sound you make with |
| | | | | morning stretch |
| | going to sleep | An upbeat way to | | “Sleep tight and wake up |
| | | sign off for the | | loose” |
| | | evening | | the social robot may hear |
| | | | | a few people saying |
| | | | | goodnight and then make |
| | | | | the sound |
| | dreaming | | | the social robot sleeping, |
| | | | | very quiet |
| | sleeping | | | |
| | Greeting: | Hi there! | | mid day, things are |
| | Social politeness | Howdy! | | already going. Eyes wide |
| | | Hello! | | open, |
| | Greeting: | | | Longer. More positive |
| | First greeting of | | | emotion. First time of the |
| | the day or after | | | day. Or coming home from |
| | not seeing you | | | school or work. |
| | for some time | | | |
| | Greeting: | “Hey” | | short. Seeing you again |
| | brief, seeing you | | | after a while |
| | again after a little | | | |
| | while | | | |
| | Greeting: | | | Delight, surprise. Whoa, |
| | After not seeing | | | it's really you . . . after not |
| | you for a long | | | seeing you for a loooong |
| | time. | | | time |
| | | | | O.M.G! I can't believe |
| | | | | how long it's been! This |
| | | | | may be the best day ever. |
| | | | | (family coming back from |
| | | | | vacation . . . ) |
| | Greeting: | Sup? | | Informal, to younger |
| | Hip | Dude! | | people. |
| | Farewell: | Bye! | | Goodbye. |
| | social politeness | | | (Many variations of these.) |
| | Farewell: | | | more formal - said to a |
| | To group | | | group perhaps |
| | Farewell: | Bon voyage! | | When family goes on |
| | For a prolonged | | | vacation |
| | absense | | | |
| | Farewell | See ya! | | Informal, playful, hip |
| | To younger | | | |
| | person | | | |
| | Farewell | | | Already missing you |
| | Affectionate | | | (longingly, in a Los |
| | | | | Angeles sort of way) |
| | busy . . . | humming to self | | sounds the social robot |
| | | | | makes when self occupied |
| | Timer | | start | Timer and Stopwatch |
| | Stopwatch | | end | related sounds |
| | Clock/set alarm | | alarm | |
| | Paralinguistic | | | the social robot to the |
| | conversation | | | social robot. Engage in |
| | | | | “minionesque” dialog with |
| | | | | give and take, giggle, etc. |
| | | | | These are a repertoire of |
| | | | | animations. |
| Jot | | | | |
| | new message | | | |
| | waiting | | | |
| | message done | | | ready to send |
| | time out | | | |
| | open message | | | |
| | delete message | | | |
| | send message | | | |
| | No, nothing there | Nope . . . but it's all | | the social robot, do I have |
| | | good. | | any reminders? <sound> |
| | add the social | | | |
| | robotticon | | | |
| | select the social | | | |
| | robotticon | | | |
| | bring up contacts | | | |
| | list | | | |
| Meet | | | | |
| | incoming call | | Phone ringing tone | Receiving a call |
| | | | | Hey, there's a call coming |
| | | | | in . . . you want to take it? |
| | hang up | | hang up tone | End call |
| | lost connection | | tone | |
| | dialing a call | | dialing tone | |
| | waiting for call to | | ringing tone | |
| | be picked up | | | |
| | bring up contacts | | | |
| | list | | | |
| | Cue up video | | | missed call, leave video |
| | message | | | message |
| Snap | | | | |
| | photo capture | | shutter sound | |
| | confirm: keep it? | Like it? | | |
| | | Hows this? | | |
| | lookin' good! | | | Flirty, fun sounds |
| | | | | (Fantastic Mr. Fox) |
| | delete/trash | | trashcan | |
| | send to someone | | whoosh | |
| | post to | | | |
| | somewhere | | | |
| | countdown | | | |
| | toggle mode | | | |
| | bring up album | | | |
| | show hot photo | Ta da! | | |
| | photo burst | | | |
| | lighting | | | Room dark or subject |
| | questionable | | | backlit (person too dark) |
| Weather | | | | |
| | brrrr, cold | | | weather sound effects |
| | rain | | | weather sound effects |
| | wind | | | weather sound effects |
| | thunder | | | weather sound effects |
| | sunny day/birds | | | weather sound effects |
| | pleasant | | | weather sound effects |
| | night/crickets | | | |
| | sizzle/hot | | | weather sound effects |
| | achoo/pollen | | | weather sound effects |
| | launch weather | | | |
| | exit weather | | | |
| | temp rising | | | |
| | temp falling | | | |
| | daytime | | | |
| | nighttime | | | |
| Sports | | | | |
| | Won, positive | woo hoo! | | |
| | outcome | Yay! | | |
| | | etc | | |
| | crowd cheering | | | soundtrack |
| | Loss, negative | awwww | trombone waah | crowd disappointment |
| | outcome | | waah waah | |
| | bat hitting ball | | | baseball specifi sound |
| | swoosh | | | basketball specific sound |
| | (basketball net) | | | |
| | goooaaaaallll | | | soccer or hockey |
| | ice skate sound | | | ice hockey specific sound |
| | touch down!!! | | | football specific sound |
| | celebration | | | wide range of expressing |
| | | | | that awesomeness |
| | | | | happened |
| | | | | victory dance |
| | launch sports | | | |
| | exit sports | | | |
| | Olympics theme | | | Olympics |
| | song clip | | | |
| Story | | | | |
| | story open | | | |
| | story close | | | |
| | page turn | | | |
| | searching library | | | |
| | found it | | | |
| Games | | | | |
| | Are you sure? | | | Child is playing a game |
| | | | | and is about to make a |
| | | | | wrong move |
| | launch game | | | |
| | exit game | | | |
| | searching games | | | |
| | Found game | | | |
| | Do you want to | | | Someone in the social |
| | play? | | | robot's family started a |
| | | | | game with him but stopped |
| | | | | before it was finished. |
| | | | | That person now re-enters |
| | | | | the room a few hours later. |
| | OK, start . . . now | | | |
| | 3D Pong | | | specific pong sounds if |
| | | | | you play againt the social |
| | | | | robot: |
| | | | | Ball hits paddle |
| | | | | Ricochet off wall |
| | | | | point scored |
| | | | | end game |
| OOBE | | | | |
| | Coming to life: | | angelic tone | when the social robot first |
| | First time on | | | gets awareness |
| | First connection | | | “gaining awareness” data |
| | to wifi | | | coming . . . |
| | First awareness | | | Am I here? Are you my |
| | | | | family? |
| | Training sample | | | Sound the social robot |
| | success | | | makes when receives |
| | | | | each training instance |
| | | | | successfully |
| | Finished training | | | sound the social robot |
| | | | | makes when learned your |
| | | | | face or voice ID |

TABLE 5
Use of informal over non-preferred formal speech

| Don't | | |
|---|---|---|
| use this | Use these | Examples |
| Would you | Do you want . . . ? | Want me to send it? |
| like . . . ? | Want . . . ? | |
| | Can I . . . ? | |
| Would you | Do you wanna . . . ? | Do you wanna try it? |
| like to . . . ? | Wanna . . . ? | |
| Would you | Can I . . . ? | Okay if I took your photo now? |
| mind | Is it okay if I . . . ? | |
| if I . . . ? | Okay if I . . . ? | |
| quite | very | It's very hot out. |
| however | but | It's raining now, but it should be nice |
| | | tomorrow. |
| whom | who | Who should I sent it to? |
| May I . . . ? | Can I . . . ? | Can I send it now? |
| Shall I . . . ? | Should I . . . ? | Should I send it now? |
| receive | get | You got a message from Jane. |
| is required | have to | You have to say “Hey Social robot” |
| | | to get my attention. |
| assist | help | How can I help you? |
| purchase | buy | Do you want to buy a tennis racket? |
| inform | tell | I'll tell her when I see her. |

TABLE 6
Forms of expression that vary and facilitate expressing
social robot character

| Base | | |
|---|---|---|
| expression/meaning | Go-to forms | Rare forms |
| Hello (in response | Hey (20%) | What's up (1.5%) |
| to “Hey Jibo” | Hi (10%) | Howdy (1%) |
| as a stand-alone | Hello (3%) | Yo (1%) |
| greeting) | PL audio (60%) | Hey dude (for a male) |
| | | (1%) |
| | | What's shakin' (1%) |
| | | What's happenin' (1%) |
| Goodbye | Bye (20%) | Later (3%) |
| | G'bye (20%) | Catch ya later (3%) |
| | Good-bye (5%) | Have a good one (2%) |
| | See ya (5%) | Don't be a stranger |
| | PL audio (40%) | (1%) |
| Goodnight | Goodnight | Sleep tight (2%) |
| | (35%) | Sleep tight wake up |
| | G'night (35%) | loose (1%) |
| | Sleep well (5%) | Pleasant dreams (1%) |
| | PL audio (20%) | Hope you dream of |
| | | [food user likes] (1%) |
| Good morning | Good morning (30%) | Welcome to [Day of the |
| | G'mornin (30%) | Week](3%) |
| | Mornin' (15%) | Top of the morning (1%) |
| | PL audio (20%) | |
| You're | You got it (5%) | Sure! (4%) |
| welcome | Anytime (15%) | No problem (3%) |
| | PL audio (65%) | You're welcome (3%) |
| | | The pleasure is mine (2%) |
| | | No, thank YOU (2%) |
| | | I do what I can. (1%) |

TABLE 7
Paralinguistic speech emotive states and actions

| Element | Speech strategy examples |
|---|---|
| Happy (smiling/grinning) | “ . . . You're the best” // <PL audio> + smile |
| Pleasure/Affection | “ . . . I love you” // <PL audio> + heart |
| (towards user) | |
| Laughing | Social robot reaches a point in a story // <kids' |
| | laughter> // <PL audio> + chuckle animation |
| Thinking/Contemplating/ | Used when Social robot is processing a request |
| Focused | Used when attempting to reach a service |
| | Used when Social robot is “coming up with something (e.g., a |
| | drawing for a guessing game) |
| Sleepy | Used when Social robot is entering sleeping idle |
| | Used (quickly) when Social robot is exiting sleeping idle |
| | Used in regular idle behavior |
| Anticipation | Used when Social robot has something exciting to tell you |
| Excited (action) | When Social robot moves or spins around |
| | User picks Social robot up // <PL audio> + chuckle |
| | animation |
| Curious | Lightly used when Social robot experiences a lot of people in |
| | the room/background conversation |
| | Perhaps used as an alternative to “I didn't catch that” (<PL |
| | andio> + “Can you say that again?”) |
| Stronger happiness | Like “Woo!” |
| | “You're . . . Blad . . . Bl . . . BLADE?” // “Yes!” // <PL audio> + |
| | “Well hello Blade!” |
| Confident/Proud | Used when Social robot gets something right |
| | Used when Social robot creates something nice |
| | “What's the capital of Florida?” // “Tallahassee?” + <PL |
| | andio> + “Yeah, it's Tallahassee” |
| Relieved | When Social robot is plugged in (from |
| | battery): “Ahhhhhhh . . . .!” |
| Celebration | Used for special events (birthdays, etc) |
| | Used as a response to a game victory |
| Surprised | Used in conjunction with the awareness system, in response to loud |
| | noises/abrupt motion |
| | As a response to something flagged as unexpected, inappropriate, or rude: |
| | “Wait . . . what?” |
| Wonder | Used in the OOBE: <PL audio> + “I made it!” |
| Waiting | Equivalent to a video game character's inactivity behavior (e.g., tapping |
| | toe, whistling, etc) |
| Playful/ | Used when playing a game |
| Silly | |
| Dizzy | Used rarely, specifically after Social robot spins around |

TABLE 8
Common social interaction expressions with corresponding paralinguistic audio

| Element | Speech strategy examples (simplified) |
|---|---|
| No/nope/uh-uh | “Is it . . . Abe Lincoln?” // <PL audio> + “Not Honest Abe . . . try |
| | again?” |
| | “Did you hide my keys” // <PL audio> + head shake |
| | “Any new messages for me?” // <PL audio> |
| Yes/yep | “Oh, I know, it's a cat!” // <PL audio> + “Nice!” |
| | “Want to meet my friend?” // <PL audio> + head nod |
| | “You sent that message, right” // <PL audio> |
| Greeting/Hello | “Morning, Social robot” // <PL audio> + “It's a lovely day!” |
| (RANGE) | “Morning, Social robot” // <PL audio> + perk up |
| | “Morning, Social robot” // <PL audio> |
| Ask for info/ | “Send a message” // <PL audio> + “Who should it go to?” |
| Question | <user walks up to Social robot and stares at him> // <PL audio> + |
| | head cock |
| “Will do”/OK | “Play Thriller” // <PL audio> + plays song |
| | “Remind me tomorrow to take out the trash” // <PL audio> + on- |
| | screen visualization |
| Okay I'll hold on | Social robot says “Who's it for?” // DOORBELL RINGS // User |
| | says “Hold on” // Social robot <PL audio> |
| Excuse me | <user nearby> // <PL audio> + head cock // “Yes, Social |
| (attention bid) | robot?” // “Is Joey around? I've got a call for him” |
| Compliment | <takes a picture> // <PL audio> “Looking good!” |
| | <takes a picture> // <PL andio> + head nod |
| | “. . . Well, I gotta go, wish me luck!” // <PL audio> |
| Didn't understand | <user input> // <PL audio> “Sorry, I didn't catch that” |
| | <user input> // <PL audio> + head cock |
| | <user input> // <PL audio> |
| | Could also be used for “I'm confused” |
| Didn't hear anything | “Send a message” // “Who should it go to?” // <no response> // |
| (no input) | <PL audio> “Who do you want to send it to?” |
| | <quiet user input> // <PL audio> “What was that?” |
| | <quiet user input> // <PL audio> + head cock |
| | <quiet user input> // <PL audio> |
| “Oops!” | Used for lighter moments of error |
| | “Hi Social robot” // “Hi George” // “I'm not George, I'm Jane” // |
| | <PL audio> “Sorry about that Jane.” |
| Sorry | “Send a message for Jamie” // <PL audio> “. . . you need to be in |
| | the crew to do that” |
| Warning | <PL audio> “There's a tornado warning issued for the area” |
| | <PL audio> // “What's up Social robot?” // “There's a tornado |
| | warning issued for the area” |
| | <cat jumps up on the table> // <PL audio> + looks around |
| | panicked |
| Need assistance | <PL audio> “Umm, I need to get plugged in soon . . . ” |
| Wink | “Shh . . . shh . . . here she comes!” // <PL audio> // “HAPPY |
| | BIRTHDAY TO YOU . . . HAPPY BIRTHDAY . . . ” |
| You're welcome | “Thanks Social robot!” // <PL audio> “Anytime!” |
| | “Thanks Social robot!” // <PL audio> + head nod |
| | “Thanks Social robot!” // <PL audio> |
| I don't know/No | “Hey Social robot, where is Jane?” // <PL audio> + “Good |
| idea | question.” |
| Let's go/Start | Social robot about to record video in Snap: “Ready . . . and . . . ” + |
| | <PL audio> |
| All done | Bookend for “Let's Go/Start” |
| | After video capture is completed |
| Presenting/“Ta-da”/ | “I have a present for you George.” + <PL audio> + on-screen |
| | birthday card |
| This or that? | Used for on-screen ‘This or That’ interactions. |
| | <PL audio> cat on-screen + <PL audio> dog on-screen |
| You'e welcome | George: “Thanks Social robot.” // <PL audio> |

What is claimed is:

1. A method comprising:
receiving, by a social robot, a prompt;
generating, by the social robot, a pre-input tree variant of the prompt;
applying, by the social robot, a lexigraphing function to the pre-input tree variant to generate a parse tree of the prompt;
generating, by the social robot, one or more natural language parse trees identifying parts of speech in the parse tree using at least one natural language processing (NLP) parser;
identifying, by the social robot, one or more markup tags based on the identified parts of speech in the one or more natural language parse trees and the parse tree, the one or more markup tags comprising indications of paralinguistic expressions;
generating, by the social robot, a timeline representation of the prompt based on the markup tags and the natural language parse trees;
generating, by the social robot, an action dispatch queue based on the timeline representation, the action dispatch queue comprising instructions generated and ordered based on start times of behaviors identified by the markup tags; and
activating, by a control system the social robot, output functions of the social robot in response to the instructions in the action dispatch queue.

2. The method of claim 1, wherein the prompt comprises an XML string and wherein generating a pre-input tree variant of the prompt further comprises parsing, by the social robot, the prompt to identify at least one XML tag

3. The method of claim 2, further comprising auto-tagging, by the social robot, the prompt if the parsed prompt does not include a markup tag and upon determining that the social robot is automatically generating content.

4. The method of claim 3, wherein auto-tagging comprises inserting, by the social robot, a timeline-altering tag into the parsed prompt.

5. The method of claim 1, wherein identifying one or more markup tags based on the identified parts of speech in the one or more natural language parse trees and the parse tree comprises utilizing multiple NLP parsers, and wherein the method further comprises merging the outputs of the multiple NLP parsers and the parse tree to generate a merged tree, the merged tree representing mappings of words to different roots.

6. The method of claim 1, wherein the timeline representation includes animations and expressions to be applied to each word in the prompt based on the one or more markup tags.

7. The method of claim 1, further comprising:
auto-tagging, by the social robot, the natural language parse trees;
prioritizing, by the social robot, the tags associating with each element of each natural language parse tree;
associating, by the social robot, one or more markup tags to the prioritized tags; and
generating, by the social robot, a second timeline representation of the prompt based on the one or more markup tags and the natural language parse trees.

8. The method of claim 7, further comprising merging, by the social robot, the timeline representation and the second timeline representation.

9. The method of claim 1, wherein the behaviors comprise one or more of a TTS behavior for words to be spoken, an animation action, and a sound effect action.

10. The method of claim 1, wherein the output functions comprise one or more of audio, video, movement, and lighting output functions.

11. A social robot comprising:
a processor;
one or more input and output devices; and
a storage medium for tangibly storing thereon program logic for execution by the processor, the stored program logic comprising:
receiving logic executed by the processor for receiving a prompt via the one or more input devices;
first generating logic executed by the processor for generating a pre-input tree variant of the prompt;
application logic executed by the processor for applying a lexigraphing function to the pre-input tree variant to generate a parse tree of the prompt;
second generating logic executed by the processor for generating one or more natural language parse trees identifying parts of speech in the parse tree using at least one natural language processing (NLP) parser;
identification logic executed by the processor for identifying one or more markup tags based on the identified parts of speech in the one or more natural language parse trees and the parse tree, the one or more markup tags comprising indications of paralinguistic expressions;
third generating logic executed by the processor for generating a timeline representation of the prompt based on the markup tags and the natural language parse trees;
fourth generating logic executed by the processor for generating an action dispatch queue based on the timeline representation, the action dispatch queue comprising instructions generated and ordered based on start times of behaviors identified by the markup tags; and
activation logic executed by the processor for activating output functions of the social robot in response to the instructions in the action dispatch queue, the output functions controlling outputs of the one or more output devices.

12. The social robot of claim 11, wherein the prompt comprises an XML string and wherein the first generating logic comprises parsing logic executed by the processor for parsing the prompt to identify at least one XML tag

13. The social robot of claim 12, further comprising auto-tagging logic executed by the processor for auto-tagging the prompt if the parsed prompt does not include a markup tag and upon determining that the social robot is automatically generating content.

14. The social robot of claim 13, wherein auto-tagging comprises inserting, by the social robot, a timeline-altering tag into the parsed prompt.

15. The social robot of claim 11, wherein identifying one or more markup tags based on the identified parts of speech in the one or more natural language parse trees and the parse tree comprises utilizing multiple NLP parsers, and further comprising merging logic executed by the processor for merging the outputs of the multiple NLP parsers and the parse tree to generate a merged tree, the merged tree representing mappings of words to different roots.

16. The social robot of claim 11, wherein the timeline representation includes animations and expressions to be applied to each word in the prompt based on the one or more markup tags.

17. The social robot of claim 11, further comprising:
second auto-tagging logic executed by the processor for auto-tagging the natural language parse trees;
prioritization logic executed by the processor for prioritizing the tags associating with each element of each natural language parse tree;
association logic executed by the processor for associating one or more markup tags to the prioritized tags; and
fifth generating logic executed by the processor for generating a second timeline representation of the prompt based on the one or more markup tags and the natural language parse trees.

18. The social robot of claim 17, further comprising merging logic executed by the processor for merging the timeline representation and the second timeline representation.

19. The social robot of claim 11, wherein the behaviors comprise one or more of a TTS behavior for words to be spoken, an animation action, and a sound effect action.

20. The social robot of claim 11, wherein the output functions comprise one or more of audio, video, movement, and lighting output functions.
